(19) United States
(12) Patent Application Publication
(10) Pub. No.: US 2025/0133563 A1
(43) Pub. Date: Apr. 24, 2025

(54) METHOD AND APPARATUS FOR TRANSMITTING UPLINK CONTROL INFORMATION IN WIRELESS COMMUNICATION SYSTEMS

(71) Applicant: SAMSUNG ELECTRONICS CO., LTD., Suwon-si (KR)

(72) Inventors: Kyungjun CHOI, Suwon-si (KR); Seongmok LIM, Suwon-si (KR); Youngrok JANG, Suwon-si (KR); Hyoungju JI, Suwon-si (KR)

(21) Appl. No.: 18/920,482

(22) Filed: Oct. 18, 2024

(30) Foreign Application Priority Data
Oct. 19, 2023 (KR) 10-2023-0140508

(51) Int. Cl. H04W 72/1268; H04L 5/00

(52) U.S. Cl. CPC H04W 72/1268; H04L 5/0094

(57) ABSTRACT

The disclosure relates to a 5G or 6G communication system for supporting higher data transmission rates. In addition, the disclosure relates to operations of a UE and base station in a wireless communication system. Specifically, the disclosure relates to a method for transmitting an UL control signal by a UE and an apparatus capable of performing the same. The disclosure provides a subband-based transmission method in a wireless communication system.

### CROSS-REFERENCE TO RELATED APPLICATION

This application claims priority to Korean patent Application No. 10-2023-0140508 filed on Oct. 19, 2023, in the Korean Intellectual Property Office, the disclosures of all of which are hereby incorporated by reference herein in their entireties.

### BACKGROUND

### 1. Field

The disclosure relates to operations of a terminal and a base station in a wireless communication system. Specifically, the disclosure relates to a method for transmitting an uplink control signal by a terminal and an apparatus capable of performing the same.

### 2. Description of the Related Art

5^{th} generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies, which is referred to as Beyond 5G systems, in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra-Reliable Low Latency Communications (URLLC), and massive Machine-Type Communications (mMTC), there has been ongoing standardization regarding beamforming and massive Multiple-Input Multiple-Output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving technology, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosed embodiments are to provide an apparatus and method capable of effectively providing services in a mobile communication system.

In accordance with an aspect of the disclosure, a method performed by a user equipment (UE) in a communication system is provided. The method comprises receiving, from a base station, configuration for one or more sub-bands, receiving, from the base station, downlink control information (DCI) scheduling a physical uplink shared channel (PUSCH), identifying a sub-band for uplink control information (UCI) among the one or more sub-bands, multiplexing the UCI on the PUSCH based on the sub-band for the UCI, and transmitting, to the base station, the PUSCH including the UCI.

In accordance with an aspect of the disclosure, a method performed by a base station in a communication system is provided. The method comprises transmitting, to a user equipment (UE), configuration for one or more sub-bands, transmitting, to the UE, downlink control information (DCI) scheduling a physical uplink shared channel (PUSCH), and receiving, from the UE, the PUSCH including an uplink control information (UCI). The UCI is multiplexed in a sub-band for the UCI among the one or more sub-bands.

In accordance with an aspect of the disclosure, a user equipment (UE) in a communication system is provided. The UE comprises a transceiver, and at least one processor configured to: receive, from a base station, configuration for one or more sub-bands, receive, from the base station, downlink control information (DCI) scheduling a physical uplink shared channel (PUSCH), identify a sub-band for uplink control information (UCI) among the one or more sub-bands, multiplex the UCI on the PUSCH based on the sub-band for the UCI, and transmit, to the base station, the PUSCH including the UCI.

In accordance with an aspect of the disclosure, a base station in a communication system is provided. The base station comprises a transceiver, and at least one processor configured to: transmit, to a user equipment (UE), configuration for one or more sub-bands, transmit, to the UE, downlink control information (DCI) scheduling a physical uplink shared channel (PUSCH), and receive, from the UE, the PUSCH including an uplink control information (UCI). The UCI is multiplexed in a sub-band for the UCI among the one or more sub-bands.

The disclosed embodiments are to provide an apparatus and method capable of effectively providing services in a mobile communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a basic structure of time-frequency areas in a wireless communication system according to an embodiment of the disclosure;

FIG. 2 illustrates frame, subframe, and slot structures in a wireless communication system according to an embodiment of the disclosure;

FIG. 3 illustrates an example of a configuration of a bandwidth part in a wireless communication system according to an embodiment of the disclosure;

FIG. 4 illustrates an example of a configuration of a control resource set of a downlink control channel in a wireless communication system according to an embodiment of the disclosure;

FIG. 5 illustrates a structure of a downlink control channel in a wireless communication system according to an embodiment of the disclosure;

FIG. 6 illustrates a method for a base station and a UE to transmit/receive data in consideration of a downlink data channel and a rate matching resource in a wireless communication system according to an embodiment of the disclosure;

FIG. 7 illustrates an example of frequency domain resource allocation of a PDSCH in a wireless communication system according to an embodiment of the disclosure;

FIG. 8 illustrates an example of time domain resource allocation of a PDSCH in a wireless communication system according to an embodiment of the disclosure;

FIG. 9 illustrates an example of time domain resource allocation according to subcarrier spacing of a data channel and control channel in a wireless communication system according to an embodiment of the disclosure;

FIG. 10 illustrates radio protocol structures of a bae station and UE in single cell, carrier aggregation, and dual connectivity situations in a wireless communication system according to an embodiment of the disclosure;

FIG. 11 illustrates an example of operating a SBFD in an TDD band of a wireless communication system to which the disclosure is applied;

FIG. 12A illustrates an example of a method for determining a subband based on a UL BWP configuration according to an embodiment of the disclosure;

FIG. 12B illustrates an example of a method for determining a subband based on a cell/carrier configuration according to an embodiment of the disclosure;

FIG. 12C illustrates an example of a method for determining a subband based on scheduling information according to an embodiment of the disclosure;

FIG. 13A illustrates an example of a method for configuring a subband for each time interval according to an embodiment of the disclosure;

FIG. 13B illustrates another example of a method for configuring a subband for each time interval according to an embodiment of the disclosure;

FIG. 13C illustrates an example of a method for indicating a subband configuration based on DCI according to an embodiment of the disclosure;

FIG. 14 illustrates a method for a UE to transmit an uplink channel or signal according to an embodiment of the disclosure;

FIG. 15 illustrates configurations configured for each subband according to an embodiment of the disclosure;

FIG. 16A illustrates a method for a UE to transmit a PUSCH according to an embodiment of the disclosure;

FIG. 16B illustrates a method for a UE to transmit a PUSCH according to an embodiment of the disclosure;

FIG. 16C illustrates a method for a UE to transmit a PUSCH according to an embodiment of the disclosure;

FIG. 16D illustrates a method for a UE to transmit a PUSCH according to an embodiment of the disclosure;

FIG. 17 illustrates multiplexing of UCI and UL-SCH on a PUSCH according to an embodiment of the disclosure;

FIG. 18 illustrates transmission of UCI based on a specific subband according to an embodiment of the disclosure;

FIG. 19 illustrates a method for determining a specific subband to transmit UCI according to an embodiment of the disclosure;

FIG. 20 illustrates multiplexing of UCI SB selection information and UCI within a PUSCH when a UE selects a subband for transmitting UCI by itself according to an embodiment of the disclosure;

FIG. 21 illustrates a rate-matching or puncturing applied in a subband where UCI is not transmitted according to an embodiment of the disclosure;

FIG. 22 illustrates a structure of a UE in a wireless communication system according to an embodiment of the disclosure; and

FIG. 23 illustrates a structure of a base station in a wireless communication system according to an embodiment of the disclosure.

### DETAILED DESCRIPTION

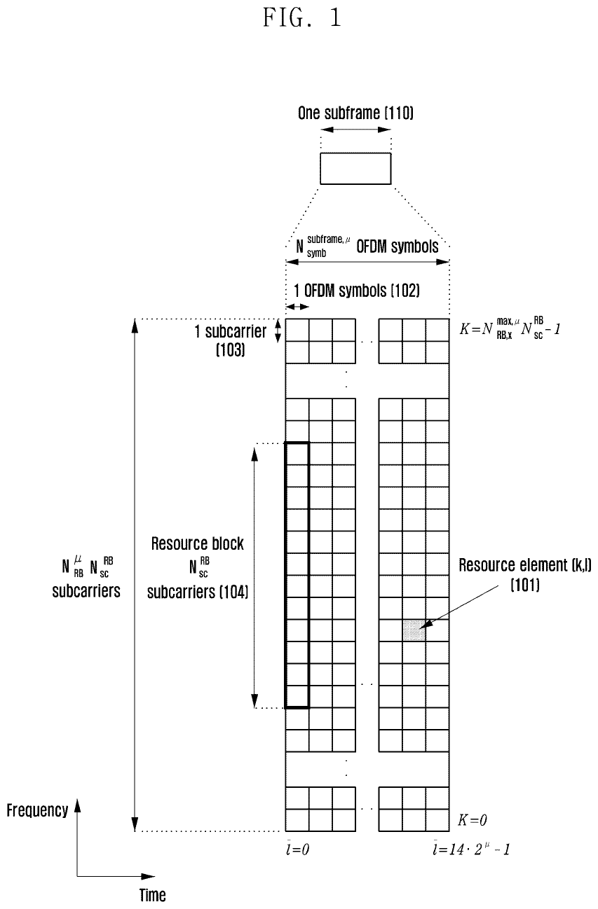

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art to which the disclosure pertains and not associated directly with the disclosure will be omitted. Such an omission is to transfer the main idea of the disclosure more clearly without obscuring it by omitting unnecessary descriptions.

For the same reason, in the accompanying drawings, some elements may be exaggerated, omitted, or schematically illustrated. Further, the size of each component does not completely reflect the actual size. In the drawings, identical or corresponding components are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in describing the disclosure, a detailed description of known functions or constitutions incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

In the following description, a base station is an entity that allocates resources to UEs, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a downlink (DL) refers to a radio transmission path via which a base station transmits a signal to a UE, and an uplink (UL) refers to a radio transmission path via which a UE transmits a signal to a base station. Further, in the following description, long-term evolution (LTE) or LTE-advanced (LTE-A) systems may be described by way of example, but the embodiments of the disclosure may also be applied to other communication systems having similar technical backgrounds or channel types. Examples of such communication systems may include 5^{th} generation mobile communication technologies (5G, new radio, and NR) developed beyond LTE-A, and in the following description, the 5G may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of the flowchart illustrations, can be implemented by computer program instructions. These computer program instructions can be provided to a processor of a general-purpose computer, special purpose computer, or other programmable data processing apparatus, such that the instructions, which execute via the processor of the computer or other programmable data processing apparatus, create means for implementing the functions specified in the flowchart block(s). These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable data processing apparatus to produce a computer implemented process such that the instructions that execute on the computer or other programmable data processing apparatus provide steps for implementing the functions specified in the flowchart block(s).

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the corresponding functionality.

As used in embodiments of the disclosure, the term “˜unit” refers to a software component or a hardware component, such as a Field Programmable Gate Array (FPGA) or an Application Specific Integrated Circuit (ASIC), which performs a predetermined function. However, the “˜unit” does not always have a meaning limited to software or hardware. The “˜unit” may be constituted either to be stored in an addressable storage medium or to execute one or more processors. Therefore, the “˜unit” includes components, such as, software components, object-oriented software components, class components or task components, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into a larger number of components and a “˜unit.” Moreover, the components and “˜units” may be implemented to reproduce one or more central processing units (CPUs) within a device or a security multimedia card. Further, in the embodiments, the “˜unit” may include one or more processors.

A wireless communication system has been developed from a wireless communication system providing a voice centered service in the early stage toward broadband wireless communication systems providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high rate packet data (HRPD) of 3GPP2, ultra-mobile broadband (UMB), IEEE 802.16e, and the like.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a terminal (user equipment (UE) or mobile station (MS)) transmits data or control signals to a base station (BS) (eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (cMBB) communication, massive machine type communication (mMTC), ultra reliability low-latency communication (URLLC), and the like.

cMBB aims at providing a data rate enhanced more than that supported by existing LTE, LTE-A, or LTE-Pro. For example, in the 5G communication system, eMBB must provide a peak data rate of 20 Gbps in the downlink and a peak data rate of 10 Gbps in the uplink from the perspective of a single base station. Furthermore, the 5G communication system must provide an increased user-perceived data rate to the UE, as well as the maximum data rate. In order to satisfy such requirements, various transmission/reception technologies including a further enhanced multi input multi-output (MIMO) transmission technology are required to be improved. In addition, the data rate required for the 5G communication system may be satisfied in the 5G communication system using a frequency bandwidth more than 20 MHz in a frequency band of 3 to 6 GHz or 6 GHz or more, while transmitting signals using a transmission bandwidth up to 20 MHz in a band of 2 GHz used in LTE.

At the same time, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be constituted to be inexpensive, and may require a very long battery lifetime, such as 10 to 15 years, because it is difficult to frequently replace the battery of the UE.

Lastly, URLLC is a cellular-based mission-critical wireless communication service. For example, URLLC may be considered for services to be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10⁻⁵ or less at the same time. Therefore, for the services supporting URLLC, a 5G system must provide a transmit time interval (TTI) shorter than those of other services, and also may require a design for assigning a large number of resources in a frequency band in order to secure reliability of a communication link.

Three services in 5G, that is, eMBB, URLLC, and mMTC, may be multiplexed and transmitted in a single system. In this case, different transmission/reception techniques and transmission/reception parameters may be used between services in order to satisfy different requirements of the respective services. It is apparent that 5G is not limited to the three services described above.

### [NR Time-Frequency Resources]

Hereinafter, a frame structure of the 5G system is described in more detail with reference to the drawings.

FIG. 1 illustrates a basic structure of a time-frequency area which is a radio resource area in which data or a control channel is transmitted in a 5G system.

In FIG. 1, a horizontal domain indicates a time area and a vertical domain indicates a frequency area. A basic unit of resources in the time and frequency areas is a resource element (RE) 101 and may be defined as 1 orthogonal frequency division multiplexing (OFDM) symbol 102 in the time domain and 1 subcarrier 103 in the frequency domain. In the frequency area, (for example, 12) consecutive REs may constitute one resource block (RB) 104.

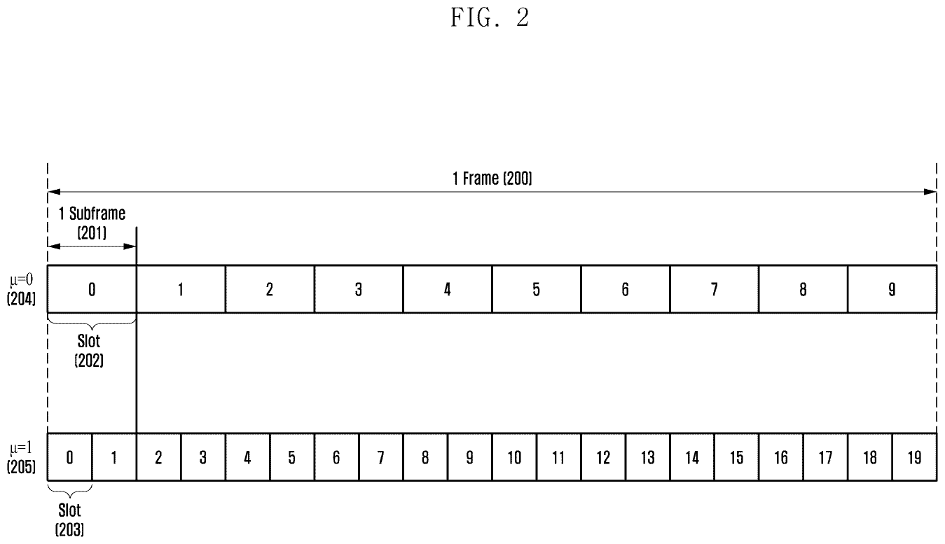

FIG. 2 illustrates structures of a frame, subframe, slot in a wireless communication system according to an embodiment of the disclosure.

In FIG. 2, an example of the structures of a frame 200, subframe 201, and slot 202 is illustrated. One frame 200 may be defined as 10 ms. One subframe 201 may be defined as 1 ms, and accordingly one frame 200 may be constituted with a total of 10 subframes 201. One slot 202 or 203 may be defined as 14 OFDM symbols (that is, the number of symbols (Nₛₗₒₜ^{symb}) per slot=14). One subframe 201 may include one or a plurality of slots 202 or 203, and the number of slots 202 or 203 per subframe 201 may vary depending on a configuration value μ 204 or 205 for subcarrier spacing. In the example of FIG. 2, the cases in which the subcarrier spacing configuration values μ=0 204 and μ=1 205 are illustrated. One subframe 201 may be constituted with one slot 202 in the case of μ=0 204, and one subframe 201 may be constituted with two slots 203 in the case of μ=1 205. That is, the number of slots (Nₛₗₒₜ^{subframe,μ}) per subframe may be different according to the configuration value μ for subcarrier spacing, and accordingly, the number of slots (Nₛₗₒₜ^{frame,μ}) per frame may be different. Nₛₗₒₜ^{subframe,μ} and Nₛₗₒₜ^{frame,μ} according to each subcarrier spacing configuration μ may be defined as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a configuration of a bandwidth part (BWP) in the 5G communication system will be described in detail with reference to the drawings.

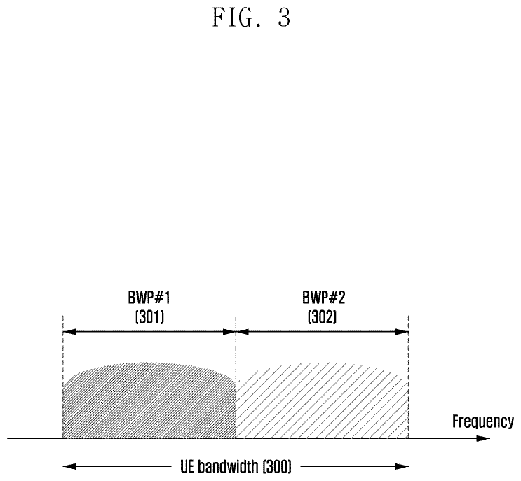

FIG. 3 illustrates an example of a configuration for a BWP in a wireless communication system according to an embodiment of the disclosure.

FIG. 3 shows an example in which a UE bandwidth 300 is configured as two bandwidth parts, that is, bandwidth part #1 (BWP #1) 301 and bandwidth part #2 (BWP #2) 302. The base station may configure one or a plurality of BWPs in the UE, and the following information such as in Table 2 below may be configured to each BWP.

TABLE 2

| | |
|---|---|
| BWP ::= | SEQUENCE { |
| bwp-Id | BWP-Id, |

(BWP identity)

| | |
|---|---|
| locationAndBandwidth | INTEGER (1..65536), |

(BWP location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

It is apparent that the disclosure is not limited to the above example, and various parameters related to a BWP as well as the above configuration information may be configured in the UE. The information may be transmitted to the UE by the base station through higher layer signaling, for example, radio resource control (RRC) signaling. Among one or a plurality of configured BWPs, at least one BWP may be activated. Whether to activate the configured BWPs may be semi-statically transferred from the base station to the UE through RRC signaling or may be dynamically transferred through Downlink Control Information (DCI).

According to some embodiments, the UE before the radio resource control (RRC) connection may receive a configuration of an initial BWP for initial access from the base station through a master information block (MIB). More specifically, the UE may receive configuration information for a control resource set (CORESET) and a search space in which a PDCCH for receiving system information (which may correspond to remaining system information (RMSI) or system information block 1 (SIB 1)) required for initial access through the MIB can be transmitted in an initial access stage. Each of the CORESET and the search space configured through the MIB may be considered as an identity (ID) 0, respectively. The base station may inform the UE of configuration information such as frequency allocation information for control resource set #0, time allocation information, numerology, and the like through the MIB. Further, the base station may inform the UE of configuration information for a monitoring period and an occasion of control resource set #0, that is, configuration information for search space #0 through the MIB. The UE may consider a frequency area configured as control resource set #0 acquired from the MIB as an initial bandwidth part for initial access. Here, the identity (ID) of the initial BWP may be considered as 0.

The configuration of the BWP supported by 5G may be used for various purposes.

According to some embodiments, in the case that a bandwidth supported by the UE is smaller than a system bandwidth, it may be supported through the configuration of the BWP. For example, the base station may configure a frequency location (configuration information 2) of the BWP in the UE, and thus the UE may transmit and receive data at a specific frequency location within the system bandwidth.

Further, according to some embodiments, the base station may configure a plurality of BWPs in the UE for the purpose of supporting different numerologics. For example, in order to support a certain UE to perform data transmission and reception using both subcarrier spacing of 15 kHz and subcarrier spacing of 30 kHz, two BWPs may be configured as subcarrier spacings of 15 kHz and 30 kHz, respectively. Different BWPs may be frequency-division-multiplexed, and in the case that data is transmitted and received at particular subcarrier spacing, the BWP configured at the corresponding subcarrier spacing may be activated.

Further, according to some embodiments, the base station may configure BWPs having different bandwidth sizes in the UE for the purpose of reducing power consumption of the UE. For example, in the case that the UE supports a very large bandwidth, for example, 100 MHZ and always transmits and receives data through the corresponding bandwidth, very high power consumption may be generated. Particularly, monitoring an unnecessary downlink control channel through a large bandwidth of 100 MHz in the state in which there is no traffic is very inefficient in terms of the perspective of power consumption. For the purpose of reducing power consumption of the UE, the base station may configure a BWP having a relatively narrow bandwidth, for example, a bandwidth of 20 MHz. The UE may perform a monitoring operation in the BWP of 20 MHz in the state in which there is no traffic, and in the case that data is generated, may transmit and receive data through the BWP of 100 MHz according to an indication from the base station.

In a method of configuring the BWP, UEs before an RRC connection may receive configuration information for an initial bandwidth part through a master information block (MIB) in an initial access stage. More specifically, the UE may receive a configuration of a control resource set (CORESET) for a downlink control channel in which downlink control information (DCI) for scheduling a system information block (SIB) may be transmitted from an MIB of a physical broadcast channel (PBCH). A bandwidth of the control resource set configured as the MIB may be considered as an initial bandwidth part, and the UE may receive a physical downlink shared channel (PDSCH), in which the SIB is transmitted, through the configured initial bandwidth part. The initial bandwidth part may be used not only for reception of the SIB but also other system information (OSI), paging, or random access.

### [Change of Bandwidth Part (BWP)]

In the case where one or more BWPs are configured for the UE, the base station may indicate the UE to change (switch or transition) the BWP using a bandwidth part indicator field in the DCI. For example, in the case that a currently active BWP of the UE is BWP #1 301 in FIG. 3, the base station may indicate BWP #2 302 to the UE using a bandwidth part indicator in the DCI, and the UE may perform changing of a BWP to BWP #2 302 indicated by the bandwidth part indicator in the received DCI.

As described above, since DCI-based BWP change may be indicated by the DCI for scheduling a PDSCH or a PUSCH, in the case that the UE receives a request for changing the BWP, the UE may easily receive or transmit a PDSCH or PUSCH scheduled by the corresponding DCI in the changed BWP. To this end, the standard stipulates the requirements for a delay time (T_{BWP}) required when changing the BWP, and may be defined, for example, as Table 3.

TABLE 3

| | NR Slot | BWP switch delay T_{BWP} (slots) | |
|---|---|---|---|
| | length | Type | Type |
| μ | (ms) | 1^{Note 1} | 2^{Note 1} |
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirements for a BWP change delay time supports Type 1 or Type 2 depending on the capability of a UE. The UE may report a supportable BWP delay time type to the base station.

In accordance with the above-described requirements for a BWP change delay time, in the case that the UE receives DCI including a BWP change indicator in slot n, the UE may complete a change to a new BWP indicated by the BWP change indicator at the time not later than slot n+T_{BWP}, and perform transmission/reception of a data channel scheduled by the corresponding DCI in the new changed BWP. In the case that the base station is to schedule a data channel with a new BWP, the base station may determine time domain resource allocation for the data channel in consideration of the BWP change delay time (T_{BWP}) of the UE. That is, when scheduling a data channel with a new BWP, the base station may schedule a corresponding data channel after the BWP change delay time in a method of determining time domain resource allocation for the data channel. Accordingly, the UE may not expect that the DCI indicating the BWP change may indicate a slot offset value (K0 or K2) smaller than the BWP change delay time (T_{BWP}).

If the UE receives a DCI (e.g., DCI format 1_1 or 0_1) indicating a BWP change, the UE may not perform any transmission or reception during a period of time from the third symbol of the slot in which a PDCCH including the corresponding DCI is received to the starting point of the slot indicated by a slot offset value (K0 or K2) indicated by a time domain resource allocation indicator field in the corresponding DCI. For example, if the UE receives DCI indicating a BWP change in slot n, and if the slot offset value indicated by the corresponding DCI is K, the UE may not perform any transmission or reception from the third symbol of slot n to the symbol before slot n+K (i.e., the last symbol of slot n+K−1).

### [SS/PBCH Block]

Next, a synchronization signal (SS)/PBCH block in 5G will be described.

The SS/PBCH block may refer to a physical layer channel block including a primary SS (PSS), a secondary SS (SSS), and a PBCH. A detailed description thereof is made below.
PSS: It is a signal which is a reference of downlink time/frequency synchronization and provides some pieces of information of a cell ID.
SSS: It is a reference of downlink time/frequency synchronization and provides the remaining cell ID information which the PSS does not provide. In addition, it serves as a reference signal for demodulation of a PBCH.
PBCH: It provides necessary system information required for transmitting and receiving a data channel and a control channel by the UE. The necessary system information may include control information related to a search space indicating radio resource mapping information of a control channel, scheduling control information for a separate data channel for transmitting system information, and the like.
SS/PBCH block: The SS/PBCH block is composed of a combination of PSS, SSS, and PBCH. One or a plurality of SS/PBCH blocks may be transmitted within a time of 5 ms, and each of the transmitted SS/PBCH blocks may be distinguished by an index.

The UE may detect the PSS and the SSS in an initial access stage and decode the PBCH. The UE may acquire an MIB from the PBCH and receive a configuration of control resource set (CORESET) #0 (corresponding to a control resource set having control resource set index 0) therefrom. The UE may monitor control resource set #0 on the basis of the assumption that the selected SS/PBCH block and a demodulation reference signal (DMRS) transmitted in control resource set #0 are quasi co-located (QCLed). The UE may receive system information through downlink control information transmitted in control resource set #0. The UE may acquire configuration information related to a random access channel (RACH) required for initial access from the received system information. The UE may transmit a physical RACH (PRACH) to the base station in consideration of the selected SS/PBCH block index, and the base station that has received the PRACH may acquire information on the SS/PBCH block index selected by the UE. The base station may know which block is selected by the UE from among the SS/PBCH blocks and that CORESET #0 related thereto is monitored.

### [PDCCH: In Relation to DCI]

Next, downlink control information (DCI) in a 5G system will be described in detail.

In the 5G system, scheduling information for uplink data (or a physical uplink data channel (physical uplink shared channel (PUSCH)) or downlink data (or physical downlink data channel (physical downlink shared channel (PDSCH)) is delivered from the base station to the UE through DCI. The UE may monitor a fallback DCI format and a non-fallback DCI format for the PUSCH or the PDSCH. The fallback DCI format may be constituted with a fixed field predefined between the base station and the UE, and the non-fallback DCI format may include a configurable field.

The DCI may be transmitted through a Physical Downlink Control Channel (PDCCH) via a channel coding and modulation process. A cyclic redundancy check (CRC) may be added to a DCI message payload and may be scrambled by a radio network temporary identifier (RNTI) corresponding to the identity of the UE. Depending on the purpose of the DCI message, for example, UE-specific data transmission, a power control command, a random access response, or the like, different RNTIs may be used. That is, the RNTI is not explicitly transmitted but is included in a CRC calculation process to be transmitted. If the DCI message transmitted through the PDCCH is received, the UE may identify the CRC using the allocated RNTI, and may know that the corresponding message has been transmitted to the UE when the CRC identification result is correct.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying of a slot format indicator (SFI) may be scrambled by an SFI-RNTI. DCI for notifying of transmit power control (TPC) may be scrambled with a TPC-RNTI. DCI for scheduling a UE-specific PDSCH or PUSCH may be scrambled by a cell RNTI (C-RNTI).

DCI format 0_0 may be used for fallback DCI for scheduling a PUSCH in which case the CRC may be scrambled by a C-RNTI. DCI format 0_0 in which the CRC is scrambled by the C-RNTI may include, for example, the following information of Table 4.

TABLE 4
Identifier for DCI formats—[1] bit
Frequency domain resource assignment—
[┌log₂( N_{RB}^{UL, BWP} (N_{RB}^{UL, BWP} + 1)/2)┐] bits
Time domain resource assignment (—X bits
Frequency hopping flag—1 bit.
Modulation and coding scheme—5 bits
New data indicator—1 bit
Redundancy version—2 bits
HARQ process number—4 bits
TPC command for scheduled PUSCH—[2] bits
UL/SUL indicator—0 or 1 bit

DCI format 0_1 may be used for non-fallback DCI for scheduling a PUSCH in which case the CRC may be scrambled by a C-RNTI. DCI format 0_1 in which the CRC is scrambled by the C-RNTI may include, for example, the following information of Table 5.

```
TABLE 5
Carrier indicator - 0 or 3 bits
UL/SUL indicator - 0 or 1 bit
Identifier for DCI formats - [1] bits
Bandwidth part indicator - 0, 1 or 2 bits
Frequency domain resource assignment
  For resource allocation type 0, ┌N_{RB}^{UL,BWP}/P┐ bits
  For resource allocation type 1, ┌log₂(N_{RB}^{UL,BWP}(N_{RB}^{UL,BWP} + 1)/2)┐ bits
Time domain resource assignment -1, 2, 3, or 4 bits
VRB-to-PRB mapping - 0 or 1 bit, only for resource allocation type 1.
  0 bit if only resource allocation type 0 is configured;
  1 bit otherwise.
Frequency hopping flag - 0 or 1 bit, only for resource allocation type 1.
  0 bit if only resource allocation type 0 is configured;
  1 bit otherwise.
Modulation and coding scheme - 5 bits
New data indicator - 1 bit
Redundancy version - 2 bits
HARQ process number - 4 bits
1st downlink assignment index - 1 or 2 bits
  1 bit for semi-static HARQ-ACK codebook;
  2 bits for dynamic HARQ-ACK codebook with single HARQ-ACK codebook.
2nd downlink assignment index - 0 or 2 bits
  2 bits for dynamic HARQ-ACK codebook with two HARQ-ACK sub-
  codebooks;
  0 bit otherwise.
TPC command for scheduled PUSCH - 2 bits
$SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
  $⌈ {log}_{2} ( {\sum }_{k = 1}^{{L}_{max}} ( \begin{matrix}{N}_{SRS} \\ k\end{matrix} ) ) ⌉ bits for non ‐ codebook based PUSCH tranmission ;$
  ┌log₂(N_{SRS})┐ bits for codebook based PUSCH transmission.
Precoding information and number of layers - up to 6 bits
Antenna ports - up to 5 bits
SRS request - 2 bits
CSI request - 0, 1, 2, 3, 4, 5, or 6 bits
CBG transmission information - 0, 2, 4, 6, or 8 bits
PTRS-DMRS association - 0 or 2 bits.
beta_offset indicator - 0 or 2 bits
DMRS sequence initialization - 0 or 1 bit
```

DCI format 1_0 may be used for fallback DCI for scheduling a PDSCH in which case the CRC may be scrambled by a C-RNTI. DCI format 1_0 in which the CRC is scrambled by the C-RNTI may include, for example, the following information of Table 6.

TABLE 6
Identifier for DCI formats—[1] bit
Frequency domain resource assignment—
[┌log₂( N_{RB}^{DL, BWP} (N_{RB}^{DL, BWP} + 1)/2)┐] bits
Time domain resource assignment—X bits
VRB-to-PRB mapping—1 bit.
Modulation and coding scheme—5 bits
New data indicator—1 bit
Redundancy version—2 bits
HARQ process number—4 bits
Downlink assignment index—2 bits
TPC command for scheduled PUCCH—[2] bits
PUCCH resource indicator—3 bits
PDSCH-to-HARQ feedback timing indicator—[3] bits

DCI format 1_1 may be used for non-fallback DCI for scheduling a PDSCH in which case the CRC may be scrambled by a C-RNTI. DCI format 1_1 in which the CRC is scrambled by the C-RNTI may include, for example, the following information of Table 7.

TABLE 7
Carrier indicator—0 or 3 bits
Identifier for DCI formats—[1] bits
Bandwidth part indicator—0, 1 or 2 bits
Frequency domain resource assignment
For resource allocation type 0, ┌N_{RB}^{DL, BWP}/P┐bits
For resource allocation type 1, ┌log₂( N_{RB}^{DL, BWP} (N_{RB}^{DL, BWP} + 1)/2)┐ bits
Time domain resource assignment—1, 2, 3, or 4 bits
VRB-to-PRB mapping—0 or 1 bit, only for resource allocation type 1.
0 bit if only resource allocation type 0 is configured;
1 bit otherwise.
PRB bundling size indicator—0 or 1 bit
Rate matching indicator—0, 1, or 2 bits
ZP CSI-RS trigger—0, 1, or 2 bits
For transport block 1:
Modulation and coding scheme—5 bits
New data indicator—1 bit
Redundancy version—2 bits
For transport block 2:
Modulation and coding scheme—5 bits
New data indicator—1 bit
Redundancy version—2 bits
HARQ process number—4 bits
Downlink assignment index—0 or 2 or 4 bits
TPC command for scheduled PUCCH—2 bits
PUCCH resource indicator—3 bits
PDSCH-to-HARQ_feedback timing indicator—3 bits
Antenna ports—4, 5 or 6 bits
Transmission configuration indication—0 or 3 bits
SRS request—2 bits
CBG transmission information—0, 2, 4, 6, or 8 bits
CBG flushing out information—0 or 1 bit
DMRS sequence initialization—1 bit

### [PDCCH: CORESET, REG, CCE, Search Space]

Hereinafter, the downlink control channel in the 5G communication system will be described in more detail with reference to the drawings.

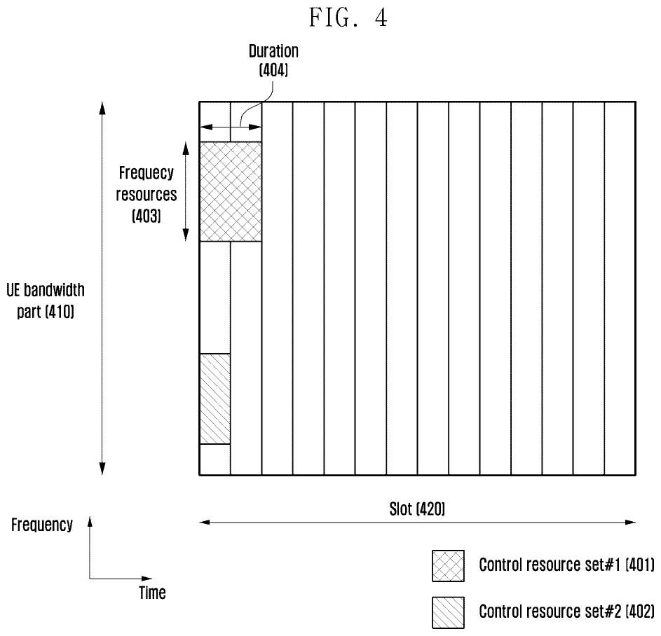

FIG. 4 illustrates an example of a control resource set (CORESET) in which a downlink control channel is transmitted in the wireless communication system. FIG. 4 illustrates an example in which a UE bandwidth part 410 is configured in the frequency domain and two control resource sets (control resource set #1 401 and control resource set #2 402) are configured within one slot 420 in the time domain. The control resource sets 401 and 402 may be configured in specific frequency resources 403 within a total UE BWP 410 in the frequency domain. The control resource set may be configured as one or a plurality of OFDM symbols in the time domain, which may be defined as a control resource set duration 404. With reference to the example illustrated in FIG. 4, the control resource set #1 401 may be configured as a control resource set duration of 2 symbols, and control resource set #2 402 may be configured as a control resource set duration of 1 symbol.

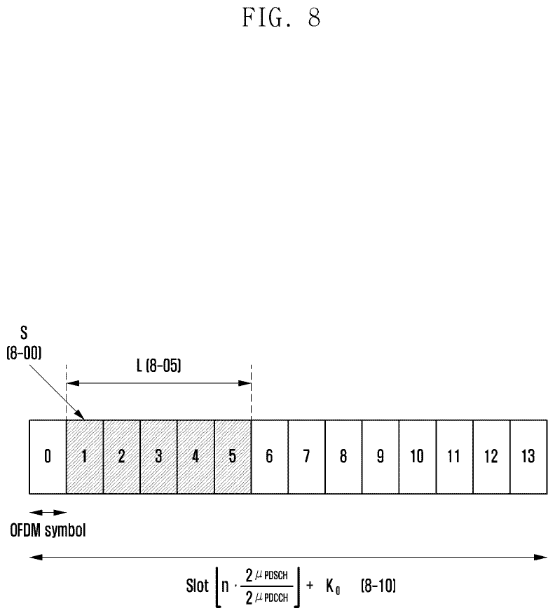

The above described resource control set in 5G may be configured in the UE by the base station through higher layer signaling (e.g., system information, a master information block (MIB), or radio resource control (RRC) signaling). Configuring the control resource set in the UE may mean providing information such as a control resource set identity, a frequency location of the control resource set, and a symbol length of the control resource set. For example, the information of FIG. 8 may be included.

TABLE 8

| | |
|---|---|
| ControlResourceSet ::= | SEQUENCE { |

-- Corresponds to L1 parameter ‘CORESET-ID’

| | |
|---|---|
| vcontrolResourceSetId | ControlResourceSetId, |

(control resource set identity)

| | |
|---|---|
| frequencyDomainResources | BIT STRING (SIZE (45)), |

(frequency domain resource allocation information)

| | |
|---|---|
| duration | INTEGER (1..maxCoReSetDuration), |

(time domain resource allocation information
)

| | |
|---|---|
| cce-REG-MappingType | CHOICE { |

(CCE-to-REG mapping type
)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG- |

bundle, allContiguousRBs},

| | |
|---|---|
| interleaverSize | ENUMERATED {n2, n3, n6} |

```
        (interleaver size)
        shiftIndex
  INTEGER(0..maxNrofPhysicalResourceBlocks-1)
  OPTIONAL
      (interleaver shift)
    },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |
| | OPTIONAL, -- Need S |

}

In Table 8, tci-StatesPDCCH (referred to as a transmission configuration indication (TCI) state) configuration information may include information on one or a plurality of synchronization signal (SS)/physical broadcast channel (PBCH) block indexes or channel state information reference signal (CSI-RS) indexes having the quasi co-located (QCL) relationship with a DMRS transmitted in the corresponding CORESET.

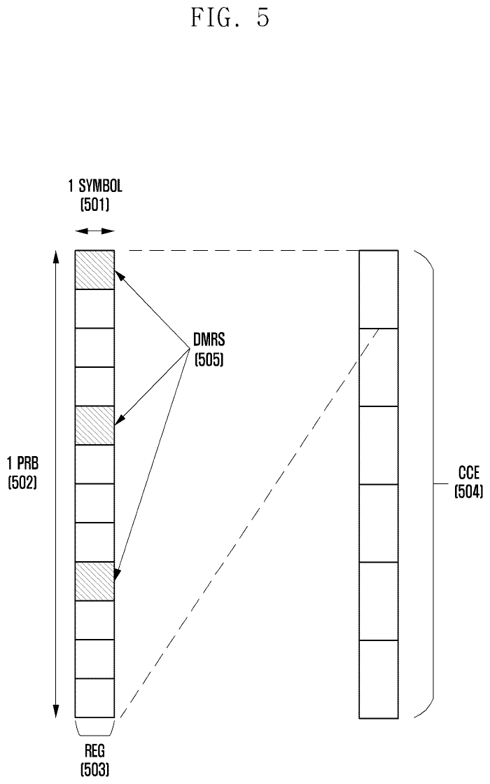

FIG. 5 illustrates an example of a basic unit of time and frequency resources constituting a downlink control channel used in 5G. With reference to FIG. 5, a basic unit of time and frequency resources constituting a control channel may be referred to as a resource element group (REG) 503, and the REG 503 may be defined as one OFDM symbol 501 in the time domain and one physical resource block (PRB) 502 in the frequency domain, that is, it may be defined as 12 subcarriers. The base station may constitute a downlink control channel allocation unit by concatenating the REG 503

As illustrated in FIG. 5, in the case that the basic unit in which downlink control channels are allocated in 5G is a control channel element (CCE) 504, one CCE 504 may include a plurality of REGs 503. For example, the REG 503 illustrated in FIG. 5 may be constituted with 12 REs and, when 1 CCE 504 is constituted with 6 REGs 503, 1 CCE 504 may be constituted with 72 REs. When a downlink control resource set is configured, the corresponding resource set may be constituted with a plurality of CCEs 504, and a specific downlink control channel may be mapped to one or a plurality of CCEs 504 according to an aggregation level (AL) within the control resource set and then transmitted. CCEs 504 within the control resource set may be distinguished by numbers and the numbers of the CCEs 504 may be assigned according to a logical mapping type.

The basic unit of the downlink control channel illustrated in FIG. 5, that is, the REG 503, may include all of REs to which the DCI is mapped and the region to which a DMRS 505, which is a reference signal for decoding the REs, is mapped. As illustrated in FIG. 5, 3 DMRSs 505 may be transmitted within 1 REG 503. The number of CCEs required to transmit the PDCCH may be 1, 2, 4, 8, or 16 according to the aggregation level (AL), and the different number of CCEs may be used to implement link adaptation of the downlink control channel. For example, in the case that AL=L, one downlink control channel may be transmitted through L CCEs. The UE needs to detect a signal in the state in which the UE is not aware of information on the downlink control channel, and a search space indicating a set of CCEs is defined for blind decoding. The search space is a set of downlink control channel candidates composed of CCEs for which the UE may attempt decoding at the given aggregation level, and there are several aggregation levels at which one set of CCEs is bundled by 1, 2, 4, 8, and 16 CCEs, so that the UE may have a plurality of search spaces. The search space set may be defined as a set of search spaces at all configured aggregation levels.

The search space may be classified into a common search space and a UE-specific search space. UEs in a predetermined group or all UEs may search for a common search space of the PDCCH in order to receive cell common control information such as dynamic scheduling for system information or paging messages. For example, PDSCH scheduling allocation information for transmission of an SIB including information on a service provider of a cell and the like may be received by searching for a common search space of the PDCCH. In the case of the common search space, UEs in a predetermined group or all UEs may receive the PDCCH, so that the common search space may be defined as a set of pre-arranged CCEs. Scheduling allocation information for the UE-specific PDSCH or PUSCH may be received by searching for a UE-specific search space of the PDCCH. The UE-specific search space may be UE-specifically defined as a UE identity and a function of various system parameters.

In 5G, parameters for the PDCCH search space may be configured in the UE by the base station through higher layer signaling (e.g., SIB, MIB, or RRC signaling). For example, the base station may configure, in the UE, the number of PDCCH candidates at each aggregation level L, a monitoring period of the search space, a monitoring occasion in units of symbols within the slot for the search space, a search space type (a common search space or a UE-specific search space), a combination of a DCI format and an RNTI to be monitored in the corresponding search space, a control resource set index for monitoring the search space, and the like. For example, the information of Table 9 may be included.

TABLE 9

| | |
|---|---|
| SearchSpace ::= | SEQUENCE { |

```
    -- Identity of the search space. SearchSpaceId = 0 identifies the SearchSpace
      configured via PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level period)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration(monitoring duration) | INTEGER (2..2559) |
| monitoringSymbolsWithinSlot | BIT STRING (SIZE (14)) |
| | OPTIONAL, |

(monitoring symbol in slot)

| | |
|---|---|
| nrofCandidates | SEQUENCE { |

(number of PDCCH candidates for aggregation level)

| | |
|---|---|
| aggregationLevel1 | ENUMERATED {n0, n1, n2, n3, n4, n5, |

n6, n8},

| | |
|---|---|
| aggregationLevel2 | ENUMERATED {n0, n1, n2, n3, n4, n5, |

n6, n8},

| | |
|---|---|
| aggregationLevel4 | ENUMERATED {n0, n1, n2, n3, n4, n5, |

n6, n8},

| | |
|---|---|
| aggregationLevel8 | ENUMERATED {n0, n1, n2, n3, n4, n5, |

n6, n8},

| | |
|---|---|
| aggregationLevel16 | ENUMERATED {n0, n1, n2, n3, n4, n5, |

```
      n6, n8}
    },
```

| | |
|---|---|
| searchSpaceType | CHOICE { |

```
    (search space type)
      -- Configures this search space as common search space (CSS) and DCI formats to
      monitor.
```

| | |
|---|---|
| common | SEQUENCE { |

```
      (common search space)
  }
```

| | |
|---|---|
| ue-Specific | SEQUENCE { |

```
      (UE-specific search space)
        -- Indicates whether the UE monitors in this USS for DCI formats 0-0 and 1-0 or
      for formats 0-1 and 1-1.
```

| | |
|---|---|
| formats | ENUMERATED {formats0-0-And-1-0, |

```
      formats0-1-And-1-1},
        ...
      }
```

The base station may configure one or a plurality of search space sets in the UE according to configuration information. According to some embodiments, the base station may configure search space set 1 and search space set 2 in the UE, and the configuration may be performed such that DCI format A scrambled by an X-RNTI in search space set 1 is monitored in the common search space and DCI format B scrambled by a Y-RNTI in search space set 2 is monitored in the UE-specific search space.

According to configuration information, one or a plurality of search space sets may exist in the common search space or the UE-specific search space. For example, search space set #1 and search space set #2 may be configured as common search spaces, and search space set #3 and search space set #4 may be configured as UE-specific search spaces.

In the common search space, the following combinations of DCI formats and RNTIs may be monitored. It is apparent that the disclosure is not limited to the following examples:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

In the UE-specific search space, the following combinations of DCI formats and RNTIs may be monitored. It is apparent that the disclosure is not limited to the following examples:
DCI format 0_0/1_0 with CRC scrambled by C-RNTI, CS-RNTI, TC-RNTI;
and/or
DCI format 1_0/1_1 with CRC scrambled by C-RNTI, CS-RNTI, TC-RNTI.

The described RNTIs may follow the following definition and use:
C-RNTI (Cell RNTI): a use for scheduling UE-specific PDSCH;
TC-RNTI (Temporary Cell RNTI): a use for scheduling UE-specific PDSCH;
CS-RNTI (Configured Scheduling RNTI): a use for semi-statically configured UE-specific PDSCH scheduling;
RA-RNTI (Random Access RNTI): a use for PDSCH scheduling at random access stage;
P-RNTI (Paging RNTI): a use for PDSCH scheduling through which paging is transmitted;
SI-RNTI (System Information RNTI): a use for PDSCH scheduling through which system information is transmitted;
INT-RNTI (Interruption RNTI): a use for indicating whether puncturing is performed for PDSCH;
TPC-PUSCH-RNTI (Transmit Power Control for PUSCH RNTI): a use for indicating PUSCH power control command;
TPC-PUCCH-RNTI (Transmit Power Control for PUCCH RNTI): a use for indicating PUCCH power control command; and/or
TPC-SRS-RNTI (Transmit Power Control for SRS RNTI): a use for indicating SRS power control command.

The above described DCI formats may follow definitions as in the examples of Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, the search space of an aggregation level L in a control resource set p and search space set s may be expressed as in Equation 1 below.

$$L \cdot \{ ( {Y}_{p , {n}_{s , f}^{μ}} + ⌊ \frac{{n}_{s , {n}_{CI}} \cdot {N}_{CCE , p}}{L \cdot {M}_{s , max}^{( L )}} ⌋ + {n}_{Ci} ) mod ⌊ \frac{{N}_{CCE , p}}{L} ⌋ \} + i \qquad [ Equation 1 ]$$

$$where : - L : Aggregation level ;$$

$$- {n}_{CI} : Carrier index ;$$

$$- {N}_{CCE , p} : Total number of CCEs in control resource set p ;$$

$$- {n}_{s , f}^{μ} : Slot index ;$$

$$- {M}_{s , max}^{( L )} : The number of PDCCH candidates in aggregation level L ;$$

$$- {m}_{s , {n}_{CI}} = 0 , … , {M}_{s , max}^{( L )} - 1 : PDCCH candidate index in aggregation level L ;$$

$$- i = 0 , … , L - 1 ;$$

$$- {Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 ,$$

$${A}_{p} = 39827 for pmod 3 = 0 , {A}_{p} = 39829 for pmod 3 = 1 ,$$

$${A}_{p} = 39839 for pmod 3 = 2 , D = 65537 ; and$$

$$- {n}_{RNTI} : UE identity .$$

The value Y_{p,n}_{_{s,f}}_{^{μ}} may correspond to zero in the case of a common search space.

In the case of a UE-specific search space, the value Y_{p,n}_{_{s,f}}_{^{μ}} may correspond to a value that varies depending on the UE identity (C-RNTI or an ID configured to the UE by the base station) and a time index.

In 5G, since a plurality of search space sets may be configured using different parameters (e.g., the parameters in Table 9), a set of search space sets monitored by the UE may differ at each time. For example, in the case that search space set #1 is configured in an X-slot periodicity, and search space set #2 is configured in a Y-slot periodicity, and X and Y are different, the UE may monitor both search space set #1 and search space set #2 in a specific slot, and may monitor one of search space set #1 and search space set #2 in a specific slot.

### [PDCCH: BD/CCE Limit]

In the case where a plurality of search space sets is configured for the UE, the following conditions may be considered in a method for determining a search space set to be monitored by the UE.

If a value “monitoringCapabilityConfig-r16,” which is higher layer signaling, is configured as “r15 monitoringcapability,” the UE defines the maximum values of the number of PDCCH candidates capable of being monitored and the number of CCEs constituting the entire search space (here, the entire search space means an entire CCE set corresponding to the union area of a plurality of search space sets) for each slot, and if the value “monitoringCapabilityConfig-r16” is configured as “r16 monitoringcapability,” the UE defines the maximum values of the number of PDCCH candidates capable of being monitored and the number of CCEs constituting the entire search space (here, the entire search space means an entire CCE set corresponding to the union area of a plurality of search space sets) for each span.

### [Condition 1: Limit of Maximum Number of PDCCH Candidates]

According to the configuration value of higher layer signaling described above, M^{μ}, the maximum number of PDCCH candidates capable of being monitored by the UE, may be configured according to Table 11 below in the case that it is defined based on a slot, and may be configured according to Table 12 below in the case that it is defined based on a span, in a cell configured with a subcarrier spacing of 15.24 KHz.

TABLE 11

| | Maximum number of PDCCH candidates |
|---|---|
| μ | per slot and per serving cell (M^{μ}) |
| 0 | 44 |
| 1 | 36 |
| 2 | 22 |
| 3 | 20 |

TABLE 12

| | Maximum number M^{μ} of monitored PDCCH candidates | | |
|---|---|---|---|
| | per span for combination (X, Y) and per serving cell | | |
| μ | (2, 2) | (4, 3) | (7, 3) |
| 0 | 14 | 28 | 44 |
| 1 | 12 | 24 | 36 |

### [Condition 2: Limit of Maximum Number of CCEs]

According to the configuration value of higher layer signaling described above, C^{μ}, the maximum number of CCEs constituting the entire search space (here, the entire search space means the entire CCE set corresponding to the union area of a plurality of search space sets), may be configured according to Table 13 below in the case that it is defined based on a slot, and may be configured according to Table 14 below in the case that it is defined based on a span, in a cell configured with a subcarrier spacing of 15.24 kHz.

TABLE 13

| | Maximum number of non-overlapped CCEs |
|---|---|
| μ | per slot and per serving cell (C^{μ}) |
| 0 | 56 |
| 1 | 56 |
| 2 | 48 |
| 3 | 32 |

TABLE 14

| | Maximum number C^{μ} of non-overlapped CCEs per | | |
|---|---|---|---|
| | span for combination (X, Y) and per serving cell | | |
| μ | (2, 2) | (4, 3) | (7, 3) |
| 0 | 18 | 36 | 56 |
| 1 | 18 | 36 | 56 |

For convenience of explanation, a situation that satisfies both conditions 1 and 2 above at a specific time is defined as “condition A.” Therefore, a situation that does not satisfy condition A may mean that the situation does not satisfy at least one of conditions 1 and 2 above.

### [PDCCH: Overbooking]

Condition A may not be satisfied at a specific time depending on the configuration of search space sets by the base station. In the case that condition A is not satisfied at a specific time, the UE may select and monitor only some of the search space sets configured to satisfy condition A at that time, and the base station may transmit a PDCCH to the selected search space sets.

A method for selecting some search spaces from among the overall configured search space sets may be performed according to the following methods.

In the case that condition A for a PDCCH is not satisfied at a specific time (slot), the UE (or the base station) may preferentially select the search space set in which the search space type is configured as a common search space from among the search space sets existing at the corresponding time, instead of the search space set in which the search space type is configured as a UE-specific search space.

In the case that all search space sets configured as a common search space are selected (that is, in the case that condition A is satisfied even after selecting all search spaces configured as a common search space), the UE (or the base station) may select the search space sets configured as a UE-specific search space. In this case, in the case that there is a plurality of search space sets configured as a UE-specific search space, the search space set having a lower search space set index may have a higher priority. The UE may select UE-specific search space sets within a range in which condition A is satisfied in consideration of priority.

### [In Relation to Rate Matching/Puncturing]

Hereinafter, a rate matching operation and puncturing operation will be described in detail.

In the case where time-and-frequency resources A to transmit arbitrary symbol sequences A overlaps arbitrary time-and-frequency resources B, a rate matching or puncturing operation may be considered as a transmission/reception operation of a channel A in consideration of a resource C of the area where the resources A and the resources B overlap. A detailed operation may be as follows.

### Rate Matching Operation

The base station may map the channel A only to the remaining resource areas, excluding the resource C corresponding to the area overlapping the resources B, among all the resources A for transmitting the symbol sequences A to the UE, and transmit the same. For example, in the case where the symbol sequences A is constituted with {symbol #1, symbol #2, symbol #3, symbol #4}, where the resources A are {resource #1, resource #2, resource #3, resource #4}, and where the resources B are {resource #3, resource #5}, the base station may sequentially map the symbol sequences A to the remaining resources {resource #1, resource #2, resource #4}, excluding {resource #3} corresponding to the resource C, among the resources A, and transmit the same. As a result, the base station may map the symbol sequences {symbol #1, symbol #2, symbol #3} to {resource #1, resource #2, resource #4}, respectively, and transmit the same.

The UE may determine the resources A and the resources B from scheduling information for the symbol sequences A from the base station and determine the resource C, which is an area where the resources A and the resources B overlap, according thereto. The UE may receive the symbol sequences A, assuming that the symbol sequences A are mapped and transmitted in the remaining areas, excluding the resource C, among all the resources A. For example, in the case where the symbol sequences A are constituted with {symbol #1, symbol #2, symbol #3, symbol #4}, where the resources A are {resource #1, resource #2, resource #3, resource #4}, where the resources B are {resource #3, resource #5}, the UE may receive the symbol sequences A, assuming that the symbol sequences A are sequentially mapped to the remaining resources {resource #1, resource #2, resource #4}, excluding {resource #3} corresponding to the resource C, among the resources A. As a result, the UE may perform a series of subsequent reception operations, assuming that the symbol sequences {symbol #1, symbol #2, symbol #3} are mapped to the resources {resource #1, resource #2, resource #4}, respectively, and transmitted.

### Puncturing Operation

In the case that there is a resource C corresponding to the area overlapping the resources B, among all the resources A for transmitting the symbol sequences A to the UE, the base station may map the symbol sequences A to all the resources A and transmit only the remaining resource areas, excluding the resource C from among the resources A, instead of transmitting the resource area corresponding to the resource C. For example, in the case where the symbol sequences A are constituted with {symbol #1, symbol #2, symbol #3, symbol 4}, where the resources A are {resource #1, resource #2, resource #3, resource #4}, and where the resources B are {resource #3, resource #5}, the base station may map the symbol sequences A {symbol #1, symbol #2, symbol #3, symbol #4} to the resources A {resource #1, resource #2, resource #3, resource #4}, respectively, and transmit only the symbol sequence {symbol #1, symbol #2, symbol #4} corresponding to {resource #1, resource #2, resource #4}, which are the remaining resources excluding {resource #3} corresponding to resource C from among the resources A, instead of transmitting {symbol #3} mapped to {resource #3} corresponding to the resource C. As a result, the base station may map the symbol sequences {symbol #1, symbol #2, symbol #4} to {resource #1, resource #2, resource #4}, respectively, and transmit the same.

The UE may determine the resources A and the resources B from scheduling information for the symbol sequences A from the base station and determine the resource C, which is an area where the resources A and the resources B overlap, according thereto. The UE may receive the symbol sequence A, assuming that the symbol sequences A are mapped to all the resources A but transmitted only in the remaining areas, excluding the resource C from among the resource areas A. For example, in the case where the symbol sequences A are constituted with {symbol #1, symbol #2, symbol #3, symbol #4}, where the resources A are {resource #1, resource #2, resource #3, resource #4}, where the resources B are {resource #3, resource #5}, the UE may receive the symbol sequences A, assuming that the symbol sequences A {symbol #1, symbol #2, symbol #3, symbol #4} are mapped to the resources A {resource #1, resource #2, resource #3, resource #4}, respectively, but {symbol #3} mapped to {resource #3} corresponding to resource C is not transmitted, and assuming that the symbol sequences {symbol #1, symbol #2, symbol #4} corresponding to the remaining resources {resource #1, resource #2, resource #4}, excluding {resource #3} corresponding to the resource C from among the resources A, are mapped and transmitted. As a result, the UE may perform a series of subsequent reception operations, assuming that the symbol sequences {symbol #1, symbol #2, symbol #4} are mapped to the resources {resource #1, resource #2, resource #4}, respectively, and transmitted.

Hereinafter, a method for configuring a rate matching resource for the purpose of rate matching in a 5G communication system will be described. Rate matching means that the magnitude of a signal is adjusted in consideration of the number of resources capable of transmitting the signal. For example, rate matching of a data channel may mean that the amount of data is adjusted by not mapping and transmitting a data channel for a specific time-and-frequency resource area.

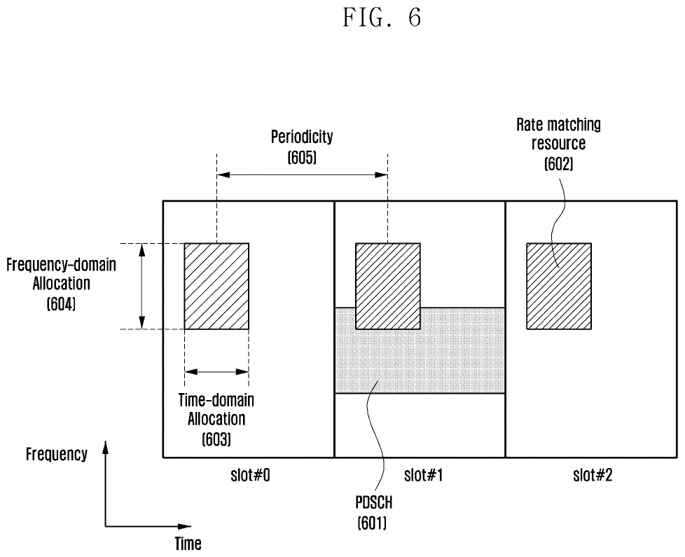

FIG. 6 illustrates a method for a base station and a UE to transmit/receive data in consideration of a downlink data channel and a rate matching resource.

FIG. 6 shows a downlink data channel (PDSCH) 601 and rate matching resources 602. The base station may configure one or a plurality of rate matching resources 602 for the UE through higher layer signaling (e.g., RRC signaling). Configuration information of the rate matching resource 602 may include time domain resource allocation information 603, frequency domain resource allocation information 604, and periodicity information 605. In the following description, the bitmap corresponding to the frequency domain resource allocation information 604 will be referred to as a “first bitmap,” the bitmap corresponding to the time domain resource allocation information 603 will be referred to as a “second bitmap,” and the bitmap corresponding to the periodicity information 605 will be referred to as a “third bitmap.” In the case where all or some of the time and frequency resources of the scheduled data channel 601 overlap the configured rate matching resources 602, the base station may rate-match the data channel 601 in the rate matching resource 602 part and transmit the same, and the UE may perform reception and decoding, assuming that the data channel 601 is rate-matched in the rate matching resource 602 part.

The base station may dynamically notify the UE through DCI of whether or not to rate-match the data channel in the configured rate matching resource part by additional configuration (this corresponds to a “rate matching indicator” in the DCI format described above). Specifically, the base station may select some of the configured rate matching resources to group them into a rate matching resource group, and indicate whether or not to rate-match the data channel for each rate matching resource group to the UE through DCI in a bitmap manner. For example, in the case where four rate matching resources, RMR #1, RMR #2, RMR #3, and RMR #4, are configured, the base station may configure RMG #1={RMR #1, RMR #2} and RMG #2={RMR #3, RMR #4} as rate matching groups and may indicate whether or not to rate-match the data channel in RMG #1 and RMG #2, respectively, to the UE through a bitmap using 2 bits in the DCI field. For example, the case that requires rate-matching may be indicated as 1, and the case that does not require rate-matching may be indicated as 0.

5G supports the granularity of an “RB symbol level” and an “RE level” as a method for configuring the above-described rate matching resources for the UE. More specifically, the following configuration method may be provided.

### RB Symbol Level

The UE may receive a configuration of up to four RateMatchPatterns for each BWP through higher layer signaling, and one RateMatchPattern may include the following:
As a reserved resource within the BWP, a resource in which a time and frequency resource area of the corresponding reserved resource is configured by a combination of a bitmap of an RB level and a bitmap of a symbol level in the frequency domain may be included. The reserved resource may be spanned across one or two slots. A time domain pattern (periodicity AndPattern) in which time and frequency areas constituted with a pair of RB level and symbol level bitmaps are repeated may be further configured; and/or
A time and frequency domain resource area configured as a control resource set in the BWP and a resource area corresponding to a time domain pattern configured as a search space where the corresponding resource areas is repeated may be included.

### RE Level

The UE may receive configurations below through higher layer signaling:
As configuration information (Ite-CRS-ToMatchAround) for an RE corresponding to an LTE CRS (cell-specific reference signal or common reference signal) pattern, the number of LTE CRS ports (nrofCRS-Ports), an LTE-CRS-vshift(s) value (v-shift), center subcarrier location information (carrierFreqDL) of an LTE carrier from a reference frequency point (e.g., reference point A), information on the bandwidth size of an LTE carrier (carrierBandwidthDL), subframe configuration information (mbsfn-SubframConfigList) corresponding to a multicast-broadcast single-frequency network (MBSFN), and the like may be included. The UE may determine the location of the CRS in the NR slot corresponding to an LTE subframe, based on the above-described information; and/or
Configuration information on a resource set corresponding to one or a plurality of zero power (ZP) CSI-RS within the BWP may be included.

### [In Relation to LTE CRS Rate Match]

Next, the rate matching process for the above-described LTE CRS will be described in detail. For the coexistence of LTE (Long-Term Evolution) and NR (New RAT), NR may configure an NR UE with a function of configuring a CRS (cell-specific reference signal) pattern of LTE. More specifically, the above CRS pattern may be provided by RRC signaling including at least one parameter in ServingCellConfig IE (information element) or ServingCellConfigCommon IE. Examples of the above parameter may include Ite-CRS-ToMatch Around, lte-CRS-PatternList1-r16, Ite-CRS-PatternList2-r16, crs-RateMatch-PerCORESETPoolIndex-r16, and the like.

In Rel-15 NR, one CRS pattern may be configured in each serving cell through the parameter lte-CRS-ToMatchAround. In Rel-16 NR, the above function has been extended to enable configuring of a plurality of CRS patterns for each serving cell. More specifically, one CRS pattern per one LTE carrier may be configured in a single-TRP (transmission and reception point)-configured UE, and two CRS patterns per one LTE carrier may be configured in a multi-TRP-configured UE. For example, it is possible to configure up to three CRS patterns per serving cell in the single-TRP-configured UE through the parameter lte-CRS-PatternList1-r16. As another example, a CRS may be configured for each TRP in the multi-TRP-configured UE. That is, a CRS pattern for TRP1 may be configured through a parameter lte-CRS-PatternList1-r16, and a CRS pattern for TRP2 may be configured through a parameter lte-CRS-PatternList2-r16. Meanwhile, in the case where two TRPs are configured as described above, whether or not to apply both the CRS patterns of TRP1 and TRP2 to a specific Physical Downlink Shared Channel (PDSCH) or whether or not to apply only the CRS pattern for one TRP thereto is determined through a parameter crs-RateMatch-PerCORESETPoolIndex-r16, and if the parameter crs-RateMatch-PerCORESETPoolIndex-r16 is configured to be enabled, the CRS pattern for only one TRP is applied, otherwise, the CRS patterns for both TRPs are applied.

Table 15 shows a ServingCellConfig IE including the above CRS pattern, and Table 16 shows a RateMatchPatternLTE-CRS IE including at least one parameter for the CRS pattern.

TABLE 15

| ServingCellConfig ::= | SEQUENCE { | |
|---|---|---|
| tdd-UL-DL-ConfigurationDedicated | TDD-UL-DL-ConfigDedicated | OPTIONAL, |

-- Cond TDD

| | | |
|---|---|---|
| initialDownlinkBWP | BWP-DownlinkDedicated | OPTIONAL, -- Need M |

| | |
|---|---|
| downlinkBWP-ToReleaseList | SEQUENCE (SIZE (1..maxNrofBWPs)) OF BWP-Id |

OPTIONAL, -- Need N

| downlinkBWP-ToAddModList | SEQUENCE (SIZE (1..maxNrofBWPs)) OF BWP- | |
|---|---|---|
| Downlink | OPTIONAL, -- Need N | |
| firstActiveDownlinkBWP-Id | BWP-Id | OPTIONAL, -- Cond |

SyncAndCellAdd

| | |
|---|---|
| bwp-InactivityTimer | ENUMERATED {ms2, ms3, ms4, ms5, ms6, ms8, ms10, ms20, |

ms30,

| | ms40,ms50, ms60, ms80,ms100, ms200,ms300, ms500, | |
|---|---|---|
| | ms750, ms1280, ms1920, ms2560, spare10, spare9, spare8, | |
| | spare7, spare6, spare5, spare4, spare3, spare2, spare1 } | OPTIONAL, --Need R |
| defaultDownlinkBWP-Id | BWP-Id | OPTIONAL, -- Need S |
| uplinkConfig | UplinkConfig | OPTIONAL, -- Need M |
| supplementaryUplink | UplinkConfig | OPTIONAL, -- Need M |

| | |
|---|---|
| pdcch-ServingCellConfig | SetupRelease { PDCCH-ServingCellConfig } |

OPTIONAL, -- Need M

| | | |
|---|---|---|
| pdsch-ServingCellConfig | SetupRelease { PDSCH-ServingCellConfig } | OPTIONAL, |

-- Need M

| csi-MeasConfig | SetupRelease { CSI-MeasConfig } | OPTIONAL, -- Need M |
|---|---|---|
| sCellDeactivationTimer | ENUMERATED {ms20, ms40, ms80, ms160, ms200, ms240, | |
| | ms320, ms400, ms480, ms520, ms640, ms720, | |
| | ms840, ms1280, spare2,spare1} | OPTIONAL, -- Cond |

ServingCellWithoutPUCCH

| | | |
|---|---|---|
| crossCarrierSchedulingConfig | CrossCarrierSchedulingConfig | OPTIONAL, -- |

Need M

| tag-Id | TAG-Id, | |
|---|---|---|
| dummy | ENUMERATED {enabled} | OPTIONAL, -- Need R |

| | | |
|---|---|---|
| pathlossReferenceLinking | ENUMERATED {spCell, sCell} | OPTIONAL, -- |

Cond SCellOnly

| | | |
|---|---|---|
| servingCellMO | MeasObjectId | OPTIONAL, -- Cond MeasObject |

```
  ...,
  [[
```

| | |
|---|---|
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE (1..maxNrofRateMatchPatterns)) OF |
| RateMatchPattern | OPTIONAL, -- Need N |
| rateMatchPatternToReleaseList | SEQUENCE (SIZE (1..maxNrofRateMatchPatterns)) OF |
| RateMatchPatternId | OPTIONAL, -- Need N |
| downlinkChannelBW-PerSCS-List | SEQUENCE (SIZE (1..maxSCSs)) OF SCS- |
| SpecificCarrier | OPTIONAL -- Need S |

```
  ]],
  [[
```

| | | |
|---|---|---|
| supplementaryUplinkRelease | ENUMERATED {true} | OPTIONAL, -- Need |

N

| | |
|---|---|
| tdd-UL-DL-ConfigurationDedicated-IAB-MT-r16 | TDD-UL-DL-ConfigDedicated-IAB-MT- |

r16 OPTIONAL, -- Cond TDD_IAB

| | | |
|---|---|---|
| dormantBWP-Config-r16 | SetupRelease { DormantBWP-Config-r16 } | OPTIONAL, |

-- Need M

| ca-SlotOffset-r16 | CHOICE { | |
|---|---|---|
| refSCS15kHz | INTEGER (−2..2), | |
| refSCS30KHz | INTEGER (−5..5), | |
| refSCS60KHz | INTEGER (−10..10), | |
| refSCS120KHz | INTEGER (−20..20) | |
| } | OPTIONAL, -- Cond AsyncCA | |
| channelAccessConfig-r16 | SetupRelease { ChannelAccessConfig-r16 } | OPTIONAL, |

-- Need M

| intraCellGuardBandsDL-List-r16 | SEQUENCE (SIZE (1..maxSCSs)) OF | |
|---|---|---|
| IntraCellGuardBandsPerSCS-r16 | OPTIONAL, -- Need S | |
| intraCellGuardBandsUL-List-r16 | SEQUENCE (SIZE (1..maxSCSs)) OF | |
| IntraCellGuardBandsPerSCS-r16 | OPTIONAL, -- Need S | |
| csi-RS-ValidationWith-DCI-r16 | ENUMERATED {enabled} | OPTIONAL, -- |

Need R

| | | |
|---|---|---|
| lte-CRS-PatternList1-r16 | SetupRelease { LTE-CRS-PatternList-r16 } | OPTIONAL, |

-- Need M

| | | |
|---|---|---|
| lte-CRS-PatternList2-r16 | SetupRelease { LTE-CRS-PatternList-r16 } | OPTIONAL, |

-- Need M

| | | |
|---|---|---|
| crs-RateMatch-PerCORESETPoolIndex-r16 | ENUMERATED | {enabled} |

OPTIONAL, -- Need R

| | | |
|---|---|---|
| enableTwoDefaultTCI-States-r16 | ENUMERATED {enabled} | OPTIONAL, - |

- Need R

| | | |
|---|---|---|
| enableDefaultTCI-StatePerCoresetPoolIndex-r16 | ENUMERATED | {enabled} |

OPTIONAL, -- Need R

| | | |
|---|---|---|
| enableBeamSwitchTiming-r16 | ENUMERATED {true} | OPTIONAL, -- |

Need R

| | | |
|---|---|---|
| cbg-TxDiffTBsProcessingType1-r16 | ENUMERATED {enabled} | OPTIONAL, |

-- Need R

| | | |
|---|---|---|
| cbg-TxDiffTBsProcessingType2-r16 | ENUMERATED {enabled} | OPTIONAL |

-- Need R
]]
}

```
TABLE 16
    - RateMatchPatternLTE-CRS
The IE RateMatchPatternLTE-CRS is used to configure a pattern to rate match around LTE
CRS. See TS 38.214.
    RateMatchPatternLTE-CRS information element
-- ASN1START
-- TAG-RATEMATCHPATTERNLTE-CRS-START
```

| RateMatchPatternLTE-CRS ::= | SEQUENCE { | |
|---|---|---|
| carrierFreqDL | INTEGER (0..16383), | |
| carrierBandwidthDL | ENUMERATED {n6, n15, n25, n50, n75, n100, spare2, spare1}, | |
| mbsfn-SubframeConfigList | EUTRA-MBSFN-SubframeConfigList | OPTIONAL, |

-- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) OF |

RateMatchPatternLTE-CRS
-- TAG-RATEMATCHPATTERNLTE-CRS-STOP
-- ASN1STOP

RateMatchPatternLTE-CRS field descriptions
carrierBandwidthDL
BW of the LTE carrier in number of PRBs (see TS 38.214).
carrierFreqDL
Center of the LTE carrier (see TS 38.214).
mbsfn-SubframeConfigList
LTE MBSFN subframe configuration (see TS 38.214).
nrofCRS-Ports
Number of LTE CRS antenna port to rate-match around (see TS 38.214).
v-Shift
Shifting value v-shift in LTE to rate match around LTE CRS (see TS 38.214).

### [PDSCH: In Relation to Frequency Resource Allocation]

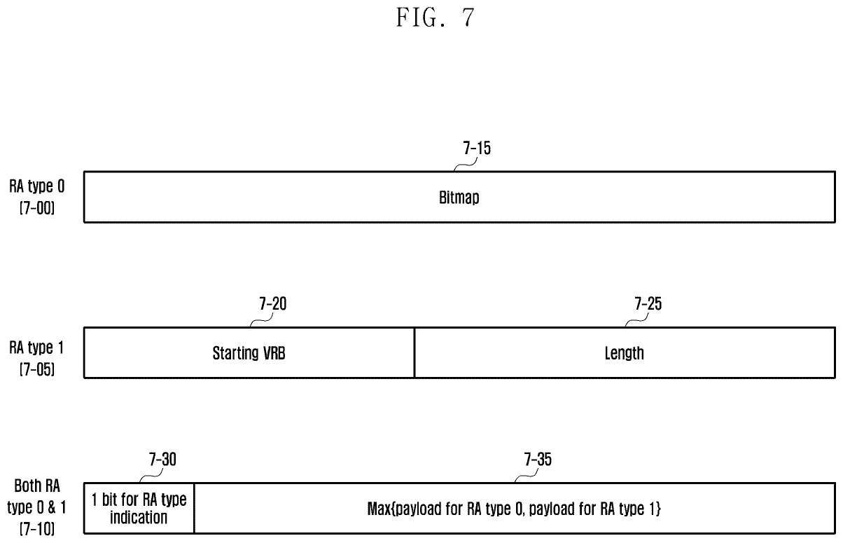

FIG. 7 illustrates an example of allocating resources on a frequency domain of a physical downlink shared channel (PDSCH) in a wireless communication system according to an embodiment of the disclosure.

FIG. 7 illustrates three frequency domain resource allocation methods of type 0 (7-00), type 1 (7-05), and dynamic switch (7-10) that may be configured through a higher layer in an NR wireless communication system.

With reference to FIG. 7, in the case where the UE is configured to use only resource type 0 through higher layer signaling 7-00, some downlink control information (DCI) for allocating a PDSCH to the corresponding UE includes a bitmap constituted with NRBG bits. The conditions for this will be described later. In this case, NRBG refers to the number of resource block groups (RBGs) determined as shown in Table 17 below according to a BWP size allocated by a BWP indicator and a higher layer parameter rbg-Size, and data is transmitted in the RBG indicated as 1 by a bitmap.

TABLE 17

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In the case where the UE is configured to use only resource type 1 through higher layer signaling 7-05, some DC for allocating a PDSCH to the corresponding UE includes frequency domain resource allocation information of ┌log₂(N_{RB}^{DL,BWP}(N_{RB}^{DL,BWP}+1)/2┐ bits. The conditions for this will be described later. The base station may configure a starting VRB 7-20 according thereto and the length 7-25 of a frequency domain resource that is allocated subsequently thereto

In the case where the UE is configured to use both resource type 0 and resource type 1 through higher layer signaling 7-10, some DCI for allocating a PDSCH to the corresponding UE includes frequency domain resource allocation information of bits constituted with a larger value 7-35 of a payload 7-15 for configuring resource type 0 and payloads 7-20 and 7-25 for configuring resource type 1. The conditions for this will be described later. In this case, one bit may be added to the foremost part (MSB) of the frequency domain resource allocation information in DCI, and in the case where the corresponding bit has a value 0, it may indicate that resource type 0 is used, and in the case where the corresponding bit has a value 1, it may indicate that resource type 1 is used.

### [PDSCH/PUSCH: In Relation to Time Resource Allocation]

A time domain resource allocation method for a data channel in a next-generation mobile communication system (5G or NR system) will be described below

The base station may configure a table for time domain resource allocation information on a downlink data channel (physical downlink shared channel (PDSCH)) and an uplink data channel (physical uplink shared channel (PUSCH)) for the UE using higher layer signaling (e.g., RRC signaling). A table constituted as up to maxNrofDL-Allocations=16 entries may be configured for a PDSCH, and a table constituted as up to maxNrofUL-Allocations=16 entries may be configured for a PUSCH. In an embodiment, the time domain resource allocation information may include PDCCH-to-PDSCH slot timing (corresponding to the time interval in slot units between the time at which a PDCCH is received and the time at which a PDSCH scheduled by the received PDCCH is transmitted, and denoted by K0), PDCCH-to-PUSCH slot timing (corresponding to the time interval in slot units between the time at which a PDCCH is received and the time at which a PUSCH scheduled by the received PDCCH is transmitted, and denoted by K2), information on the location and length of a start symbol in which the PDSCH or PUSCH is scheduled in the slot, a mapping type of a PDSCH or PUSCH, and the like. For example, information shown in Table 18 or Table 19 below may be transmitted from the base station to the UE.

TABLE 18
PDSCH-TimeDomainResourceAllocationList information element

[symbol]

-TimeDomainResurceAllocationList ::= SEQUENCE (SIZE(1..maxNrofDL-Allocations)) OF [symbol]
-TimeDomainResourceAllocation [symbol]
-TimeDomainResourceAllocation ::= SEQUENCE {

| | |
|---|---|
| k0 | INTEGER(0..32) |

OPTIONAL, -- Need S [symbol]
-to- [symbol] slot unit

[symbol]

| | |
|---|---|
| mappingType | ENUMERATED {typeA, typeB}, |

[symbol]

mapping type

[symbol]

| | |
|---|---|
| startSymbolAndLength | INTEGER (0..127) |

( [symbol] start symbol and length

[symbol]

[symbol]

[symbol]

indicates data missing or illegible when filed

TABLE 19
PUSCH-TimeDomainResourceAllocation information element

[symbol]

-TimeDomainResourceAllocationList ::= SEQUENCE (SIZE(1..maxNrofUL-Allocations)) OF [symbol]
-TimeDomainResourceAllocation [symbol]
-TimeDomainResourceAllocations ::= SEQUENCE {

| | | |
|---|---|---|
| k2 | INTEGER(0..32) | OPTIONAL, -- Need S |

[symbol]

-to- [symbol] slot unit

[symbol]

| | |
|---|---|
| mappingType | ENUMERATED {typeA, typeB}, |

[symbol]

mapping type

[symbol]

| | |
|---|---|
| startSymbolAndLength | INTEGER (0..127) |

[symbol]

start symbol length

[symbol]

[symbol]

[symbol]

indicates data missing or illegible when filed

The base station may notify the UE of one of the entries in the table for the time domain resource allocation information described above through L1 signaling (e.g., DCI) (e.g., it may be indicated by a “time domain resource allocation field” in DCI). The UE may obtain time domain resource allocation information for the PDSCH or PUSCH, based on the DCI received from the base station.

FIG. 8 illustrates an example of time domain resource allocation of a PDSCH in a wireless communication system according to an embodiment of the disclosure.

With reference to FIG. 8, the base station may indicate the time domain location of a PDSCH resource according to the subcarrier spacing (SCS) (μ_{PDSCH}, μ_{PDCCH}) of a data channel and a control channel configured using a higher layer, a scheduling offset value (K0), a starting location 8-00 of OFDM symbols within one slot dynamically indicated through DCI, and the length 8-05 thereof.

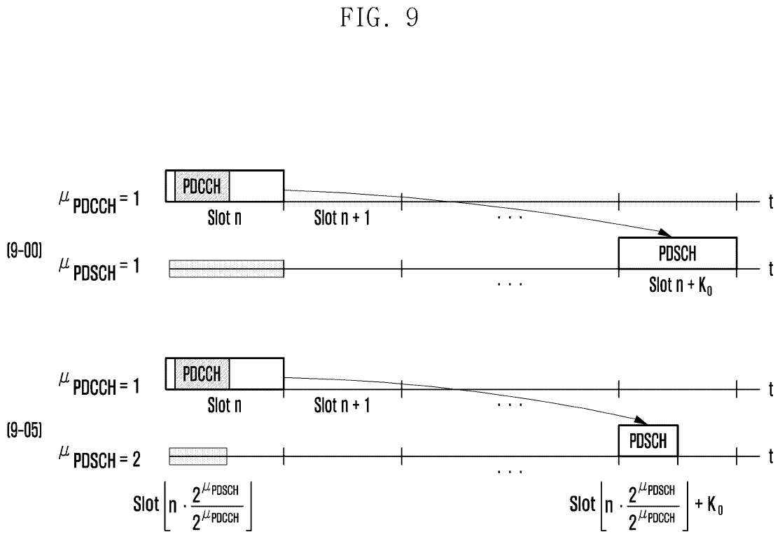

FIG. 9 illustrates an example of time domain resource allocation depending on subcarrier spacing of a data channel and a control channel in a wireless communication system according to an embodiment of the disclosure.

With reference to FIG. 9, in the case where the subcarrier spacing of the data channel is the same as the subcarrier spacing of the control channel 9-00 (μ_{PDSCH}=μ_{PDCCH}), the slot numbers for the data and control are the same, so the base station and the UE may generate a scheduling offset according to a predetermined slot offset K0. On the other hand, in the case where the subcarrier spacing of the data channel is different from the subcarrier spacing of the control channel 9-05 (μ_{PDSCH}≠μ_{PDCCH}), the slot numbers for the data and control are different from each other, so the base station and the UE may generate a scheduling offset according to a predetermined slot offset K0, based on the subcarrier spacing of the PDCCH.

### [PUSCH: In Relation to Transmission Method]

Next, a scheduling method of PUSCH transmission will be described. PUSCH transmission may be dynamically scheduled by a UL grant in DCI, or may be operated by configured grant Type 1 or Type 2. Dynamic scheduling indication for PUSCH transmission may be performed through DCI format 0_0 or 0_1.

PUSCH transmission in the configured grant Type 1 may be semi-statically configured through reception of configuredGrantConfig including rrc-ConfiguredUplinkGrant in Table 20 using higher layer signaling without receiving a UL grant in DCI. PUSCH transmission in the configured grant Type 2 may be semi-continuously scheduled by a UL grant in DCI after reception of configuredGrantConfig that does not include rrc-ConfiguredUplinkGrant in Table 20 through higher layer signaling. In the case where PUSCH transmission is operated by a configured grant, parameters applied to PUSCH transmission are applied through the higher layer signaling configuredGrantConfig in Table 20, excluding dataScramblingIdentityPUSCH, txConfig, codebookSubset, maxRank, and scaling of UCI-OnPUSCH, which are provided through higher layer signaling pusch-Config in Table 21. If the UE is provided with transformPrecoder in configuredGrantConfig, which is the higher layer signaling in Table 20, the UE applies tp-pi2 BPSK in pusch-Config of Table 21 to PUSCH transmission operated by a configured grant.

TABLE 20

| ConfiguredGrantConfig ::= | SEQUENCE { | |
|---|---|---|
| frequencyHopping | ENUMERATED {intraSlot, interSlot} | OPTIONAL, -- |

Need S,

| cg-DMRS-Configuration | DMRS-UplinkConfig, | |
|---|---|---|
| mcs-Table | ENUMERATED {qam256, qam64LowSE} | OPTIONAL, -- |

Need S

| | |
|---|---|
| mcs-TableTransformPrecoder | ENUMERATED {qam256, qam64LowSE} |

OPTIONAL, -- Need S

| | | |
|---|---|---|
| uci-OnPUSCH | SetupRelease { CG-UCI-OnPUSCH } | OPTIONAL, -- |

Need M

| | |
|---|---|
| resourceAllocation | ENUMERATED { resourceAllocationType0, |

resourceAllocationType1, dynamicSwitch },

| rbg-Size | ENUMERATED {config2} | OPTIONAL, -- Need S |
|---|---|---|
| powerControlLoopToUse | ENUMERATED {n0, n1}, | |
| p0-PUSCH-Alpha | P0-PUSCH-AlphaSetId, | |
| transformPrecoder | ENUMERATED {enabled, disabled} | OPTIONAL, -- |

Need S

| nrofHARQ-Processes | INTEGER(1..16), | |
|---|---|---|
| repK | ENUMERATED {n1, n2, n4, n8}, | |
| repK-RV | ENUMERATED {s1-0231, s2-0303, s3-0000} | OPTIONAL, -- |

Need R

| | |
|---|---|
| periodicity | ENUMERATED { |
| | sym2, sym7, sym1x14, sym2x14, sym4x14, sym5x14, sym8x14, sym10x14, |

sym16x14, sym20x14,

sym32x14, sym40x14, sym64x14, sym80x14, sym128x14, sym160x14,

sym256x14, sym320x14, sym512x14,

sym640x14, sym1024x14, sym1280x14, sym2560x14, sym5120x14,
sym6, sym1x12, sym2x12, sym4x12, sym5x12, sym8x12, sym10x12, sym16x12,

sym20x12, sym32x12,

sym40x12, sym64x12, sym80x12, sym128x12, sym160x12, sym256x12,

sym320x12, sym512x12, sym640x12,

sym1280x12, sym2560x12

},

| configuredGrantTimer | INTEGER (1..64) | OPTIONAL, -- Need R |
|---|---|---|
| rrc-ConfiguredUplinkGrant | SEQUENCE { | |
| timeDomainOffset | INTEGER (0..5119), | |
| timeDomainAllocation | INTEGER (0..15), | |
| frequencyDomainAllocation | BIT STRING (SIZE(18)), | |
| antennaPort | INTEGER (0..31), | |
| dmrs-SeqInitialization | INTEGER (0..1) | OPTIONAL, -- Need R |
| precodingAndNumberOfLayers | INTEGER (0..63), | |
| srs-ResourceIndicator | INTEGER (0..15) | OPTIONAL, -- Need R |

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs-1), |

...

| | |
|---|---|
| } | OPTIONAL, -- Need R |

...
}

Next, a PUSCH transmission method will be described. A DMRS antenna port for PUSCH transmission is the same as an antenna port for SRS transmission. PUSCH transmission may be performed by a codebook-based transmission method or a non-codebook-based transmission method depending on whether a value txConfig in pusch-Config of Table 21, which is higher layer signaling, is codebook or nonCodebook.

As described above, PUSCH transmission may be dynamically scheduled through DCI format 0_0 or 0_1, and may be semi-statically configured by a configured grant. If the UE is indicated with scheduling for PUSCH transmission through DCI format 0_0, the UE performs beam configuration for PUSCH transmission using pucch-spatialRelationInfoD corresponding to a UE-specific PUCCH resource corresponding to the minimum ID within the uplink BWP activated in the serving cell, and in this case, PUSCH transmission is based on a single antenna port. The UE does not expect scheduling for PUSCH transmission through DCI format 0_0 within the BWP in which the PUCCH resource including pucch-spatialRelationInfo is not configured. If the UE does not receive a configuration of txConfig in pusch-Config of Table 21, the UE does not expect scheduling through DCI format 0_1.

TABLE 21

| PUSCH-Config ::= | SEQUENCE { | |
|---|---|---|
| dataScramblingIdentityPUSCH | INTEGER (0..1023) | OPTIONAL, -- Need |

S

| | | |
|---|---|---|
| txConfig | ENUMERATED {codebook, nonCodebook} | OPTIONAL, -- Need |

S

| | | |
|---|---|---|
| dmrs-UplinkForPUSCH-MappingTypeA | SetupRelease | { DMRS-UplinkConfig } |

OPTIONAL, -- Need M

| | | |
|---|---|---|
| dmrs-UplinkForPUSCH-MappingTypeB | SetupRelease | { DMRS-UplinkConfig } |

OPTIONAL, -- Need M

| | | |
|---|---|---|
| pusch-PowerControl | PUSCH-PowerControl | OPTIONAL, -- Need M |
| frequencyHopping | ENUMERATED {intraSlot, interSlot} | OPTIONAL, -- |

Need S

| | |
|---|---|
| frequencyHoppingOffsetLists | SEQUENCE (SIZE (1..4)) OF INTEGER (1.. |

maxNrofPhysicalResourceBlocks-1)

| | |
|---|---|
| | OPTIONAL, -- Need M |
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

| TimeDomainResourceAllocationList } | OPTIONAL, -- Need M | |
|---|---|---|
| pusch-AggregationFactor | ENUMERATED { n2, n4, n8 } | OPTIONAL, -- |

Need S

| | | |
|---|---|---|
| mcs-Table | ENUMERATED {qam256, qam64LowSE} | OPTIONAL, -- |

Need S

| | |
|---|---|
| mcs-TableTransformPrecoder | ENUMERATED {qam256, qam64LowSE} |

OPTIONAL, -- Need S

| | | |
|---|---|---|
| transformPrecoder | ENUMERATED {enabled, disabled} | OPTIONAL, -- |

Need S

| | |
|---|---|
| codebookSubset | ENUMERATED {fullyAndPartialAndNonCoherent, |

partialAndNonCoherent,nonCoherent}

| | OPTIONAL, -- Cond codebookBased | |
|---|---|---|
| maxRank | INTEGER (1..4) | OPTIONAL, -- Cond codebookBased |
| rbg-Size | ENUMERATED { config2} | OPTIONAL, -- Need S |

| | | |
|---|---|---|
| uci-OnPUSCH | SetupRelease { UCI-OnPUSCH} | OPTIONAL, -- Need M |

| | | |
|---|---|---|
| tp-pi2BPSK | ENUMERATED {enabled} | OPTIONAL, -- Need S |

...
}

Next, codebook-based PUSCH transmission will be described. Codebook-based PUSCH transmission may be dynamically scheduled through DCI format 0_0 or 0_1, and may be operated semi-statically by a configured grant. If a codebook-based PUSCH is dynamically scheduled by DCI format 0_1 or is semi-statically configured by a configured grant, the UE determines a precoder for PUSCH transmission, based on an SRS resource indicator (SRI), a transmission precoding matrix indicator (TPMI), and a transmission rank (the number of PUSCH transmission layers)

In this case, the SRI may be given through a field SRS resource indicator in DCI or may be configured through srs-ResourceIndicator, which is higher layer signaling. At least one SRS resource may be configured for the UE during the codebook-based PUSCH transmission, and up to two SRS resources may be configured. In the case where the UE is provided with the SRI through DCI, the SRS resource indicated by the corresponding SRI refers to an SRS resource corresponding to the SRI, among the SRS resources transmitted prior to the PDCCH including the corresponding SRI. In addition, the TPMI and transmission rank may be given through precoding information fields and number of layers in DCI, or may be configured through higher layer signaling, precodingAndNumberOfLayers. The TPMI is used to indicate a precoder applied to PUSCH transmission. If one SRS resource is configured for the UE, the TPMI is used to indicate the precoder to be applied in the configured one SRS resource. If a plurality of SRS resources is configured for the UE, the TPMI is used to indicate a precoder to be applied in the SRS resource indicated through the SRI.

A precoder to be used for PUSCH transmission is selected from an uplink codebook having the same number of antenna ports as the value nrofSRS-Ports in the higher layer signaling, SRS-Config. In the codebook-based PUSCH transmission, the UE determines a codebook subset, based on the TPMI and codebookSubset in the higher layer signaling, pusch-Config. CodebookSubset in the higher layer signaling, pusch-Config, may be configured as one of “fully AndPartialAndNonCoherent,” “partialAndNonCoherent,” and “noncoherent,” based on the UE capability reported by the UE to the base station. If the UE reports “partialAndNonCoherent” as UE capability, the UE does not expect that the value of the higher layer signaling, codebookSubset, will be configured as “fullyAndPartialAndNonCoherent.” In addition, if the UE reports “noncoherent” as UE capability, the UE does not expect that the value of the higher layer signaling, codebookSubset, will be configured as “fullyAndPartialAndNonCoherent” or “partialAndNonCoherent.” In the case where nrofSRS-Ports in the higher layer signaling, SRS-ResourceSet, indicates two SRS antenna ports, the UE does not expect that the value of the higher layer signaling, codebookSubset, will be configured as “partialAndNonCoherent.”

One SRS resource set in which the value of usage in the higher layer signaling, SRS-ResourceSet, is configured as “codebook” may be configured for the UE, and one SRS resource may be indicated through SRI in the corresponding SRS resource set. If several SRS resources are configured in the SRS resource set in which the value of usage in the higher layer signaling, SRS-ResourceSet, is configured as “codebook,” the UE expects that the value of nrofSRS-Ports in the higher layer signaling, SRS-Resource, has is the same value for all SRS resources.

The UE transmits, to the base station, one or a plurality of SRS resources included in the SRS resource set in which the value of usage is configured as “codebook” according to higher layer signaling, and the base station selects one of the SRS resources transmitted by the UE and indicates the UE to perform PUSCH transmission using transmission beam information of the corresponding SRS resource. In this case, in the codebook-based PUSCH transmission, the SRI is used as information for selecting an index of one SRS resource and is included in DCI. Additionally, the base station includes information indicating the TPMI and rank to be used by the UE for PUSCH transmission in DCI. The UE performs PUSCH transmission by using the SRS resource indicated by the SRI and applying the precoder indicated by the rank and TPMI indicated based on the transmission beam of the corresponding SRS resource.

Next, non-codebook-based PUSCH transmission will be described. Non-codebook-based PUSCH transmission may be dynamically scheduled through DCI format 0_0 or 0_1 and may be semi-statically operated by a configured grant. In the case where at least one SRS resource is configured in the SRS resource set in which the value of usage in the higher layer signaling, SRS-ResourceSet, is configured as “nonCodebook,” the UE may be scheduled for non-codebook-based PUSCH transmission through DCI format 0_1.

For the SRS resource set in which the value of usage in the higher layer signaling, SRS-ResourceSet, is configured as “nonCodebook,” the UE may receive a configured of one connected NZP CSI-RS resource (non-zero power CSI-RS). The UE may perform a calculation for the precoder for SRS transmission by measuring the NZP CSI-RS resource connected to the SRS resource set. If the difference between the last reception symbol of the aperiodic NZP CSI-RS resource connected to the SRS resource set and the first symbol of aperiodic SRS transmission in the UE is less than 42 symbols, the UE does not expect that the information on the precoder for SRS transmission will be updated.

If the value resourceType in the higher layer signaling, SRS-ResourceSet, is configured as “aperiodic,” the connected NZP CSI-RS is indicated by a SRS request, which is a field in DCI format 0_1 or 1_1. In this case, if the connected NZP CSI-RS resource is an aperiodic NZP CSI-RS resource, it indicates that a connected NZP CSI-RS exists in the case where the value of the SRS request field in DCI format 0_1 or 1_1 is not 00. In this case, the corresponding DCI may not indicate cross carrier or cross BWP scheduling. In addition, if the value of the SRS request indicates the existence of an NZP CSI-RS, the corresponding NZP CSI-RS is located in the slot in which a PDCCH including the SRS request field is transmitted. In this case, the TCI states configured in the scheduled subcarrier are not configured as QCL-TypeD.

If a periodic or semi-persistent SRS resource set is configured, a connected NZP CSI-RS may be indicated through associatedCSI-RS in the higher layer signaling, SRS-ResourceSet. For non-codebook-based transmission, the UE does not expect that both spatialRelationInfo, which is higher layer signaling for the SRS resource, and associatedCSI-RS in the higher layer signaling, SRS-ResourceSet, will be configured.

In the case where a plurality of SRS resources is configured for the UE, the UE may determine a precoder and a transmission rank to be applied to PUSCH transmission, based on the SRI indicated by the base station. In this case, the SRI may be indicated through an SRS resource indicator field in DCI or may be configured through srs-ResourceIndicator, which is higher layer signaling. Like the above-described codebook-based PUSCH transmission, in the case where the UE is provided with an SRI through DCI, an SRS resource indicated by the corresponding SRI refers to the SRS resource corresponding to the SRI, among the SRS resources transmitted prior to a PDCCH including the corresponding SRI. The UE may use one or a plurality of SRS resources for SRS transmission, and the maximum number of SRS resources and the maximum number of SRS resources that can be simultaneously transmitted in the same symbol in one SRS resource set are determined by the UE capability reported by the UE to the base station. In this case, the SRS resources simultaneously transmitted by the UE occupy the same RB. The UE configures one SRS port for each SRS resource. Only one SRS resource set in which the value of usage in the higher layer signaling, SRS-ResourceSet, is configured as “nonCodebook” may be configured, and up to four SRS resources may be configured for non-codebook-based PUSCH transmission.

The base station transmits one NZP-CSI-RS connected to the SRS resource set to the UE, and the UE calculates a precoder to be used for transmission of one or a plurality of SRS resources in the corresponding SRS resource set, based on a result measured upon receiving the NZP-CSI-RS. The UE applies the calculated precoder when transmitting one or a plurality of SRS resources in the SRS resource set in which the usage is configured as “nonCodebook” to the base station, and the base station selects one or a plurality of SRS resources among the received one or a plurality of SRS resources. In this case, in the non-codebook-based PUSCH transmission, the SRI indicates an index capable of representing one SRS resource or a combination of a plurality of SRS resources, and the SRI is included in the DCI. In this case, the number of SRS resources indicated by the SRI transmitted by the base station may be the number of transmission layers of the PUSCH, and the UE transmits the PUSCH by applying a precoder applied to SRS resource transmission to each layer.

### [PUSCH: Preparation Procedure Time]

Next, a PUSCH preparation procedure time will be described. In the case where the base station schedules the UE to transmit a PUSCH using DCI format 0_0, 0_1, or 0_2, the UE may require a PUSCH preparation procedure time for transmitting a PUSCH by applying the transmission method indicated through DCI (a transmission precoding method of SRS resources, the number of transmission layers, and a spatial domain transmission filter). In NR, a PUSCH preparation procedure time is defined in consideration of this. The PUSCH preparation procedure time of the UE may follow Equation 2 below.

$${T}_{proc , 2} = max ( ( {N}_{2} + {d}_{2 , 1} + {d}_{2} ) ( 2048 + 144 ) κ {2}^{- µ} {T}_{c} + {T}_{ext} + {T}_{switch} , {d}_{2 , 2} ) .$$

Respective variables in T_{proc,2} described in Equation 2 may have the following definitions:
N₂: The number of symbols determined according to UE processing capability 1 or 2 according to the UE capability and numerology μ. This may have the values shown in Table 22 in the case where UE processing capability 1 is reported according to the capability report of the UE, and may have the values shown in Table 23 in the case where UE processing capability 2 is reported and where UE processing capability 2 is configured to be available through higher layer signaling.

TABLE 22

| | PUSCH preparation time N₂ |
|---|---|
| μ | [symbols] |
| 0 | 10 |
| 1 | 12 |
| 2 | 23 |
| 3 | 36 |

TABLE 23

| | PUSCH preparation time N₂ |
|---|---|
| μ | [symbols] |
| 0 | 5 |
| 1 | 5.5 |
| 2 | 11 for frequency range 1 |

d_{2,1}: The number of symbols configured as 0 in the case where all resource elements of the first OFDM symbol of PUSCH transmission are configured as only DM-RSs, otherwise configured as 1.
κ: 64.
μ: μDL or μUL, which increases Tproc,2. μDL refers to a numerology of a downlink in which a PDCCH including DCI for scheduling a PUSCH is transmitted, and μUL refers to a numerology of an uplink in which a PUSCH is transmitted.
Tc: This has 1/(Δfmax*Nf), Δfmax=480*103 Hz, Nf=4096.
d2,2: This follows a BWP switching time in the case where the DCI scheduling a PUSCH indicates BWP switching, otherwise this has 0.
d2: In the case where OFDM symbols of a PUCCH, a PUSCH having a high priority index, and a PUCCH having a low priority index overlap in time, the value d2 of the PUSCH having a high priority index is used. Otherwise, d2 is 0.
Text: In the case where the UE uses a shared spectrum channel access method, the UE may calculate Text and apply the same to the PUSCH preparation procedure time. Otherwise, Text is assumed to be 0.
Tswitch: In the case where an uplink switching interval is triggered, Tswitch is assumed to be a switching interval time. Otherwise, it is assumed to be 0.

Considering the influence of the timing advance between time domain resource mapping information of a PUSCH scheduled through DCI and the uplink-downlink, in the case where the first symbol of a PUSCH starts earlier than the first uplink symbol in which CP starts after T_{proc,2} from the last symbol of a PDCCH including DCI scheduling the PUSCH, the base station and UE determine that the PUSCH preparation procedure time is not sufficient. Otherwise, the base station and UE determine that the PUSCH preparation procedure time is sufficient. The UE may transmit a PUSCH only in the case where the PUSCH preparation procedure time is sufficient, and ignore DCI scheduling a PUSCH in the case where the PUSCH preparation procedure time is not sufficient.

### [In Relation to CA/DC]

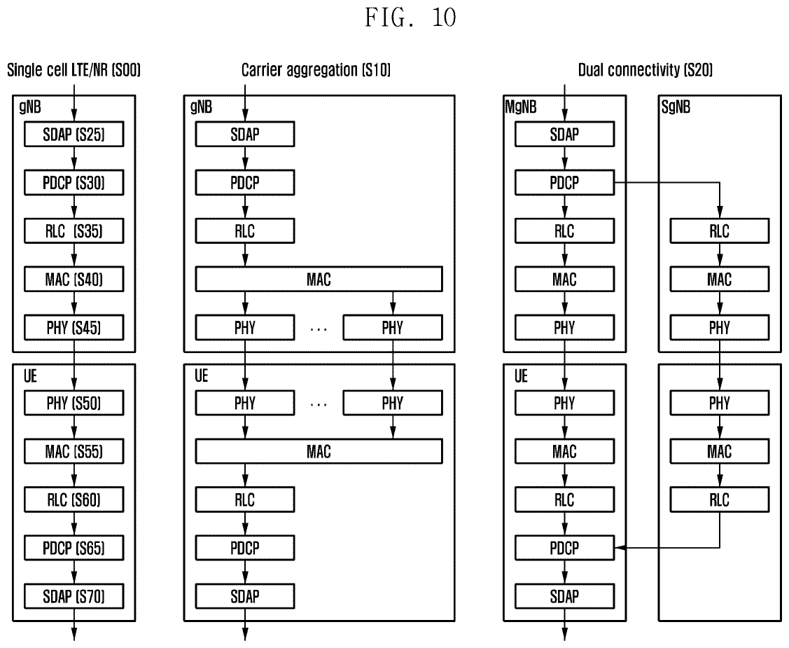

FIG. 10 illustrates the radio protocol structures of a base station and UE in a single cell case, a carrier aggregation case, and a dual connectivity case according to an embodiment of the disclosure.

With respect to FIG. 10, a radio protocol of the next generation mobile communication system may include an NR service data adaptation protocol (NR SDAP) S25 and S70, an NR packet data convergence protocol (NR PDCP) S30 and S65, an NR radio link control (NR RLC) S35 and S60, and an NR medium access control (NR MAC) S40 and S55, for each of a UE and an NR base station.

The main functions of the NR SDAP S25 and S70 may include some of the following functions:
Transfer function of user data (transfer of user plane data);
Mapping function between a QoS flow and a data bearer for uplink and downlink (mapping between a QoS flow and a DRB for both DL and UL);
Marking function of QoS flow ID in uplink and downlink (marking QoS flow ID in both DL and UL packets); and/or
Mapping function of reflective QoS flow to data bearer for uplink SDAP PDUs (reflective QoS flow to DRB mapping for the UL SDAP PDUs).

For the SDAP layer entity, whether to use the header of the SDAP layer entity or whether to use the function of the SDAP layer entity may be configured for the UE via an RRC message for each PDCP layer entity, for each bearer, or for each logical channel. In the case that the SDAP header is configured, a NAS reflective QoS configuration one-bit indicator (NAS reflective QoS) and an AS reflective QoS configuration one-bit indicator (AS reflective QoS) of the SDAP header may indicate so that the UE updates or reconfigures mapping information between a QoS flow and a data bearer in an uplink and a downlink. The SDAP header may include QoS flow ID information indicating QoS. The QoS information may be used as data processing priority information, scheduling information, or the like for supporting a smooth service.

The main functions of the NR PDCP S30 and S65 may include some of the following functions:
Header compression and decompression functions (Header compression and decompression: ROHC only);
Transfer function of user data (Transfer of user data);
In-sequence delivery function (In-sequence delivery of upper layer PDUs);
Out-of-sequence delivery function (Out-of-sequence delivery of upper layer PDUs);
Reordering function (PDCP PDU reordering for reception);
Duplicate detection function (Duplicate detection of lower layer SDUs);
Retransmission function (Retransmission of PDCP SDUs);
Ciphering and deciphering functions (Ciphering and deciphering); and/or
Timer-based SDU discard function (Timer-based SDU discard in uplink.).

The above reordering function of the NR PDCP device refers to a function of sequentially reordering PDCP PDUs received in a lower layer according to a PDCP sequence number (PDCP SN), and may include transferring data to a higher layer in a reordered sequence. Alternatively, the reordering function of the NR PDCP device may include immediately transferring data irrespective of a sequence, recording lost PDCP PDUs after sequential reordering, reporting the states of lost PDCP PDUs to a transmission side, and requesting retransmission of lost PDCP PDUs.

The main function of the NR RLC S35 and S60 may include some of the following functions:
Data transfer function (Transfer of upper layer PDUs);
In-sequence delivery function (In-sequence delivery of upper layer PDUs);
Out-of-sequence delivery function (Out-of-sequence delivery of upper layer PDUs);
ARQ function (Error Correction through ARQ);
Concatenation, segmentation and reassembly functions (Concatenation, segmentation and reassembly of RLC SDUs);
Re-segmentation function (Re-segmentation of RLC data PDUs);
Reordering function (Reordering of RLC data PDUs);
Duplicate detection function (Duplicate detection);
Error detection function (Protocol error detection);
RLC SDU discard function (RLC SDU discard); and/or
RLC re-establishment function (RLC re-establishment).

The above in-sequence delivery function of the NR RLC entity refers to the function of sequentially delivering RLC SDUs, received from a lower layer, to a higher layer. In the case that a single original RLC SDU is divided into multiple RLC SDUs and the multiple RLC SDUs are received, the in-sequence delivery function of the NR RLC entity may include reassembling and delivering the same. The in-sequence delivery function of the NR RLC entity may include the functions of reordering received RLC PDUs according to an RLC sequence number (RLC SN) or a PDCP sequence number (PDCP SN), and recording lost RLC PDUs after sequential reordering, reporting the states of the lost RLC PDUs to a transmission side, and requesting retransmission of the lost RLC PDUs. The in-sequence delivery function of the NR RLC entity may include the functions of sequentially delivering, to a higher layer, only RLC SDUs before a lost RLC SDU in the case that there is a lost RLC SDU. Alternatively, even though there is a lost RLC SDU, when a predetermined timer expires, the in-sequence delivery function may include the function of sequentially delivering RLC SDUs, received before the timer starts, to a higher layer. Alternatively, the in-sequence delivery function of the NR RLC entity may include the function of sequentially delivering all RLC SDUs, received up to the present, to a higher layer even though there is a lost RLC SDU, when a predetermined timer expires. In addition, RLC PDUs may be processed in order of reception (in order of arrival, irrespective of a serial number or a sequence number), and may be delivered to the PDCP device irrespective of a sequence (out-of-sequence delivery). In the case of segments, segments, which are stored in a buffer or which are to be received in the future, are received and reconfigured as a single intact RLC PDU, may be processed, and delivered to the PDCP device. The NR RLC layer may not include a concatenation function, or may perform the function in the NR MAC layer or replace the function with a multiplexing function in the NR MAC layer.

The out-of-sequence delivery function of the NR RLC entity refers to the function of immediately delivering RLC SDUs, received from a lower layer, to a higher layer irrespective of a sequence. In the case that a single original RLC SDU is divided into multiple RLC SDUs and the multiple RLC SDUs are received, the out-of-sequence delivery function may include the functions of reassembling and transmitting the same, and storing the RLC SN or PDCP SN of the received RLC PDUs, and performing sequential ordering, and recording lost RLC PDUs.

The NR MAC S40 and S55 may be connected to multiple NR RLC layer entities configured for a single UE, and the main functions of the NR MAC may include some of the following functions:
Mapping function (Mapping between logical channels and transport channels);
Multiplexing and demultiplexing functions (Multiplexing/demultiplexing of MAC SDUs);
Scheduling information reporting function (Scheduling information reporting);
HARQ function (Error correction through HARQ);
Priority handling function between logical channels (Priority handling between logical channels of one UE);
Priority handling function between UEs (Priority handling between UEs by means of dynamic scheduling);
MBMS service identification function (MBMS service identification);
Transport format selection function (Transport format selection); and/or
Padding function (Padding).

The NR PHY layer S45 and S50 may perform channel-coding and modulating of higher layer data to produce an OFDM symbol, and transmit the OFDM symbol via a wireless channel, or may perform demodulating and channel-decoding of the OFDM symbol, received via a wireless channel, and deliver the demodulated and channel-decoded OFDM symbol to a higher layer

The detailed structure of the radio protocol structure may be variously changed depending on a carrier (or cell) operation scheme. For example, in the case that a base station transmits, based on a single carrier (or cell), data to a UE, the base station and UE may use a protocol structure having a single structure for each layer as shown in diagram S00. Conversely, in the case that, based on carrier aggregation (CA) that uses multiple carriers in a single TRP, the base station transmits data to the UE, the base station and UE may use a protocol structure that has a single structure up to RLC and performs multiplexing a PHY layer via a MAC layer, as shown in diagram S10. As another example, in the case that, based on dual connectivity (DC) that uses multiple carriers in multiple TRPs, the base station transmits data to the UE, the base station and UE may use a protocol structure that has a single structure up to RLC but performs multiplexing a PHY layer via a MAC layer, as shown in diagram S20.

With respect to the above-described PDCCH and the description related to configuration of a beam, repetitive PDCCH transmission is not supported in Rel-15 and Rel-16 NR currently, and thus it is difficult to obtain request reliability in a scenario that needs high-reliability such as URLLC and the like. The disclosure provides a repetitive PDCCH transmission method via multiple transmission points (TRP) so as to improve a PDCCH reception reliability of a UE. A method will be described in detail in the following embodiments

Hereinafter, embodiments of the disclosure will be described in detail with reference to the accompanying drawings. The content provided in the disclosure may be applicable in FDD and TDD systems. Hereinafter, higher signaling (or higher layer signaling) is signal transferring method from a base station to a UE via a DL data channel of a physical layer, or signal transferring from a UE to a base station via a UL data channel of a physical layer, which may also be referred to as RRC signaling, PDCP signaling, or medium access control (MAC) control element (CE).

Herein, when determining whether cooperative communication is applied, a UE may use various methods such as a method in which a PDCCH(s) that allocates a PDSCH to which cooperative communication is applied has a predetermined format, a method in which a PDCCH(s) that allocates a PDSCH to which cooperative communication is applied includes a predetermined indicator indicating whether cooperative communication is applied, a method in which a PDCCH(s) that allocates a PDSCH to which cooperative communication is applied is scrambled by a predetermined RNTI, a method in which application of cooperative communication is assumed in a predetermined interval indicated via a higher layer, or the like. For ease of description, when a UE receives a PDSCH to which cooperative communication is applied based on the conditions similar to the above is referred to as an NC-JT case.

Herein, in the disclosure, determining priorities of A and B may be variously described such as the case of selecting one having a higher priority according to a predetermined priority rule and performing an operation corresponding thereto, or the case of omitting or dropping one that has a lower priority, or the like.

Although the disclosure describes the various examples through a plurality of embodiments, the embodiments are not independent from one another but one or more embodiments may be applicable simultaneously or in combination.

Hereinafter, the embodiments of the disclosure will be described in detail together with the accompanying drawings. Hereinafter, a base station is an entity that allocates resources to UEs, and may be at least one of a gNode B, a gNB, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Hereinafter, although the embodiments of the disclosure are described using a 5G system as an example, the embodiments of the disclosure may also be applied to other communication systems having similar technical backgrounds or channel types. For example, this may include LTE or LTE-A mobile communication and mobile communication technologies developed after 5G. Accordingly, the embodiments of the disclosure may be applied to other communication systems with some modifications without significantly departing from the scope of the disclosure as judged by a person skilled in the art. The contents of the disclosure can be applied to FDD and TDD systems.

Further, in describing the disclosure, a detailed description of known functions or constitutions incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

In describing the disclosure below, higher layer signaling may be signaling corresponding to at least one or a combination of one or more of the following signaling:
Master Information Block (MIB);
System Information Block (SIB) or SIB X (X=1, 2, . . . );
Radio Resource Control (RRC); and/or
Medium Access Control (MAC) Control Element (CE).

In addition, L1 signaling may be signaling corresponding to at least one or a combination of one or more of signaling methods using the following physical layer channels or signalings:
Physical Downlink Control Channel (PDCCH);
Downlink Control Information (DCI);
UE-specific DCI;
Group common DCI;
Common DCI;
Scheduling DCI (e.g., DCI used for the purpose of scheduling downlink or uplink data);
Non-scheduling DCI (e.g., DCI not intended for the purpose of scheduling downlink or uplink data);
Physical Uplink Control Channel (PUCCH); and/or
Uplink Control Information (UCI).

Hereinafter, in the disclosure, determining priorities of A and B may be variously described such as the case of selecting one having a higher priority according to a predetermined priority rule and performing an operation corresponding thereto, or the case of omitting or dropping one that has a lower priority, or the like.

Although the disclosure describes the various examples through a plurality of embodiments, the embodiments are not independent from one another but one or more embodiments may be applicable simultaneously or in combination.

### [In Relation to SBFD]

Meanwhile, in 3GPP, Subband non-overlapping Full Duplex (SBFD) has been discussed as a new duplex scheme based on NR. In a TDD band (spectrum) of 6 GHz or lower frequency or 6 GHz or higher frequency, SBFD may receive, from a UE, as much UL transmission as a UL resource increased by utilizing some of a DL resource as a UL resource, may extend UL coverage of the UE, and may receive, from the UE, feedback with respect to DL transmission in the extended UL resource, so as to reduce a feedback delay. In the disclosure, a UE that is capable of receiving, from a base station, information associated with whether SBFD is supported, and performing UL transmission in a part of a DL resource may be called or referred to as an SBFD UE (SBFD-capable UE). To define the SBFD scheme in the standard, and to enable an SBFD UE to determine that the SBFD is supported in a predetermine cell (or frequency, frequency band), the following scheme may be considered

A First Scheme. In addition to an existing frame structure type of an unpaired spectrum (or time division duplex (TDD)) or a paired spectrum (or frequency division duplex (FDD)), another frame structure type (e.g., frame structure type 2) may be introduced to define the SBFD. Fame structure type 2 may define that SBFD is supported in the predetermined frequency or frequency band, or a base station may indicate whether SBFD is supported to a UE via system information. An SBFD UE may receive system information including whether the SBFD is supported and may determine whether SBFD is supported in the predetermined cell (or frequency, frequency band).

A Second Scheme. Without defining a new frame structure type, whether the SBFD is additionally supported in a predetermined frequency or frequency band of an existing unpaired spectrum (or TDD) may be indicated. In the second scheme, whether the SBFD is additionally supported in a predetermined frequency or frequency band of an existing unpaired spectrum may be defined, or a base station may indicate whether SBFD is supported to a UE via system information. An SBFD UE may receive system information including whether the SBFD is supported and may determine whether SBFD is supported in the predetermined cell (or frequency, frequency band).

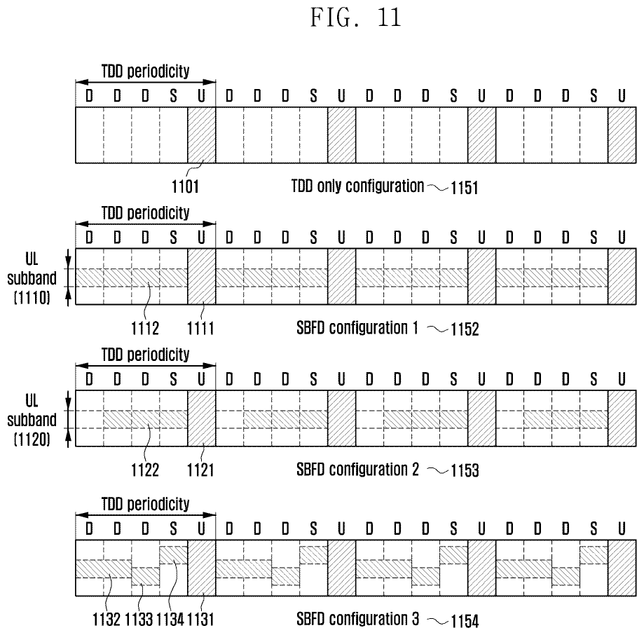

In the first and second schemes, information associated with whether SBFD is supported may be information (e.g., SBFD resource configuration information to be described in FIG. 11) indirectly indicating whether SBFD is supported by configuring a part of a DL resource as a UL resource, in addition to a configuration associated with TDD uplink (UL)-downlink (DL) resource configuration information indicating a DL slot (or symbol) resource and UL slot (or symbol) resource of TDD. Alternatively, in the first and second schemes, information associated with whether SBFD is supported may be information directly indicating whether SBFD is supported.

In the disclosure, the SBFD UE may receive a synchronization signal block and may obtain cell synchronization at an initial cell access for accessing a cell (or base station). The process of obtaining the cell synchronization may be identical between an SBFD UE and an existing TDD UE. Subsequently, the SBFD UE may determine whether the cell supports SBFD by obtaining an MIB or SIB or via a random access process.

System information to transmit information associated with whether the SBFD is supported may be system information that is distinguished from system information for a UE (e.g., an existing TDD UE) that supports a different version of standard in the cell, and is transmitted separately. The SBFD UE may determine the whole or part of the system information that is separately transmitted from the system information of the existing TDD UE, and may determine whether SBFD is supported. In the case that the SBFD UE obtains only system information for the existing TDD UE or obtains system information indicating that SBFD is not supported, the cell (or base station) may determine that the UE supports only TDD.

In the case that information associated with whether SBFD is supported is included in system information for a UE (e.g., an existing TDD UE) that supports a different version of standard, the information associated with whether the SBFD is supported may be inserted into the last portion of the system information so as not to affect obtaining of the system information of the existing TDD UE. In the case that the SBFD UE fails to obtain information associated with whether SBFD is supported, which is inserted into the last portion, or obtains information indicating that SBFD is not supported, the cell (or base station) may determine that the UE supports only TDD.

In the case that information associated with whether SBFD is supported is included in system information for a UE (e.g., an existing TDD UE) that supports a different version of standard, the information associated with whether the SBFD is supported may be transmitted via a separate PDSCH so as not to affect obtaining of the system information of the existing TDD UE. That is, a UE that does not support SBFD may receive a first SIB (or SIB1) including existing TDD-related system information via a first PDSCH. A UE that supports SBFD may receive a first SIB (or SIB) including existing TDD-related system information via a first PDSCH, and may receive a second SIB including SBFD-related system information via a second PDSCH.

The first PDSCH and second PDSCH may be scheduled via a first PDCCH and a second PDCCH, and cyclic redundancy codes (CRC) of the first PDCCH and second PDCCH may be scrambled by the same RNTI (e.g., SI-RNTI). A search space for monitoring the second PDCCH may be obtained from the system information of the first PDSCH. When the UE does not obtain the information (i.e., when the system information of the first PDSCH does not include information associated with the search space), the UE may receive the second PDCCH in a search space that is the same as the search space of the first PDCCH.

In the case that the SBFD UE determines that the cell (or base station) supports only TDD, the SBFD UE may perform a random access procedure and data/control signal transmission and/or reception in the same manner as that of the existing TDD UE.

The base station may constitute a random access resource separately for each of an existing TDD UE or an SBFD UE (e.g., an SBFD UE that supports duplex communication and an SBFD UE that supports half-duplex communication), and may transmit constitution information (e.g., control information or constitution information indicating a time-frequency resource usable for a PRACH) of the random access resource to the SBFD UE via system information. The system information to transmit information associated with the random access resource may be system information that is distinguished from system information for a UE (e.g., an existing TDD UE) that supports a different version of standard in the cell, and is transmitted separately.

The base station configures random access resources separately for the SBFD UE and the TDD UE that supports a different version of standard, and may distinguish whether the one that performs random access is the TDD UE that supports the different version of standard performs random access or the SBFD UE. For example, the random access resource separately configured for the SBFD UE may be a resource that the existing TDD UE determines as a DL time resource. The SBFD UE may perform random access via a UL resource (or a separate random access resource) configured in a part of the frequency of the DL time resource and the base station determines that a UE that has attempted random access in the UL resource is the SBFD UE.

Alternatively, the base station may not configure a random access resource separately for the SBFD UE, but may configure a random access resource in common for all UEs in a cell. In this case, constitution information for the random access resource may be transmitted to all UEs in the cell via system information, and an SBFD UE that has received the system information may perform random access in the above random access resource. Subsequently, the SBFD UE may complete the random access process and may proceed with an RRC connection mode for performing data transmission or reception with a cell. After RRC connection mode, the SBFD UE may receive, from the base station, a higher or physical signal that enables determining that a part of the frequency resource of the DL time resource is configured as a UL resource, and may perform an operation related to SBFD, for example, transmission of a UL signal in the UL resource.

In the case that the SBFD UE determines that the cell supports SBFD, the SBFD UE may inform the base station that a UE that attempts accessing is an SBFD UE by transmitting capability information including at least one piece of information among information associated with whether the UE supports SBFD, information associated with whether full-duplex communication or half-duplex communication is supported, the number of transmission or reception antennas that the UE is equipped with (or supports), and the like. Alternatively, in the case that supporting half-duplex communication is essential for the SBFD UE, whether the half-duplex communication is supported may be omitted from the capability information. In association with reporting of the capability information by the SBFD UE, the capability information may be reported to the base station via a random access process, may be reported to the base station after the random access process is completed, or may be reported to the base station after RRC access mode for data transmission or reception with a cell is performed.

The SBFD UE may support half-duplex communication that performs only UL transmission or DL reception at one instance in the same manner as the existing TDD UE or may support full-duplex communication that performs both UL transmission and DL reception at one instance. Therefore, whether half-duplex communication or full-duplex communication is supported may be reported by the SBFD UE to the base station via capability reporting. After reporting, the base station may configure, for the SBFD UE, whether the half-duplex communication or full-duplex communication is to be used when the SBFD UE performs transmission or reception. In the case that the SBFD UE reports, to the base station, capability associated with the half-duplex communication, a switching gap for changing an RF between transmission and reception may be needed in the case that operation is performed in FDD or TDD, since a duplexer is not present in general.

FIG. 11 illustrates an example in which SBFD operates in a TDD band of a wireless communication system to which the disclosure is applied.

With reference to FIG. 11, a case where in TDD only configuration 1151, TDD operates in a predetermined frequency band is illustrated. Based on a configuration associated with TDD UL-DL resource configuration information indicating a DL slot (or symbol) resource and a UL slot (or symbol) resource of TDD, a base station in a cell that operates TDD may perform signal transmission or reception including data/control information with an existing TDD UE or an SBFD UE in a DL slot (or symbol), a UL slot (or symbol) 1101, or a flexible slot (or symbol).

In FIG. 11, it is assumed that a DDDSU slot format is configured based on TDD UL-DL resource configuration information. “D” may be a slot constituted with all DL symbols. “U” may be a slot constituted with all UL symbols. “S” may be a slot that is different from “D” or “U,” that is, a slot including a DL symbol or UL symbol or including a flexible symbol. For case of description, it is assumed in FIG. 11 of the disclosure that S is constituted with 12 DL symbols and 2 flexible symbols. Also, a DDDSU slot format may be repeated according to TDD UL-DL resource constitution information. That is, a repetition cycle of a TDD configuration may be 5 slots (5 ms in the case of 15 kHz SCS, 2.5 ms in the case of 30 kHz SCS, and the like).

Next, with reference to FIG. 11, a case where in SBFD configuration 1 1152, SBFD configuration 2 1153 to SBFD configuration 3 1154, SBFD is operated together with TDD in a predetermined frequency band is illustrated.

With reference to SBFD configuration 1 1152 in FIG. 11, for a UE, some bands of the frequency band of a cell may be configured as a frequency band 1110 in which UL transmission is available. The frequency band where UL transmission is available may be referred to as a UL subband. Also, the UL subband may be applied to all symbols of all slots. The UE may transmit an UL channel or signal scheduled in the UL subband in all symbols 1112. However, the UE may be incapable of transmitting a UL channel or signal in a band other than the UL subband.

With reference to SBFD configuration 2 1153 in FIG. 11, for a UE, a part of the frequency band of a cell may be configured as a frequency band 1120 in which UL transmission is available, and a time area in which the frequency band is activated may be configured. This frequency band where UL transmission is available may be referred to as a UL subband. In SBFD configuration 2 1153 in FIG. 11, a UL subband may be deactivated in a first slot, and a UL subband may be activated in the remaining slots. Therefore, the UE may transmit a UL channel or signal in a UL subband 1122 in the remaining slots. Accordingly, in FIG. 11, although a UL subband is activated in units of slots, this is only an example, and whether to activate/deactivate a UL subband may be configured in a unit of a symbol.

With reference to SBFD configuration 3 1154 in FIG. 11, a time-frequency resource in which UL transmission is available may be configured for a UE. The UE may be configured with one or more pieces of time-frequency resources as a time-frequency resource in which UL transmission is available. For example, a partial frequency band 1132 of a first slot and second slot may be configured as a time-frequency resource in which UL transmission is available. In addition, a partial frequency band 1133 of a third slot and a partial frequency band 1134 of a fourth slot may be configured as a time-frequency resource in which UL transmission is available.

In the following description, a time-frequency resource in which UL transmission is available in a DL symbol or slot may be referred to as an SBFD resource. Also, a symbol in which a UL subband is configured in DL symbols may be referred to as an SBFD symbol. In addition, a time-frequency resource in which DL reception is available in a UL symbol or slot may be referred to as an SBFD resource. Also, a symbol in which a DL subband is configured in UL symbols may be referred to as an SBFD symbol.

For case of description, a band that excludes a UL subband, and in which a DL channel or signal is capable of being received may be expressed as a DL subband. For the UE, a maximum of a single UL subband may be configurable and a maximum of two DL subbands may be configurable in a single symbol. For example, the UE may be configured with one of {UL subband and DL subband}, {DL subband and UL subband}, and {first DL subband, UL subband, and second DL subband}, in the frequency area.

### RB Index

In this disclosure, one of the following three may be used as the index of RBs in the frequency area.

### 1) Common RB Index

A common RB index may be assigned from 0 and increase as the frequency increases. The UE may refer to a sub-carrier matching “point A” as sub-carrier 0. The common RB index may be assigned by grouping 12 sub-carriers in ascending order of frequency from the sub-carrier. That is, when the sub-carrier index is k, a value corresponding to floor(k/12) is the common RB index of the RB to which the sub-carrier belongs.

The common RB index may be determined according to point A. Since point A is configured commonly to all UEs in the cell, all UEs may have the same common RB index.

### 2) Specific BWP RB Index (BWP-Specific RB Index)

The UE may be configured with a DL BWP for receiving a channel or signal or an UL BWP for transmitting a channel or signal. The UE may assume that the index of the lowest RB of the BWP is 0 as a specific BWP RB index. For example, the location of the start RB of the BWP may be given as N_{BWP}^{start} using the common RB index. That is, the RB corresponding to the common RB index N_{BWP}^{start} may be assigned to 0 as a specific BWP RB index. That is, it may be n_{CRB}=n_{PRB}+N_{BWP}^{start}·n_{CRB} is a common RB index, and n_{PRB} is a specific BWP RB index.

### 3) Subband RB Index (Subband-Specific RB Index)

The UE may be configured with an UL subband in a DL symbol. Conversely, the UE may be configured with a DL subband in an UL symbol. In the subband RB index, the index of the lowest RB among the RBs included in the subband may be assumed to be 0.

For example, the location of the start RB of the subband may be given as N_{CRB-sub}^{start} using the common RB index. That is, the UE may be configured with the value of N_{CRB-sub}^{start} from the base station through a higher layer signal. The RB corresponding to the common RB index N_{CRB-sub}^{start} may be assigned with the subband RB index 0. That is, it may ben_{CRB}=n_{sub}+N_{CRB-sub}^{start}·n_{CRB} may be the common RB index, and n_{sub} may be the subband RB index. For reference, the subband whose location of the start RB is configured with the value of N_{CRB-sub}^{start} may be applied to all BWPs of the UE. That is, it may not be BWP specific.

As another example, the location of the start RB of the subband may be given as N_{PRB-sub}^{start} using a specific BWP RB index. That is, the UE may be configured to the value of N_{PRB-sub}^{start} through a higher layer signal from the base station. The value may be configured to a specific BWP. The RB corresponding to the specific BWP RB index N_{PRB-sub}^{start} may be assigned as the subband RB index 0. That is, it may be n_{PRB}=n_{sub}+N_{PRB-sub}^{start}·n_{PRB} may be the specific BWP RB index, and n_{sub} may be the subband RB index.

Through the above-described method or example, the subband RB index n_{sub} may be expressed as follows.

$${n}_{sub} = {n}_{CRB} - {N}_{CRB - sub}^{start} = {n}_{PRB} + ( {N}_{BWP}^{start} - {N}_{CRB - sub}^{start} )$$

$${n}_{sub} = {n}_{PRB} - {N}_{PRB - sub}^{start} = {n}_{CRB} - ( {N}_{BWP}^{start} + {N}_{PRB - sub}^{start} )$$

$$Accordingly , it may be expressed as , {N}_{CRB - sub}^{start} = {N}_{BWP}^{start} + {N}_{PRB - sub}^{start} ,$$

$${N}_{PRB - sub}^{start} = {N}_{CRB - sub}^{start} - {N}_{BWP}^{start} .$$

### First Embodiment: A Method for Determining a Subband

When a UE transmits an UL channel or signal, RBs to which the UL channel or signal is mapped may be included in one or a plurality of subbands. Here, each subband may be a set of consecutive RBs. The UE may be configured or indicated by a base station to different transmission parameters for different subbands, and the UE may transmit an UL channel or signal according to the transmission parameters configured or indicated for each of the subbands.

The UL channel or signal may include a physical uplink shared channel (PUSCH), a physical uplink control channel (PUCCH), a sounding reference signal (SRS), a physical random access channel (PRACH), and the like. For reference, the physical uplink shared channel and physical uplink control channel may include a demodulation reference signal (DMRS) and a phase tracking reference signal (PTRS).

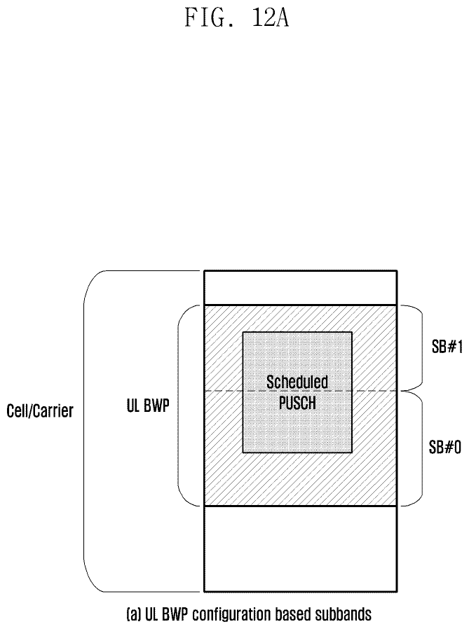

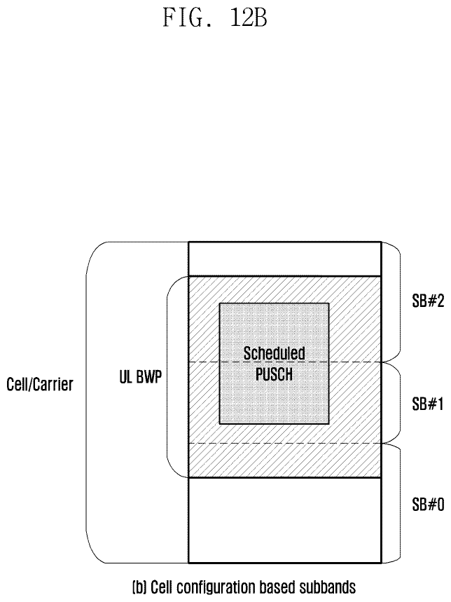

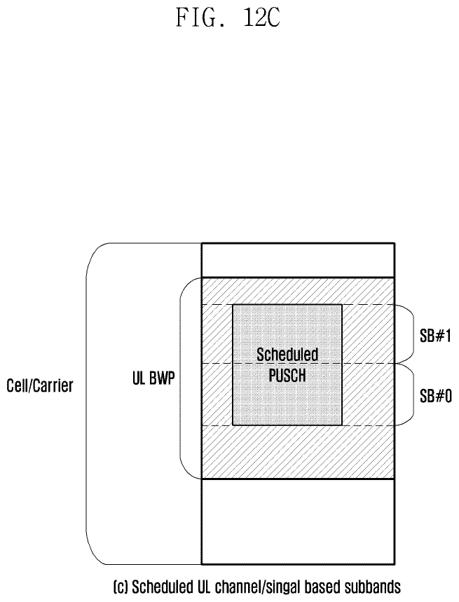

The first embodiment of the disclosure relates to a method for a base station or UE to determine a subband. According to an embodiment, a method for a base station or UE to i) determine a subband based on a UL BWP configuration, ii) determine a subband based on a cell/carrier configuration, or iii) determine a subband based on scheduling information is disclosed. FIG. 12 illustrates a subband determination method according to an embodiment of the disclosure.

### i) Subband Determination Based on UL BWP Configuration

The base station may configure an uplink bandwidth part (UL BWP) for UL transmission to the UE. The UL BWP may include a plurality of consecutive RBs in the frequency area. The base station and UE may divide the plurality of consecutive RBs into a plurality of subbands. The base station and UE may divide the frequency area of the UL BWP into a plurality of consecutive RBs.

As a first method, the base station may configure an index (RBₛₜₐᵣₜ) of a start RB of each subband and the number of consecutive RBs (L_{RBs}) to the UE. Here, the index of the start RB of each subband and the number of consecutive RBs may be transmitted by being jointly coded as a resource indication value (RIV) as in Equation 3. Here, RB start has one of the values 0, 1, . . . , size is the N_{BWP}^{size}−1 as a BWP-specific index, and L_{RBs} has one of the values 1, 2, . . . , N_{BWP}^{size}. N_{BWP}^{size} number of RBs included in the UL BWP.

$$if ( {L}_{RBs} - 1 ) \leq ⌊ {N}_{BWP}^{start} / 2 ⌋ then \qquad [ Equation 3 ]$$

$$RIV = {N}_{BWP}^{size} ( {L}_{RBs} - 1 ) + {RB}_{start}$$

$$else RIV = {N}_{BWP}^{size} ( {N}_{BWP}^{size} - {L}_{RBs} + 1 ) + ( {N}_{BWP}^{size} - 1 - {RB}_{start} )$$

$$where {L}_{RBs} \geq 1 and may not exceed {N}_{BWP}^{size} - {RB}_{start} .$$

When the base station configures N subbands to the UE, (the first start RB index, the number of the first consecutive RBs) may be configured in order to configure the first subband, (the second start RB index, the number of the second consecutive RBs) may be configured in order to configure the second subband, and (the S-th start RB index, the number of the S-th consecutive RBs) may be configured in order to set the S-th subband. Here, the number of subbands S may be explicitly configured to the UE or implicitly configured to the UE. In the case that S is implicitly configured to the UE, the UE may infer S from the configured number of (the i-th start RB index, the number of the i-th consecutive RBs).

The respective subbands may be configured not to overlap each other or may be configured to overlap each other.

For example, the respective subbands may be configured not to overlap each other. In this case, when the index of the RB where the first subband ends is N_{1,end}, the start RB index (N_{2,start}) of the second subband may be N_{2,start}=N_{1,end}+1. By utilizing this characteristic, the UE may determine the RBs included in each subband even without receiving the configuration for the index of some start RBs or the number of consecutive RBs from the base station.

For example, in the case that S subbands are configured, the base station may configure the indices of the start RBs of each of the S subbands to the UE. Here, since the start RB index of the first subband is always the RB of the lowest index of the UL BWP (0 as a specific BWP RB index), the configuration may be omitted. The UE may obtain the indices of the RBs included in each subband from the indices of the start RBs of each of the S subbands (N_{1,start}, N_{2,start}, . . . , N_{S,start}). The first subband may be constituted with the RBs having indices N_{1,start}, N_{1,start}+1, . . . , N_{2,start}−1, the second subband may be constituted with the RBs having indices N_{2,start}, N_{2,start}+1, . . . , N_{3,start}−1, the S−1 subband may be constituted with the RBs having indices N_{S-1,start}, N_{S-1,start}+1, . . . , N_{S,start}−1, and the S subband may be constituted with the RBs having indices N_{S,start}, N_{S,start}+1, . . . , N_{UL,BWP,end}. Here, N_{UL,BWP,end} may be the RB with the highest index among the RBs included in the UL BWP. Here, it may be N_{1,start}=0.

For example, in the case that S subbands are configured, the base station may configure the number of RBs (N_{1,length}, N_{2,length}, . . . , N_{S,length}) included in each of the S subbands to the UE. Here, N_{1,length}+N_{2,length}+.+N_{S,length}=N_{UL,BWP} may be satisfied. N_{UL,BWP} may be the number of RBs included in the UL BWP. Therefore, the base station may not configure one of the values of N_{1,length}, N_{2,length}, . . . , N_{S,length} to the UE. For example, the base station may not configure N_{1,length} to N_{S,length} to the UE, and in this case, it may be determined through N_{1,length}=N_{UL,BWP}−(N_{2,length}+.+N_{S,length}) to N_{S,length}=N_{UL,BWP}−(N_{1,length}+ . . . +N_{S-1,length}). The UE may obtain the indices of the RBs included in each subband from the number of RBs (N_{1,length}, N_{2,length}, . . . , N_{S,length}) included in each of the S subbands. The first subband may be constituted with the RBs having indices of 0, 1, . . . , N_{1,length}−1, the second subband may be constituted with the RBs having indices of N_{1,length}, N_{1,length}+1, . . . , N_{1,length}+N_{2,length}−1, the S−1 subband may be constituted with the RBs having indices of N_{1,length}+N_{2,length}+ . . . +N_{S-2,length}, N_{1,length}+N_{2,length}+ . . . +N_{S-2,length}+1, . . . , N_{1,length}+N_{2,length}+ . . . +N_{S-2,length}+N_{S-1,length}−1, and the S subband may be constituted with the RBs having indices of N_{1,length}+N_{2,length}+ . . . +N_{S-1,length}, N_{1,length}+N_{2,length}+ . . . +N_{S-1,length}+1, . . . , N_{1,length}+N_{2,length}+ . . . +N_{S-1,length}+N_{S,length}−1.

For example, the respective subbands may be configured to overlap with each other. That is, one RB may be included in the first subband and also in the second subband. The UE may expect the following hierarchical configuration.

The UE may be configured with non-overlapping subbands from the base station. For example, four subbands may be configured to include all RBs of the UL BWP without overlapping with each other. This may be configured according to the method described above for configuring the respective subbands to not overlap with each other. The UE may generate overlapping subbands based on the non-overlapping subbands. In this case, the UE may group subbands that are adjacent to each other on the frequency domain. For example, it is assumed that the UE has been configured with non-overlapping subbands SB #0, SB #1, SB #2, and SB #3 from the base station. The UE may determine new subbands by grouping the non-overlapping subbands. For example, SB #0 and SB #1 may be grouped to determine a new SB #4. Also, SB #2 and SB #3 may be grouped to determine a new SB #5. Also, SB #0, SB #1, SB #2, SB #3 may be grouped to determine a new SB #6. Here, which subbands are grouped to generate new subbands may be configured by the base station or may be determined according to determined rules.

The rules set forth in the examples may be as follows.

In the case that the base station configures two non-overlapping subbands (SB #0, SB #1) to the UE, a new subband, SB #2, may be determined by grouping SB #0 and SB #1.

In the case that the base station configures four non-overlapping subbands (SB #0, SB #1, SB #2, SB #3) to the UE, as a first rule, a new subband, SB #4, may be determined by grouping SB #0 and SB #1, SB #5 may be determined by grouping SB #2 and SB #3, and SB #6 may be determined by grouping SB #0, SB #1, SB #2, and SB #3. As a second rule, a new subband, SB #4, may be determined by grouping SB #0, SB #1, SB #2, and SB #3.

In the case that the base station configures eight non-overlapping subbands (SB #0, SB #1, SB #2, SB #3, SB #4, SB #5, SB #6, SB #7) to the UE, as a first rule, a new subband, SB #8, may be determined by grouping SB #0 and SB #1, SB #9 may be determined by grouping SB #2 and SB #3, SB #10 may be determined by grouping SB #4 and SB #5, SB #11 may be determined by grouping SB #6 and SB #7, SB #12 may be determined by grouping SB #0, SB #1, SB #2, and SB #3, SB #13 may be determined by grouping SB #4, SB #5, SB #6, and SB #7, and SB #14 may be determined by grouping SB #0, SB #1, SB #2, SB #3, SB #4, SB #5, SB #6, and SB #7. As a second rule, a new subband, SB #8, may be determined by grouping SB #0, SB #1, SB #2, and SB #3, SB #9 may be determined by grouping SB #4, SB #5, SB #6, and SB #7, and SB #10 may be determined by grouping SB #0, SB #1, SB #2, SB #3, SB #4, SB #5, SB #6, and SB #7. As a third rule, a new subband, SB #8, may be determined by grouping SB #0, SB #1, SB #2, SB #3, SB #4, SB #5, SB #6, and SB #7.

In the second method, the UE may receive the configuration of the number of subbands(S) from the base station, and divide the RBs included in the UL BWP into S subbands based on the number of subbands. Here, the respective subbands may not overlap with each other. Here, the RBs included in the UL BWP may be included in one subband.

The method of dividing the subbands according to the second method is as follows.
Method for dividing into RB units: The UE may divide N_{UL,BWP} RBs included in the UL BWP into S subbands. As a first method for dividing into RB units, the S subbands may be divided so that each of them has a different number of RBs by at most 1. For example, the number of RBs included in each of the S subbands is one of ceil(N_{UL,BWP}/S) and floor(N_{UL,BWP}/S). More specifically, among the S subbands, S1=mod(N_{UL,BWP},S) subbands may include ceil(N_{UL,BWP}/S) RBs, and S2=S−mod(N_{UL,BWP},S) subbands may include floor(N_{UL,BWP}/S) RBS. For example, in the case that UL BWP includes N_{UL,BWP}=273 RBs and S=4, among the S subbands, S1=mod(273,4)=1 subband may include ceil(273/4)=69 RBs, and S2=S−mod(273,4)=4−1=3 subbands may include floor(273/4)=68 RBs.

In the second method for dividing by RB units, among the S subbands, S−1 subbands may include floor(N_{UL,BWP}/S) RBs, and 1 subband may include N_{UL,BWP}−(S−1)*floor(N_{UL,BWP}/S) RBs. For example, in the case that UL BWP includes N_{UL,BWP}=273 RBs, and in the case of S=4, S−1=3 subbands may include floor(273/4)=68 RBs, and 1 subband may include 273−3*floor(273/4)=69 RBs.
Method for dividing by RB set: The UE may generate RB sets by grouping N_{UL,BWP} RBs included in the UL BWP. The RBs included in the UL BWP are grouped into N_{RB-set} RB sets. The N_{RB-set} RB sets may be divided into S subbands. As a first division method, the S subbands may be divided so that each of them has a maximum difference of 1 RB-set. For example, the number of RB-sets included in each of the S subbands is one of ceil(N_{RB-set}/S) and floor(N_{RB-set}/S). More specifically, among the S subbands, S1=mod(N_{RB-set},S) subbands may include ceil(N_{RB-set}/S) RB-sets, and S2=S−mod(N_{RB-set}/S) subbands may include floor(N_{RB-set}/S) RB-sets. As a second division method, among the S subbands, S−1 subbands may include floor(N_{RB-set}/S) RBs, and 1 subband may include N_{RB-set}−(S−1)*floor(N_{RB-set}/S) RB-sets.

For example, RB set may be the same as the resource block group (RBG) generated in frequency domain resource allocation (FDRA) type-0. That is, N_{RB-set}=┌N_{UL,BWP}+ (N_{UL,BWP,start} mod P)/P┐,
A first RB-set may include P−(N_{UL,BWP,start} mod P) RBs,
A last RB-set may include (N_{UL,BWP}+N_{UL,BWP,start})mod P RBs if (N_{UL,BWP}+N_{UL,BWP,start})mod P>0, and may include P RBs if (N_{UL,BWP}+N_{UL,BWP,start})mod P=0,
Remaining RB-sets may include P RBs.

Here, N_{UL,BWP,start} is the index of the lowest RB included in the UL BWP determined according to the common RB index. Here, P may be a value determined according to the number of RBs included in the UL BWP as one of 2, 4, 8, and 16, or a value configured by the base station.

In a third method, the UE may be configured to the nominal number of RBs included in the subband (N_{subband}) by the base station, and divide the RBs included in the UL BWP into S subbands based on the nominal number of RBs included in the subband. Here, the respective subbands may not overlap with each other. Here, the RBs included in the UL BWP may be included in one subband.

The method for dividing the subbands according to the third method is as follows.
In one method, the UE may divide the RBs included in the UL BWP into S=ceil(N_{UL,BWP}/N_{subband}) subbands, S−1 subbands may include N_{subband} RBs, and one subband may include N_{UL,BWP}−(S−1)*N_{subband} RBs.
In another method, the UE divides the RBs in the UL BWP into S=┌N_{UL,BWP}+ (N_{UL,BWP,start} mod N_{subband})/N_{subband}┐ subbands,
A first subband may include N_{subband}−(N_{UL,BWP,start} mod N_{subband}) RBs,
A last subband may include (N_{UL,BWP}+N_{UL,BWP,start})mod N_{subband} RBs if (N_{UL,BWP}+N_{UL,BWP,start})mod N_{subband}>0, and include N_{subband} RBs if (N_{UL,BWP}+N_{UL,BWP,start})mod N_{subband}=0,
The remaining subbands may include N_{subband} RBs.

The maximum number of subbands may be determined as a specific value. That is, the number of subbands(S) configured may be equal to or less than the maximum number of subbands. The maximum number of subbands may be determined as follows:
The maximum number of subbands may be determined as a specific value regardless of the number of RBs included in the UL BWP. For example, the maximum number of subbands may be determined as one of 2, 4, or 8. Here, 2, 4, and 8 are numbers that may be expressed in the form of a power of 2 (2^{b}, b=1, 2, 3); and
The maximum number of subbands may be determined according to the number of RBs included in the UL BWP. That is, in the case that more RBs are included in the UL BWP, a larger maximum number of subbands may be possible. For example, if the number of UL BWPs (N_{UL,BWP}) is 1≤N_{UL,BWP}<X1, the maximum number of subbands is Y₁, if the number of UL BWPS (N_{UL,BWP}) is X₁≤N_{UL,BWP}<X₂, the maximum number of subbands is Y₂, if the number of UL BWPs (N_{UL,BWP}) is X₂≤N_{UL,BWP}<X₃, the maximum number of subbands is Y₃, and if the number of UL BWPs (N_{UL,BWP}) is X₃≤N_{UL,BWP}, the maximum number of subbands may be Y₄. Here, it may be X₁<X₂<X₃, and Y₁<Y₂<Y₃<Y₄. In addition, it may be fixed as Y₁=1. In addition, it may be Y₂=2, Y₃=4, Y₄=8. For reference, this example is a method for determining four different maximum numbers of subbands (Y₁, Y₂, Y₃, Y₄) according to the number of UL BWPs. In the same way, a method for generating K different maximum numbers of subbands (Y₁, Y₂, . . . , Y_{K}) is as follows. If 1<N_{UL,BWP}<X₁, the maximum number of subbands may be Y₁, if X₁≤N_{UL,BWP}<X₂, the maximum number of subbands may be Y₂, if X_{K-2}≤N_{UL,BWP}<X_{K-1}, the maximum number of subbands may be Y_{K-1}, if X_{K-1}≤N_{UL,BWP}, the maximum number of subbands may be Y_{K}. Here, it may be X₁<X₂< . . . <X_{K-1}, and Y₁<Y₂< . . . <Y_{K}.

FIG. 12A illustrates an example of a method for determining a subband based on a UL BWP configuration according to an embodiment of the disclosure.

With reference to FIG. 12A, a UE may be configured with a UL BWP within a configured UL cell (carrier). The UL BWP may be divided into a plurality of subbands. In the example of FIG. 12A, the UL BWP is illustrated as being divided into two subbands, for example, but this does not limit the scope of the disclosure.

### ii) Subband Determination Based on Cell/Carrier Configuration

In the previous embodiment, a method for grouping RBs within a UL BWP into subbands has been described. In this case, if the UE is configured with different UL BWPs, different UEs may be configured with different subbands. In order to prevent different subbands from being configured for different UEs, a base station may configure a subband for the UE using cell and carrier band configuration information. More specifically, the UE may determine a common RB index based on the cell band information configured by the base station. The common RB index may be the same for the UEs in the cell. Therefore, when determining the subband based on the common RB index, the UEs with different UL BWPs configured in the cell may also determine the subband in the same way.

The methods described below may be applied by replacing a specific BWP RB index with a common RB index in the above UL BWP configuration-based subband determination method.

In a first method, the base station may configure the index of the start RB of each subband and the number of consecutive RBs to the UE. Here, the index of the start RB of each subband and the number of consecutive RBs may be jointly coded and transmitted as a resource indication value (RIV) as in Equation 4. Here, RBₛₜₐᵣₜ is a common RB index and has one of the values 0, 1, . . . , Nₘₐₓ−1, and L_{RBs} has one of the values 1, 2, . . . , Nₘₐₓ. Nₘₐₓ is the number of RBs included in the cell, which may be 273 or 275.

$$if ( {L}_{RBs} - 1 ) \leq ⌊ {N}_{max} / 2 ⌋ then \qquad [ Equation 4 ]$$

$$RIV = {N}_{max} ( {L}_{RBs} - 1 ) + {RB}_{start}$$

$$else RIV = {N}_{max} ( {N}_{max} - {L}_{RBs} + 1 ) + ( {N}_{max} - 1 - {RB}_{start} )$$

$$where {L}_{RBs} \geq 1 and may not exceed {N}_{max} - {RB}_{start} .$$

For example, when the base station configures N subbands to the UE, (the first start RB index, the number of the first consecutive RBs) may be configured in order to set the first subband, (the second start RB index, the number of the second consecutive RBs) may be configured in order to set the second subband, and (the S-th start RB index, the number of the S-th consecutive RBs) may be configured in order to set the S-th subband. Here, the number of subbands S may be explicitly configured to the UE or implicitly configured to the UE. In the case that S is implicitly configured to the UE, the UE may infer S from the configured number of (the i-th start RB index, the number of the i-th consecutive RBs).

The respective subbands may be configured not to overlap with each other or may be configured to overlap with each other.

For example, the respective subbands may be configured not to overlap with each other. In this case, when the index of the RB where the first subband ends may be N_{1,end}, the start RB index (N_{2,start}) of the second subband may be N_{2,start}=N_{1,end}+1. When utilizing this characteristic, the UE may determine the RBs included in each subband even without receiving the index of the start RB or the number of consecutive RBs from the base station.

For example, in the case that S subbands are configured, the base station may configure the indices of the start RBs of each of the S subbands to the UE. Here, since the start RB index of the first subband is always the common RB index 0, the configuration may be omitted. The UE may obtain the indices of the RBs included in each subband from the indices (N_{1,start}, N_{2,start}, . . . , N_{S,start}) of the start RBs of each of the S subbands. The first subband may be constituted with RBs having indices of N_{1,start}, N_{1,start}+1, . . . , N_{2,start}−1, the second subband may be constituted with RBs having indices of N_{2,start}, N_{2,start}+1, . . . , N_{3,start}−1, the S−1-th subband may be constituted with RBs having indices of N_{S-1,start}, N_{S-1,start}+1, . . . , N_{S,start}−1, and the S-th subband may be constituted with RBs having indices of N_{S,start}, N_{S,start}+1, . . . , N_{UL,BWP},end. Here, N_{UL,BWP},end may be RBs with the highest common RB index among the RBs included in the cell. Here, it may be N_{1,start}=0.

For example, in the case that S subbands are configured, the base station may configure the number of RBs (N1,length, N2,length, . . . , NS,length) included in each of the S subbands to the UE. Here, it may satisfy N1,length+N2,length+ . . . +NS,length=Ncell. Ncell may be the number of RBs included in the cell. Therefore, the base station may not configure one of the values of N1,length, N2,length, . . . , NS,length to the UE. For example, the base station may not configure N1,length to NS,length to the UE, in which case, it may determine through N1,length=Ncell-(N2,length+ . . . +NS,length) to NS,length=Ncell-(N1,length+ . . . +NS−1,length). The UE may obtain the indexes of the RBs included in each subband from the number of RBs (N1,length, N2,length, . . . , NS,length) included in each of the S subbands. The first subband may be constituted with RBs having indices of 0, 1, . . . , N1,length−1, the second subband may be constituted with RBs having indices of N1,length, N1,length+1, . . . , N1,length+N2,length−1, the S−1 subband may be constituted with RBs having indices of N1,length+N2,length+ . . . +N_{S-2,length}, N1,length+N2,length+ . . . +N_{S-2,length}+1, . . . , N1,length+N2,length+ . . . +N_{S-2,length}+NS−1,length−1, the S subband may be constituted with RBs having indices of N1,length+N2,length+ . . . +NS−1,length, N1,length+N2,length+ . . . +NS−1,length+1, . . . , N1,length+N2,length+ . . . +NS−1,length+NS,length−1.

For example, the respective subbands may be configured to overlap with each other. That is, one RB may be included in the first subband and also in the second subband. In this case, the UE may expect the following hierarchical configuration.

The UE may be configured with non-overlapping subbands from the base station. For example, four subbands may be configured to include all RBs of the UL BWP without overlapping with each other. This may be configured according to the method described above for configuring the respective subbands to not overlap with each other. The UE may generate overlapping subbands by grouping the non-overlapping subbands. In this case, the UE may group subbands that are adjacent to each other on the frequency domain. For example, it is assumed that the UE has been configured with non-overlapping subbands SB #0, SB #1, SB #2, and SB #3 from the base station. The UE may determine new subbands by grouping the non-overlapping subbands. For example, SB #0 and SB #1 may be grouped to determine a new SB #4. Also, SB #2 and SB #3 may be grouped to determine a new SB #5. Also, SB #0, SB #1, SB #2, and SB #3 may be grouped to determine a new SB #6. Here, which subbands are grouped to generate new subbands may be configured by the base station or determined according to a determined rule.

For example, the determined rule may be as follows.

In the case that the base station configures two non-overlapping subbands (SB #0 and SB #1) to the UE, the new subband, SB #2, may be determined by grouping SB #0 and SB #1.

In the case that the base station configures four non-overlapping subbands (SB #0, SB #1, SB #2, SB #3) to the UE, as a first rule, a new subband, SB #4, may be determined by grouping SB #0 and SB #1, SB #5 may be determined by grouping SB #2 and SB #3, and SB #6 may be determined by grouping SB #0, SB #1, SB #2, and SB #3. As a second rule, a new subband, SB #4, may be determined by grouping SB #0, SB #1, SB #2, and SB #3.

In the case that the base station configures eight non-overlapping subbands (SB #0, SB #1, SB #2, SB #3, SB #4, SB #5, SB #6, SB #7) to the UE, as a first rule, a new subband, SB #8, may be determined by grouping SB #0 and SB #1, SB #9 may be determined by grouping SB #2 and SB #3, SB #10 may be determined by grouping SB #4 and SB #5, SB #11 may be determined by grouping SB #6 and SB #7, SB #12 may be determined by grouping SB #0, SB #1, SB #2, and SB #3, SB #13 may be determined by grouping SB #4, SB #5, SB #6, and SB #7, and SB #14 may be determined by grouping SB #0, SB #1, SB #2, SB #3, SB #4, SB #5, SB #6, and SB #7. As a second rule, a new subband, SB #8, may be determined by grouping SB #0, SB #1, SB #2, and SB #3, SB #9 may be determined by grouping SB #4, SB #5, SB #6, and SB #7, and SB #10 may be determined by grouping SB #0, SB #1, SB #2, SB #3, SB #4, SB #5, SB #6, and SB #7. As a third rule, a new subband, SB #8, may be determined by grouping SB #0, SB #1, SB #2, SB #3, SB #4, SB #5, SB #6, and SB #7.

In the second method, the UE may be configured to the number of subbands(S) by the base station, and divide the RBs included in the UL BWP into S subbands based on the number of subbands. Here, the respective subbands may not overlap with each other. Here, the RBs included in the UL BWP may be included in one subband.

A method for dividing subbands according to the second method is as follows.
Method for dividing by RB unit: The UE may divide the N_{cell} RBs included in the cell into S subbands. In the first method for dividing by RB unit, the S subbands may be divided so that each of the S subbands has a maximum difference of 1 RB. For example, the number of RBs included in each of the S subbands is one of ceil(N_{cell}/S) and floor(Ncell/S). More specifically, among the S subbands, S1=mod(N_{cell},S) subbands may include ceil(N_{cell}/S) RBs, and S2=S-mod(N_{cell},S) subbands may include floor(N_{cell}/S) RBs. For example, in the case that a cell includes N_{cell}=273 RBs and S=4, among the S subbands, S1=mod(273,4)=1 subband may include ceil(273/4)=69 RBs, and S2=S−mod(273,4)=4−1=3 subbands may include floor(273/4)=68 RBs.

In a second method for dividing by RB units, among the S subbands, S−1 subbands may include floor(N_{cell}/S) RBs, and 1 subband may include N_{cell}−(S−1)*floor(N_{cell}/S) RBs. For example, in the case that a cell includes N_{cell}=273 RBs and S=4, S−1=3 subbands may include floor(273/4)=68 RBs, and 1 subband may include 273−3*floor(273/4)=69 RBs.
Method for dividing by RB set units: The UE may generate RB sets by grouping N_{cell} RBs included in the cell. The RBs included in UL BWP are grouped into N_{RB-set} RB sets. The N_{RB-set} RB sets may be divided into S subbands. As the first division method, the S subbands may be divided so that each of them has a different number of RB-sets by at most 1. For example, the number of RB-sets included in each of the S subbands is one of ceil(N_{RB-set}/S) and floor(N_{RB-set}/S). More specifically, among the S subbands, S1=mod(N_{RB-set},S) subbands may include ceil(N_{RB-set}/S) RB-sets, and S2=S−mod(N_{RB-set},S) subbands may include floor(N_{RB-set}/S) RB-sets. As the second division method, among the S subbands, S−1 subbands may include floor(N_{RB-set}/S) RBs, and 1 subband may include N_{RB-set}−(S−1)*floor(N_{RB-set}/S) RB-sets.

RB-sets may be generated by grouping P RBs in ascending order of common RB index. Here, P may be determined according to the number of RBs included in the cell as one of 2, 4, 8, and 16, or may be a value configured by the base station.

The maximum number of subbands may be determined as a specific value. That is, the number of subbands(S) configured may be equal to or less than the maximum number of subbands. The maximum number of subbands may be determined as follows.
The maximum number of subbands may be determined as a specific value regardless of the number of RBs included in the cell. For example, the maximum number of subbands may be determined as one of 2, 4, or 8. Here, 2, 4, and 8 are numbers that may be expressed in the form of a power of 2 (2^{b}, b=1, 2, 3).
The maximum number of subbands may be determined according to the number of RBs included in the cell. That is, in the case that more RBs are included in the cell, a larger maximum number of subbands may be possible. For example, if the number of cells (N_{UL,BWP}) is 1≤N_{cell}<X₁, the maximum number of subbands may be Y₁, if the number of cells (N_{UL,BWP}) is X₁≤N_{cell}<X₂, the maximum number of subbands may be Y₂, if the number of cells (N_{UL,BWP}) is X₂≤N_{cell}<X₃, the maximum number of subbands may be Y₃, the number of cells (N_{UL,BWP}) is X₃≤N_{cell}, the maximum number of subbands may be Y₄. Here, it may be X₁<X₂<X₃, and Y₁<Y₂<Y₃<Y₄. In addition, it may be fixed as Y₁=1. In addition, it may be Y₂=2, Y₃=4, Y₄=8. For reference, this example is a method to determine four different maximum numbers of subbands (Y₁, Y₂, Y₃, Y₄) according to the number of RBs included in the cell. In the same way, a method to generate K different maximum numbers of subbands (Y₁, Y₂, . . . , Y_{K}) is as follows. If 1≤N_{cell}<X₁, the maximum number of subbands may be Y₁, if X₁≤N_{cell}<X₂, the maximum number of subbands may be Y₂, if X_{K-2}≤N_{cell}<X_{K-1}, the maximum number of subbands may be Y_{K-1}, if X_{K-1}≤N_{cell}, the maximum number of subbands may be Y_{K}. Here, it may be X₁<X₂< . . . <X_{K-1}, and Y₁<Y₂< . . . <Y_{K}.

FIG. 12B illustrates an example of a method for determining a subband based on a cell/carrier configuration according to an embodiment of the disclosure.

With reference to FIG. 12B, the UL cell (carrier) configured to the UE may be divided into a plurality of subbands. In the example of FIG. 12B, a cell (carrier) may be divided into three subbands. For reference, although the cell (carrier) is illustrated as being divided into three subbands as an example, this does not limit the scope of the disclosure, and is unrelated to the UL BWP configuration. Since the UL BWP activated for the UE overlaps only with SB #1 and SB #2 and does not overlap with SB #0, the UE may determine that two subbands are configured within the activated UL BWP.

iii) Subband Determination Method Based on Scheduling Information

In another embodiment, the UE may determine a subband based on scheduling information. The UE may obtain scheduling information from the base station. For example, the UE may receive DCI for scheduling PUSCH from the base station. The UE may obtain information on a frequency band in which the PUSCH is scheduled through the DCI. The information on the frequency band may be obtained from a frequency domain resource allocation (FDRA) field or a frequency hopping flag field. The UE may determine a subband based on the scheduled frequency band. As another example, the UE may activate an UL channel and signal transmission through a higher layer signal (RRC signal or MAC-CE signal). The UL channel and signal transmission activated through a higher layer signal (RRC signal or MAC-CE signal) may include, for example, CG-PUSCH transmission, SRS transmission, PRACH transmission, and the like. The UE may obtain information on a frequency band in which an UL channel and signal are scheduled from a higher layer signal, and determine a subband based on the above information.

For the convenience of the description, the start RB index of the frequency band obtained from the scheduling information is called N_{scheduled,start}, the last RB index is called N_{scheduled,end}, and the number of RBs included in the frequency band is called N_{scheduled,length}. In the case that the scheduled channel is PUSCH and frequency hopping is activated, the start RB index of the first hop may be called N_{scheduled,start,1}, the last RB index of the first hop may be called N_{scheduled,end,1}, the start RB index of the second hop may be called N_{scheduled,start,2}, and the last RB index of the second hop may be called N_{scheduled,end,2}.

The RB start index and last RB index may be assigned according to a specific BWP RB index. In addition, the RB start index and last RB index may be assigned according to a common RB index. Unless otherwise specified, the embodiments of the disclosure may be equally applied when the RB index is assigned to a specific BWP RB index and common RB index.

In a first method, the UE may be configured to the number of subbands(S) by the base station, and divide the scheduled RBs into S subbands based on the number of subbands. Here, the respective subbands may not overlap with each other. Here, the scheduled RB may be included in one subband.

A method for dividing subbands according to the first method is as follows.
Method for dividing by RB unit: The UE may divide N_{scheduled,length} RBs included in the scheduled frequency band into S subbands. In the first method for dividing by RB unit, the S subbands may be divided so that each of them has a different number of RBs by at most 1. For example, the number of RBs included in each of the S subbands is one of ceil(N_{scheduled,length}/S) and floor(N_{scheduled,length}/S). More specifically, among the S subbands, S1=mod(N_{scheduled,length},S) subbands may include ceil(N_{scheduled,length}/S) RBs, and S2=S−mod(N_{scheduled,length},S) subbands may include floor(N_{scheduled,length}/S) RBs. For example, in the case that the scheduled frequency band includes N_{scheduled,length}=273 RBs and S=4, among the S subbands, S1=mod(273,4)=1 subband may include ceil(273/4)=69 RBs, and S2=S−mod(273,4)=4−1=3 subbands may include floor(273/4)=68 RBs.
In the second method for dividing by RB units, among the S subbands, S−1 subbands may include floor(N_{scheduled,length}/S) RBs, and 1 subband may include N_{scheduled,length}−(S−1)*floor(N_{scheduled,length}/S) RBs. For example, in the case that the scheduled frequency band includes N_{UL,BWP}=273 RBs and S=4, S−1=3 subbands may include floor(273/4)=68 RBs, and one subband may include 273−3*floor(273/4)=69 RBs.

In the case that the scheduled channel is PUSCH and frequency hopping is activated, N_{scheduled,length} RBs may be the number of RBs included in each hop. In addition, the UE may independently generate subbands for each hop. That is, by using the above method, the RBs included in the first hop of the PUSCH may be divided into S subbands, and the RBs included in the second hop of the PUSCH may be divided into S subbands.

In the case that the scheduled channel is PUSCH and frequency hopping is activated, N_{scheduled,length} RBs may be the number of RBs included in two hops. In this case, RBs included in two hops may be divided into S subbands.
Method for dividing by RB set units: The UE may generate RB sets by grouping N_{scheduled,length} RBs included in the scheduled frequency band. RBs included in the scheduled frequency band are grouped into N_{RB-set} RB sets. The N_{RB-set} RB sets may be divided into S subbands. As the first division method, the S subbands may be divided so that each of them has a different number of RB-sets by at most 1. For example, the number of RB-sets included in each of the S subbands is one of ceil(N_{RB-set}/S) and floor(N_{RB-set}/S). More specifically, among the S subbands, S1=mod(N_{RB-set},S) subbands may include ceil(N_{RB-set}/S) RB-sets, and S2=S-mod(N_{RB-set},S) subbands may include floor(N_{RB-set}/S) RB-sets. As the second division method, among the S subbands, S−1 subbands may include floor(N_{RB-set}/S) RBs, and 1 subband may include N_{RB-set}−(S−1)*floor(N_{RB-set}/S) RB-sets.

For example, the RB set may be identical to a resource block group (RBG) generated in frequency domain resource allocation (FDRA) type-0. That is, it may be N_{RB-set}=┌N_{UL,BWP}+ (N_{UL,BWP,start} mod P)/P┐,
A first RB-set may include P−(N_{UL,BWP,start} mod P) RBs,
A last RB-set may include (N_{UL,BWP}+N_{UL,BWP,start})mod P RBs if (N_{UL,BWP}+N_{UL,BWP,start})mod P>0, and include P RBs if (N_{UL,BWP}+N_{UL,BWP,start})mod P=0,
The remaining RB-sets may include P RBs.

Here, the number of RB-sets including at least one RB included in the scheduled bandwidth among the N_{RB-set} RB-sets is called N_{RB-set}, and the RB-sets including at least one RB included in the scheduled bandwidth among the N_{RB-set} RB-sets may be grouped into S subbands.

Here, N_{UL,BWP,start} is the index of the lowest RB included in the UL BWP determined according to a common RB index. Here, P may be a value determined according to the number of RBs included in the UL BWP as one of 2, 4, 8, and 16, and may be determined, or may be a value configured by the base station.
For example, RB set may be identical to a resource block group (REG) generated in frequency domain resource allocation (FDRA) type-0. That is, it may be N_{RB-set}=┌N_{scheduled,length}+ (N_{scheduled,start} mod P)/P┐,
A first RB-set may include P−(N_{scheduled,start} mod P) RBs,
A last RB-set may include (N_{scheduled,length}+N_{scheduled,start})mod P RBs if (N_{scheduled,length}+N_{scheduled,start})mod P>0, and may include P RBs if (N_{scheduled,length}+N_{scheduled,start})mod P=0,
The remaining RB-sets may include P RBs.

In the case that the scheduled channel is PUSCH and frequency hopping is activated, N_{scheduled,length} RBs may be the number of RBs included in each hop. In addition, the UE may independently generate subbands for each hop. That is, with the above method, the RBs included in the first hop of the PUSCH may be divided into S subbands, and the RBs included in the second hop of the PUSCH may be divided into S subbands. Here, when dividing the RBs included in the first hop into S subbands, it may be N_{scheduled,start}=N_{scheduled,start,1}, and when dividing the RBs included in the second hop into S subbands, it may be N_{scheduled,start}=N_{scheduled,start,2}.

In the case that the scheduled channel is PUSCH and frequency hopping is activated, N_{scheduled,length} RBs may be the number of RBs included in both hops. In this case, the RBs included in the two hops may be divided into S subbands.

The number of subbands may be determined to a specific value regardless of the number of RBs included in the scheduled frequency band. For example, the number of subbands may be determined to one of the numbers 2, 4, or 8. Here, 2, 4, and 8 are numbers that may be expressed in the form of a power of 2 (25, b=1, 2, 3).

The number of subbands may be determined according to the number of RBs included in the scheduled frequency band. That is, in the case that more RBs are included in the scheduled frequency band, a larger number of subbands may be possible. For example, if the number of RBS (N_{scheduled,length}) included in the scheduled frequency band is 1≤ N_{scheduled,length}<X₁, the number of subbands may be Y₁, if the number of RBs (N_{scheduled,length}) included in the scheduled frequency band is X₁≤N_{scheduled,length}<X₂, the number of subbands may be Y₂, if the number of RBs (N_{scheduled,length}) included in the scheduled frequency band is X₂≤ N_{scheduled,length}<X₃ the, number of subbands may be Y₃, if the number of RBs (N_{scheduled,length}) included in the scheduled frequency band is X₃≤ N_{scheduled,length}, the number of subbands may be Y₄. Here, it may be X₁<X₂<X₃, and Y₁<Y₂<Y₃<Y₄. In addition, it may be fixed as Y₁=1. In addition, it may be Y₂=2, Y₃=4, Y₄₌₈. For reference, this example is a method for determining four different numbers of subbands (Y₁, Y₂, Y₃, Y₄) according to the number of RBs included in the scheduled frequency band. In the same way, a method for generating K different subband numbers (Y₁, Y₂, . . . , Y_{K}) is as follows. If 1≤ N_{scheduled,length}<X₁, the number of subbands may be Y₁, if X₁≤N_{UL,BWP}<X₂, the number of subbands may be Y₂, if X_{K-2}≤N_{scheduled,length}<X_{K-1}, the number of subbands may be Y_{K-1}, if X_{K-1}≤N_{scheduled,length}, the number of subbands may be Y_{K}. Here, it may be X₁<X₂< . . . <X_{K-1}, and Y₁<Y₂< . . . <Y_{K}. To do this, the UE may be configured to X₁, X₂, . . . , X_{K-1}♀|. Y₁, Y₂, . . . , Y_{K} by the base station. To do this, the UE may use X₁, X₂, . . . , X_{K-1} and Y₁, Y₂, . . . , Y_{K} determined according to standard documents.

In a third method, the UE may be configured to a nominal number (N_{subband}) of RBs included in a subband by the base station, and divide the RBs included in the scheduled frequency band into S subbands based on the nominal number of RBs included in the subband. Here, the respective subbands may not overlap with each other. Here, the RBs included in the scheduled frequency band may be included in one subband.

A method for dividing the subbands according to the third method is as follows.
In one method, the UE divides the RBs included in the scheduled frequency band into S=ceil(N_{scheduled,length}/N_{subband}) subbands, S−1 subbands may include N_{subband} RBs, and one subband can include N_{scheduled,length}−(S−1)*N_{subband} RBs.
In another method, the UE divides the RBs included in the scheduled frequency band into S=N_{scheduled,length}+ (N_{scheduled,start} mod N_{subband})/N_{subband} subbands,

A first subband may include N_{subband}−(N_{scheduled,start} mod N_{subband}) RBs,

A last subband may include (N_{scheduled,length}+N_{scheduled,start})mod N_{subband} RBs if (N_{scheduled,length}+N_{scheduled,start})mod N_{subband}>0, and include N_{subband} RBs if (N_{scheduled,length}+N_{scheduled,start})mod N_{subband}=0,

The remaining subbands may include N_{subband} RBS.

In the case that the scheduled channel is PUSCH and frequency hopping is activated, N_{scheduled,length} RBs may be the number of RBs included in each hop. In addition, the UE may independently generate subbands for each hop. That is, with the above method, the RBs included in the first hop of the PUSCH may be divided into S subbands, and the RBs included in the second hop of the PUSCH may be divided into S subbands. Here, when dividing the RBs included in the first hop into S subbands, it may be N_{scheduled,start}=N_{scheduled,start,1}, and when dividing the RBs included in the second hop into S subbands, it may be N_{scheduled,start}=N_{scheduled,start,2}.

In the case that the scheduled channel is PUSCH and frequency hopping is activated, N_{scheduled,length} RBs may be the number of RBs included in both hops. In this case, the RBs included in the two hops may be divided into S subbands.

The nominal number (N_{subband}) of RBs included in a subband may be determined to a specific value regardless of the number of RBs included in the scheduled frequency band. For example, the nominal number (N_{subband}) of RBs included in a subband may be determined to one of 16, 32, and 64. Here, 16, 32, and 64 are numbers that may be expressed in the form of a power of 2 (2^{b}, b=4, 5, 6).

The nominal number (N_{subband}) of RBs included in a subband may be determined according to the number of RBs included in the scheduled frequency band. That is, in the case that more RBs are included in the scheduled frequency band, a larger N_{subband} may be possible. For example, if the number of RBs (N_{scheduled,length}) included in the scheduled frequency band is 1≤ N_{scheduled,length}<X₁, N_{subband} may be Y₁, if the number of RBs (N_{scheduled,length}) included in the scheduled frequency band is X₁≤N_{scheduled,length}<X₂, N_{subband} may be Y₂, if the number of RBs (N_{scheduled,length}) included in the scheduled frequency band is X₂≤N_{scheduled,length}<X₃, N_{subband} may be Y₃, if the number of RBs (N_{scheduled,length}) included in the scheduled frequency band is X₃≤N_{scheduled,length}, N_{subband} may be Y₄. Here, it may be X₁<X₂<X₃, and Y₁<Y₂<Y₃<Y₄. In addition, it may be fixed as Y₁=1. In addition, it may be Y₂=2, Y₃=4, Y₄=8. For reference, this example is a method for determining four different N_{subband} (Y₁, Y₂, Y₃, Y₄) according to the number of RBs included in the scheduled frequency band. In the same way, a method to generate K different N_{subband} (Y₁, Y₂, . . . , Y_{K}) is as follows. If 1≤N_{scheduled,length}<X₁, N_{subband} may be Y₁, if X₁≤N_{UL,BWP}<X₂, N_{subband} may be Y₂, if X_{K-2}≤N_{scheduled,length}<X_{K-1}, N_{subband} may be Y_{K-1}, if X_{K-1}≤N_{scheduled,length}, N_{subband} may be Y_{K}. Here, it may be X₁<X₂< . . . <X_{K-1}, and Y₁<Y₂< . . . <Y_{K}. To do this, the UE may be configured to X₁, X₂, . . . , X_{K-1} and Y₁, Y₂, . . . , Y_{K} by the base station. To do this, the UE may use X₁, X₂, . . . , X_{K-1} and Y₁, Y₂, Y_{K} determined according to standard documents.

FIG. 12C illustrates an example of a method for determining a subband based on scheduling information according to an embodiment of the disclosure.

With reference to FIG. 12C, a frequency band including a scheduled UL channel/signal may be divided into subbands. In the example of FIG. 12C, a scheduled PUSCH is divided into two subbands as an example, but this does not limit the scope of the disclosure. If the frequency band included in the scheduled PUSCH is changed, the subbands may be divided differently.

With a fourth method, the UE may configure different subbands in different time areas.

For example, the UE may configure a subband in a first time interval and not configure a subband in a second time interval. As a more specific embodiment, in the case that the UE supports an SBFD operation, the UE may configure a UL subband or a DL subband in a first time interval and not configure a subband in a second time interval. In the second time interval where no subband is configured, the UE may not perform operations related to the subband. In other words, the second time interval where no subband is configured may be interpreted as all frequency bands being associated with one subband. In the first interval, the UE may be configured to a UL subband or a DL subband. UL transmission may be possible in the UL subband, and downlink reception may be possible in the DL subband. The method for configuring the subbands may follow the above methods.

In addition, a frequency resource not included in the DL subband or UL subband may be a guard band. The guard band may not be used for UL transmission or DL reception. The base station may include the guard band in the scheduling resource, and may indicate the UE whether the guard band is included in the scheduling resource. For example, the base station may indicate the UE whether the guard band is schedulable through DCI in which the base station schedules a physical shared channel (PDSCH or PUSCH). For example, in the case that a guard band is included in a frequency resource for which a physical shared channel is scheduled from the DCI, the UE may determine that the physical shared channel is scheduled in the guard band. As another example, a bit indicating whether the guard band is a scheduling target may be included in the DCI. Depending on the bit, the UE may determine whether the physical shared channel scheduled by the DCI may be scheduled in the guard band. In the case that there is a plurality of guard bands, whether or not to schedule the plurality of guard bands may be indicated with 1 bit, whether or not to schedule for each guard band may be indicated with each 1 bit, or whether or not to schedule by grouping some of the plurality of guard bands may be indicated with 1 bit, respectively. The UE may assume that a physical shared channel scheduled by a DCI (e.g., DCI format 0_0, DCI format 1_0) that does not include the above bit may not be scheduled in the guard band.

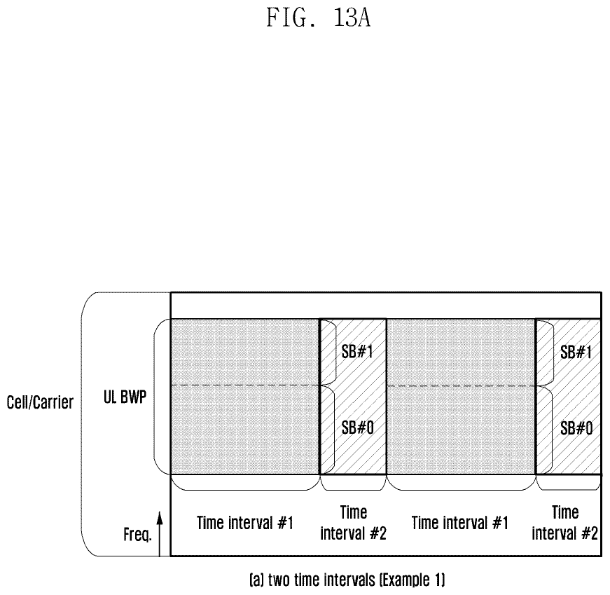

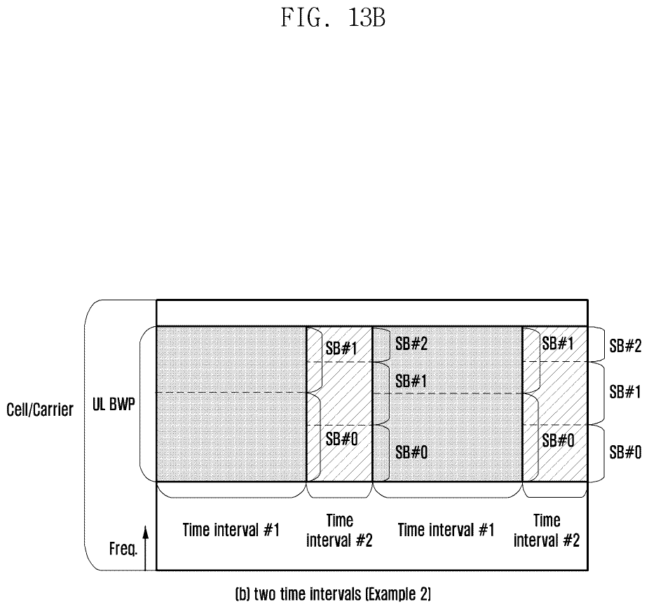

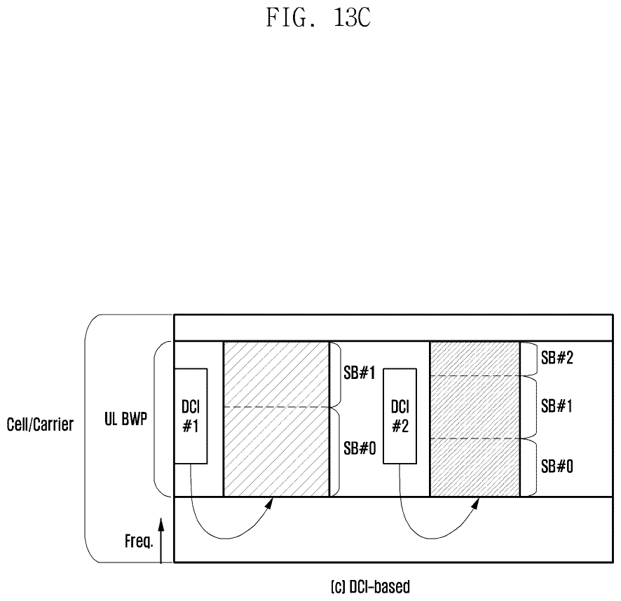

FIG. 13A illustrates an example of a method for configuring subbands by time interval according to an embodiment of the disclosure. With reference to FIG. 13A, it is illustrated that a first subband configuration is configured in a first time interval (Time interval #1), and a subband configuration is not configured in a second time interval (Time interval #2). The first subband configuration may be a configuration according to i) a method for determining a subband based on UL BWP configuration, ii) a method for determining a subband based on cell/carrier configuration, or iii) a method for determining a subband based on scheduling information, as described above. In the example of FIG. 13A, the first subband configuration may be a configuration for dividing RBs included in the UL BWP into two subbands. For example, the SB #0 may be a DL subband, and the SB #1 may be a UL subband. Conversely, the SB #0 may be a UL subband, and the SB #1 may be a DL subband.

For example, the base station may configuration the first subband configuration to the UE for the first time interval, and the second subband configuration to the UE for the second time interval. That is, the UE may be configured with different subband configurations for different time intervals. For example, four subbands may be configured for one slot, and two subbands may be configured for another slot. The UE may receive information on the first time interval and the first subband configuration from the base station, and information on the second time interval and the second subband configuration. In the case that an UL channel or signal is scheduled within the first time interval, the UE may determine a subband based on the first subband configuration. In the case that an UL channel or signal is scheduled within the second time interval, the UE may determine a subband based on the second subband configuration. In the case that an UL channel or signal is scheduled over the first time interval and second time interval, the UE may determine a subband based on one of the first subband configuration and the second subband configuration. The above configuration may be determined based on which time interval includes a time at which the scheduled UL channel or signal is first scheduled. For example, in the case that the scheduled UL channel is a repetitive transmission of a PUSCH, the UE may transmit subsequent repetitive transmissions based on the subband configuration configured in the first time interval if the first repetitive transmission is in the first time interval. In another method, which subband configuration to use for the DCI being scheduled may be indicated. That is, the scheduling DCI format may include a bit field indicating one of a plurality of subband configurations. The UE may determine a subband of the transmitted UL channel or signal according to the indication of the bit field.

FIG. 13B illustrates another example of a method for configuring subbands by time interval according to an embodiment of the disclosure. With reference to FIG. 13B, a first subband configuration is configured in a first time interval (Time interval #1), and a second subband configuration is configured in a second time interval (Time interval #2). The first subband configuration and second subband configuration may be configurations according to i) the method for determining a subband based on the UL BWP configuration, ii) the method for determining a subband based on cell/carrier configuration, and iii) the method for determining a subband based on scheduling information, as described above. In the example of FIG. 13B, the first subband configuration may be a configuration for dividing RBs included in the UL BWP into two subbands, and the second subband configuration may be a configuration for dividing RBs included in the UL BWP into three subbands.

For example, the base station may configure the first subband configuration and second subband configuration to the UE at the same time. That is, a plurality of subband configurations may be configured for the UE. In this case, time information to which each subband configuration is applied may be configured for the UE. That is, the first time interval corresponding to the first subband configuration may be configured, and the second time interval corresponding to the second subband configuration may be configured. For example, four subbands may be configured for one slot, and two subbands may be configured for another slot. The UE may receive, from the base station, information on the first time interval and first subband configuration, and information on the second time interval and second subband configuration. In the case that an UL channel or signal is scheduled within the first time interval, the UE may determine a subband based on the first subband configuration. In the case that an UL channel or signal is scheduled within the second time interval, the UE may determine a subband based on the second subband configuration. In the case that an UL channel or signal is scheduled over the first time interval and second time interval, the UE may determine a subband based on one of the first subband configuration and the second subband configuration.

The configuration may be determined based on which time interval includes a time at which the scheduled UL channel or signal is first scheduled. For example, in the case that the scheduled UL channel is a repeated transmission of a PUSCH, the UE may transmit subsequent repeated transmissions based on the subband configuration configured in the first time interval if the first repeated transmission is in the first time interval.

In another method, the base station may indicate which subband configuration to use through the scheduling DCI. That is, the scheduling DCI format may include a bit field indicating one subband configuration of a plurality of subband configurations. The UE may determine the subband of the transmitted UL channel or signal according to the indication of the bit field. An embodiment of indicating one of the subband configurations in DCI may be used even in the case where a time interval corresponding to the subband is not configured. That is, the base station may configure a plurality of subband configurations to the UE, and may indicate which subband configuration to use through DCI. In this case, a separate usage time interval is not configured, and one subband configuration may be used according to DCI in all time intervals.

FIG. 13C illustrates an example of a method for indicating a subband configuration based on DCI according to an embodiment of the disclosure.

With reference to FIG. 13C, it is illustrated that the UE is configured with the first subband configuration or second subband configuration by the base station, and uses one configuration according to DCI. The first subband configuration and second subband configuration may be configurations according to i) the method for determining a subband based on a UL BWP configuration, ii) the method for determining a subband based on a cell/carrier configuration, and iii) the method for determining a subband based on scheduling information, as described above. In the example of FIG. 13C, the first subband configuration may be a configuration that divides RBs included in a UL BWP into two subbands. The second subband configuration may be a configuration that divides RBs included in a UL BWP into three subbands. The first DCI (DCI #1) may be a DCI that indicates the use of the first subband configuration, and the second DCI (DCI #2) may be a DCI that indicates the use of the second subband configuration.

### Second Embodiment: Method for Configuring and Indicating Transmission Parameters for Each Subband

In the case that the UE receives S subbands from the base station, different transmission parameters may be configured for each subband. When transmitting an UL channel or signal within a subband, the UE may transmit the UL channel or signal based on the configured transmission parameters.

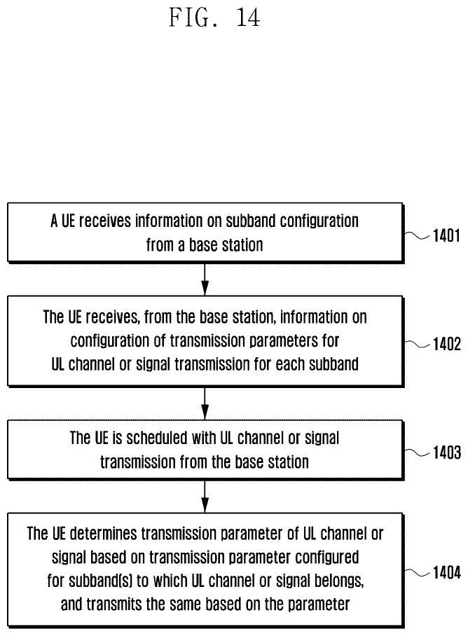

FIG. 14 illustrates a method for a UE to transmit an UL channel or signal according to an embodiment of the disclosure.

With reference to FIG. 14, the UE may transmit an UL channel or signal through the following process.

In a first operation 1401, the UE may receive information on subband configuration from the base station. This may be configured based on at least one of the information for determining a subband based on UL BWP configuration information, the information for determining a subband based on Cell band configuration, or the scheduling information-based subband determination method, as disclosed in the first embodiment. The UE may determine subbands based on the information on the subbands.

In a second operation 1402, the UE may receive information on the configuration of transmission parameters for UL channel or signal transmission for each subband from the base station.

In a third operation 1403, the UE may be scheduled for UL channel or signal transmission from the base station. For example, the UE may be scheduled to transmit an UL channel or signal through DCI. The DCI format may be DCI format 0_0, 0_1, or 0_2. The UL channel or signal may be PUSCH, PUCCH, or SRS. The UE may determine a subband to which the scheduled UL channel or signal belongs. If the scheduled UL channel or signal belongs to one subband, the UE may determine the one subband as the subband to which the scheduled UL channel or signal belongs. If the scheduled UL channel or signal belongs to a plurality of subbands, the UE may determine the plurality of subbands as the subbands to which the scheduled UL channel or signal belongs.

In a fourth operation 1404, the UE may determine a transmission parameter of the UL channel or signal based on the transmission parameter configured for the subband(s) to which the UL channel or signal belongs and transmit the same based on the parameter. In the case that the subband to which the UL channel or signal belongs is one subband, the UE may transmit the UL channel or signal based on the transmission parameter configured for the one subband. In the case that the subbands to which the UL channel or signal belongs are a plurality of subbands, the UE may transmit the UL channel or signal using one of the following methods. In a first method, the UE may transmit the UL channel or signal based on the transmission parameter configured for one subband of the plurality of subbands. Here, one of the subbands used may be called a reference subband. In a second method, the UE may determine the transmission parameter of a part of the UL channel or signal that overlaps the subband based on the transmission parameter configured for the subband. For example, in the case that the UL channel or signal overlaps two subbands, the transmission parameter of the UL channel or signal that overlaps the first subband may be determined as the transmission parameter configured for the first subband, and the transmission parameter of the UL channel or signal that overlaps the second subband may be determined as the transmission parameter configured for the second subband. That is, according to the disclosure, the UE may apply the plurality of transmission parameters to the UL channel or signal.

The UE may receive separate transmission parameter configurations for each of the plurality of subbands from the base station. Also, the transmission parameter configurations corresponding to each subband may include the plurality of sub transmission parameter configurations (or submethods, or rows of a table including configuration values). In this case, the UE may determine one sub transmission parameter configuration among the transmission parameter configurations corresponding to each subband. A method for this is disclosed.

In an embodiment of the disclosure, when determining the transmission parameter by the first method (the UE transmits the UL channel or signal based on the transmission parameter configured for one of the plurality of subbands), the UE may determine the sub transmission parameter through one bit field. That is, the UE may determine one subband (reference subband), and the one bit field may indicate one of the plurality of sub transmission parameter configurations corresponding to the reference subband.

The length of one bit field may be determined based on the number of sub transmission parameter configurations configured for all subbands. More specifically, the length of one bit field may be configured based on the maximum value among the numbers of sub transmission parameter configurations configured for all subbands. For example, in the case that the UE has been configured to N subbands, and each of the N subbands has X₁, X₂, . . . , X_{N} sub transmission parameter configurations, the length of the bit field may be B=ceil(log₂(max({X₁, X₂, . . . , X_{N}}))). Here, max({X₁, X₂, . . . , X_{N}}) is the largest value among X₁, X₂, . . . , X_{N}. As another example, the length of the bit field may be B=max{ceil(log₂(X₁)), ceil(log₂(X₂)), . . . , ceil(log₂(X_{N}))}.

The UE may obtain B bits from the DCI format. In the case that Xᵢ sub-transmission parameters are configured in the reference subband determined by the UE, one transmission parameter of the Xᵢ sub-transmission parameters may be determined by interpreting the least significant bit (LSB) or the most significant bit (MSB) ceil(log 2(Xᵢ)) bits among the B bits.

In an embodiment of the disclosure, when determining a transmission parameter by the second method (the UE determines the transmission parameter of a part overlapping a subband among an UL channel or signal based on the transmission parameter configured for the subband), the DCI format may include a plurality of bit fields. In the case that the UE receives different configurations for each of the N subbands from the base station, the number of the plurality of bit fields is N, and each field may correspond to each of the N subbands. Here, the first bit field may correspond to the lowest subband in a frequency area, and the second bit field may correspond to the second lowest subband in a frequency area. That is, the bit fields may correspond in ascending order of the frequency area of the subband. The length of each bit field may be determined according to the number of sub-transmission parameter configurations configured in the corresponding subband. For example, the length of the first bit field may be determined according to the number of sub-transmission parameter configurations configured in the first subband. If the number of sub-transmission parameter configurations configured in the subband is Xᵢ, the length of the corresponding bit field may be ceil(log₂(Xᵢ)).

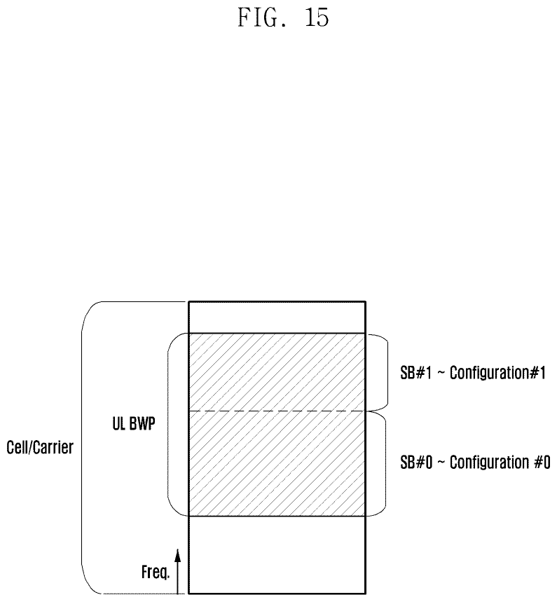

FIG. 15 illustrates configurations configured for each subband according to an embodiment of the disclosure.

With reference to FIG. 15, a UE may be configured to two subbands (SB #0 and SB #1) by a base station. In addition, UL transmission parameters may be configured for each of the two subbands. That is, UL transmission parameters (Configuration #0) may be configured for SB #0, and UL transmission parameters (Configuration #1) may be configured for SB #1. The UE may perform UL transmission based on the transmission parameters.

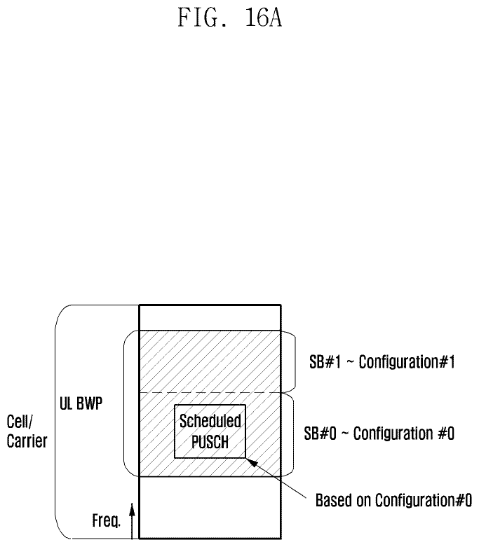

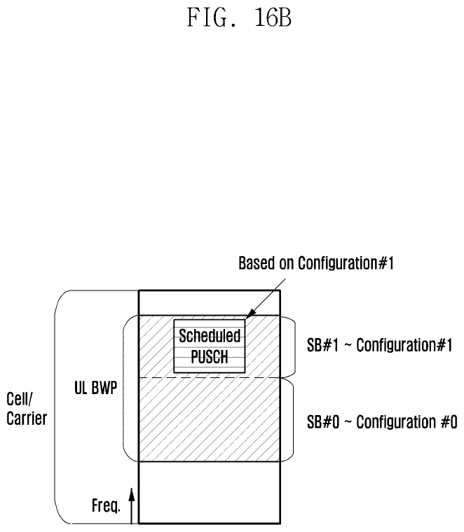

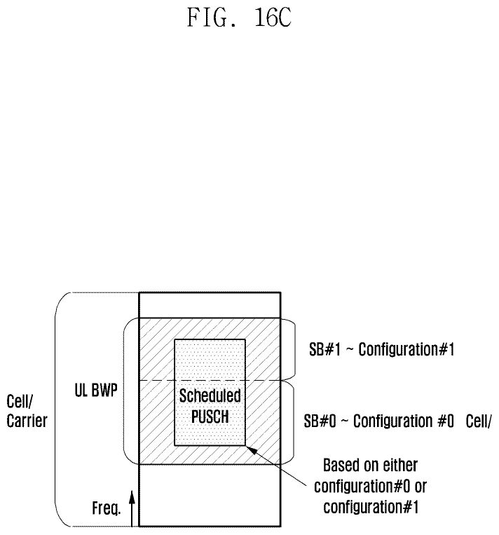

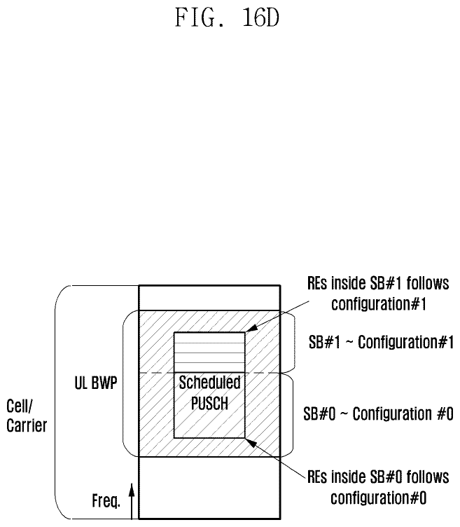

FIGS. 16A-16D illustrate methods for a UE to transmit a PUSCH according to an embodiment of the disclosure.

With reference to FIGS. 16A-16D, a UE may be scheduled for a PUSCH from a base station. As shown in FIG. 16A and FIG. 16B, a scheduled PUSCH may overlap only with one subband. In this case, a transmission parameter of a PUSCH may be determined based on one subband that overlaps with the scheduled PUSCH. That is, with reference to FIG. 16A, in the case that a PUSCH overlaps only with SB #0, a transmission parameter of a PUSCH may be determined based on transmission parameter configuration (Configuration #0) configured in SB #0. With reference to FIG. 16B, in the case that a PUSCH overlaps only with SB #1, a transmission parameter of a PUSCH may be determined based on transmission parameter configuration (Configuration #1) configured in SB #1. As shown in FIG. 16C and FIG. 16D, the scheduled PUSCH may overlap with a plurality of subbands. With reference to FIG. 16C, the UE may determine the transmission parameters of the PUSCH using the transmission parameter configuration (Configuration #0 or Configuration #1) of one subband. In this case, the transmission parameter configuration determined in one subband may also be used in the PUSCH transmission of another subband. With reference to FIG. 16d, the UE may determine the transmission parameters of the PUSCH using the transmission parameter configurations of the subbands overlapping with the scheduled PUSCH. The PUSCH overlapping with SB #0 may follow the transmission parameters determined according to the transmission parameter configuration (Configuration #0) configured in SB #0, and the PUSCH overlapping with SB #1 may follow the transmission parameters determined according to the transmission parameter configuration (Configuration #1) configured in SB #1. That is, the PUSCH may follow different transmission parameter configurations in a frequency area.

The above reference subband may be determined by at least one of the following methods.

In a first method for determining the reference subband, the subband with the lowest subband in a frequency area among the subbands to which the UL channel or signal belongs may be selected as the reference subband. That is, the UE may determine the subband with the lowest subband in a frequency area among the plurality of subbands as the reference subband. This may be determined based on a start RB index or last RB index of each of the plurality of subbands.

In a second method for determining the reference subband, the subband with the highest subband in a frequency area among the subbands to which the UL channel or signal belongs may be selected as the reference subband. That is, the UE may determine the subband with the highest subband in a frequency area among the plurality of subbands as the reference subband. This may be determined based on a start RB index or last RB index of each of the plurality of subbands.

In a third method for determining the reference subband, the subband with the most overlapping RBs among the subbands to which the UL channel or signal belongs may be selected as the reference subband. For example, in the case that there are two subbands to which an UL channel or signal belongs, the UE may determine the number of RBs overlapping with the UL channel or signal for each of the two subbands. The UE may determine a subband with a greater number of RBs overlapping with the UL channel or signal as the reference subband. If the number of RBs overlapping with the UL channel or signal for the two subbands is the same, the UE may determine the reference subband by another method.

In a fourth method for determining the reference subband, a priority may be configured for each subband. The UE may determine the reference subband based on the priority. For example, in the case that there are two subbands to which an UL channel or signal belongs, a priority may be configured for each of the two subbands. In the case that there is a subband with a higher priority among the two subbands, the UE may determine the subband with the higher priority as the reference subband. In the case that the priorities of the two subbands are the same, the UE may determine the reference subband by another method. The above priority may be configured to the UE through a higher layer signal (RRC, MAC-CE) of the base station. In addition, the above priority may be updated through a higher layer signal (RRC, MAC-CE) of the base station.

In a fifth method for determining the reference subband, the UE may be indicated to one subband through a DCI that schedules an UL channel or signal. That is, the DCI may include information for indicating one subband. For example, the DCI may include a bit field for indicating one subband among S subbands. The length of the bit field may be ceil(log₂(S)) bits. For example, one subband may be indicated according to an RNTI value that scrambles the DCI. For example, one subband may be indicated based on at least one or a combination of slot index/symbol index/search space index/CORESET index in which the DCI is received. For example, one subband may be indicated based on at least one or a combination of the lowest RB index/highest RB index/aggregation level of the PDCCH where the DCI is received.

In a sixth method for determining the reference subband, the UE may select one subband. In the case that there is a plurality of subbands to which an UL channel or signal belongs, the UE may select one subband according to the implementation of the UE. In this case, the implementation of the UE may be capable of maximizing the transmission quality of the UL channel or signal. For example, the UE may calculate the expected transmission quality based on the transmission parameters configured for each subband. The transmission quality may include UL transmission power, UL transmission data rate, UL transmission code rate, and the like. The UE may select the subband associated with the transmission parameter that provides the best quality among the calculated transmission qualities.

The transmission parameters that may be configured may include at least one of the following:

As a first transmission parameter, different transmission power-related parameters may be configured for each subband. The UE may determine the transmission power of an UL channel or signal according to transmission power related parameters. Equation 5 is an equation for determining the transmission power of a PUSCH.

$${P}_{PUSCH , b , f , c} ( i , j , {q}_{d} , l ) = min \{ \begin{matrix}{P}_{CMAX , f , c} ( i ) \\ \begin{matrix}{P}_{{O}_{PUSCH , b , f , c}} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] . \qquad [ Equation 5 ]$$

The subband-specific transmission power related parameters for PUSCH may include at least one of the following: parameters related to P_{CMAX,f,c} value that determines a PUSCH maximum transmission power. That is, different maximum transmission powers may be configured for each subband.

In the PUSCH transmission power equation, as for parameters related to P_{O_PUSCH,b,f,c}(j), parameters such as p0-NominalWithoutGrant, p0-PUSCH-Alpha, p0-PUSCH-AlphaSet, i.e., different P0 values may be configured for each subband. Also, different P_{O_PUSCH,b,f,c}(j) may be determined according to the values.

In the PUSCH transmission power equation, as for parameters related to α_{b,f,c}(j), parameters such as p0-PUSCH-Alpha, p0-PUSCH-AlphaSet.

In the PUSCH transmission power equation, parameters related to PL_{b,f,c}(q_{d}), Δ_{TF,b,f,c}(i), f_{b,f,c}(i,l).

In addition, the UE may be configured to an additional power offset value (SB_offset) for each subband. For example, in the case that the power offset value is configured, the equation for determining the PUSCH transmission power may be as shown in Equation 6. That is, the UE may adjust the value of the transmission power for each subband as the (SB_offset) value. The SB_offset value is configured in dB units and may have a granularity of 1 dB units.

$${P}_{PUSCH , b , f , c} ( i , j , {q}_{d} , l ) = min \{ \begin{matrix}{P}_{CMAX , f , c} ( i ) \\ \begin{matrix}{P}_{{O}_{PUSCH , b , f , c}} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l ) + SB\_offset\end{matrix}\end{matrix} \} [ dBm ] . \qquad [ Equation 6 ]$$

As a second parameter, the subbands may be configured with different information related to a procoder. That is, transmission using different procoders may be possible in different subbands. The information corresponding to the procoder information may be a maxRank or codebookSubset parameter or an SRS resource (or SRS configuration) or CSI-RS resource (or CSI-RS configuration) indicating the quasi-co-located (QCL) source relationship of the procoder. That is, different procoders may be determined for different subbands based on the SRS resource (or SRS configuration) or CSI-RS resource (or CSI-RS configuration) which are different QCL sources.

As a third parameter, the subbands may be configured with different beta offset values. That is, the number of resources for transmitting UCI may be determined using different beta offsets in different subbands.

### Third Embodiment: Subband-Based UCI Transmission Method

The UE may multiplex and transmit UCI and UL shared channel (UL-SCH) in one PUSCH. That is, some REs of one PUSCH may be used to transmit UCI, and the remaining REs may be used to transmit UL-SCH.

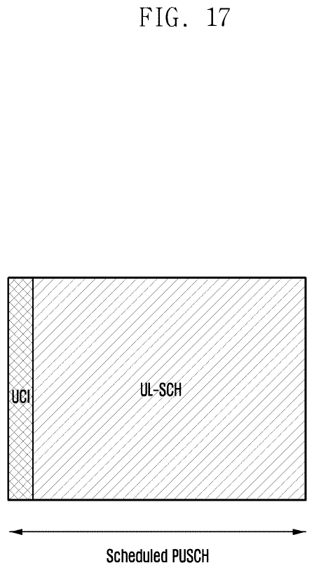

FIG. 17 illustrates that UCI and UL-SCH are multiplexed in a PUSCH according to an embodiment of the disclosure.

With reference to FIG. 17, REs in which UCI is transmitted in a PUSCH may be all frequency bands of the PUSCH. That is, UCI may be multiplexed and transmitted on all frequency bands of the PUSCH.

According to the existing method, since UCI is multiplexed and transmitted on all frequency bands of the PUSCH, the UE may not select a frequency band with excellent transmission quality among the frequency bands in which the PUSCH is scheduled. The third embodiment of the disclosure discloses a method for transmitting UCI on some frequency bands among the frequency bands in which the PUSCH is scheduled in order to improve the transmission performance of UCI.

The UE may transmit UCI by multiplexing it to a specific subband within the PUSCH. Here, the specific subband may be a continuous frequency band. The continuous frequency band may be composed of subcarriers of continuous indices.

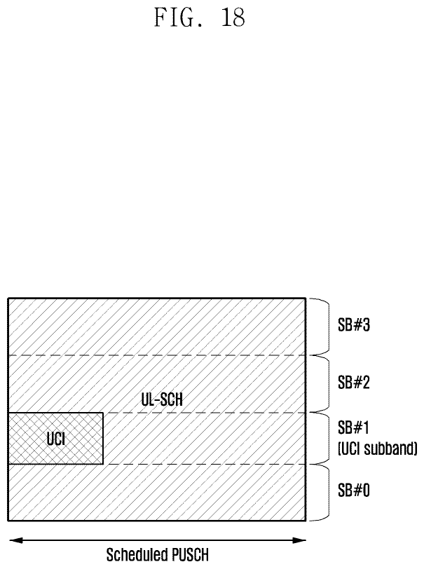

FIG. 18 illustrates UCI being transmitted based on a specific subband according to an embodiment of the disclosure.

With reference to FIG. 18, a UE may receive a subband configuration from a base station and may determine a plurality of subbands according to the subband configuration. With reference to FIG. 18, the UE may determine four subbands (SB #0, SB #1, SB #2, SB #3). The UE may transmit UCI using one subband (or a plurality of subbands) among the four subbands.

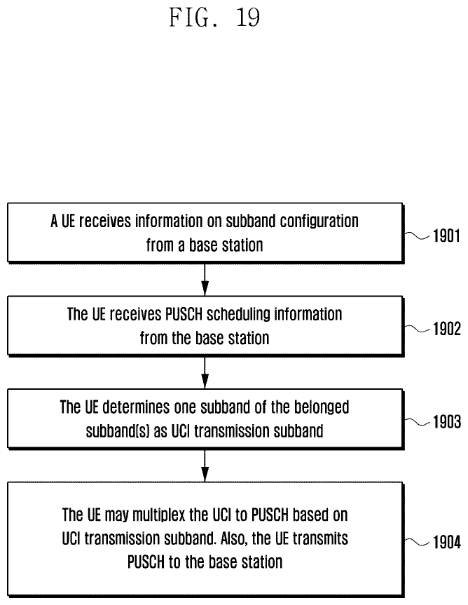

FIG. 19 illustrates a method for determining a specific subband to transmit UCI according to an embodiment of the disclosure.

Specifically, a method for determining a specific subband (hereinafter referred to as a UCI subband or a UCI transmission subband) for a UE to transmit UCI is as follows.

In a first operation 1901, the UE may receive information on subband configuration from the base station. This may be configured based on at least one of the information for determining a subband based on UL BWP configuration information, the information for determining a subband based on cell/carrier configuration, or the scheduling information-based subband determination method, as disclosed in the first embodiment. The UE may determine subbands based on the information on the subbands.

In a second operation 1902, the UE may be scheduled with a PUSCH by the base station. For example, the UE may be scheduled for PUSCH transmission through DCI. The DCI format may be DCI format 0_0, 0_1, or 0_2. The UE may determine the subband to which the scheduled UL channel or signal belongs. If the scheduled UL channel or signal belongs to one subband, the UE may determine the one subband as the subband to which the scheduled UL channel or signal belongs. If the scheduled UL channel or signal belongs to a plurality of subbands, the UE may determine the plurality of subbands as the subbands to which the scheduled UL channel or signal belongs.

In a third operation 903, the UE may determine one of the subband(s) to which the scheduled UL channel or signal belongs as the UCI transmission subband. In the case that the subband to which the scheduled UL channel or signal belongs is one, the UE may determine the one subband as the UCI transmission subband. In the case that the subband to which the scheduled UL channel or signal belongs is in plural, the UE may determine the UCI transmission subband using one of the following methods.

In a first method for determining the UCI transmission subband, the subband with the lowest subband in a frequency area among the subbands to which the PUSCH belongs may be selected as the UCI transmission subband. That is, the UE may determine the subband with the lowest subband in a frequency area among the plurality of subbands as the UCI transmission subband. This may be determined based on a start RB index to last RB index of each of the plurality of subbands.

In a second method for determining the UCI transmission subband, the subband with the highest subband in a frequency area among the subbands to which the PUSCH belongs may be selected as the UCI transmission subband. That is, the UE may determine the subband with the highest subband in a frequency area among the plurality of subbands as the UCI transmission subband. This may be determined based on a start RB index to last RB index of each of the plurality of subbands.

In a third method for determining the UCI transmission subband, the subband with the most overlapping RBs among the subbands to which the PUSCH belongs may be selected as the UCI transmission subband. For example, in the case that there are two subbands to which the UL channel or signal belongs, the UE may determine the number of RBs overlapping with the PUSCH for each of the two subbands. The UE may determine a subband with a greater number of RBs overlapping with the UL channel or signal as the UCI transmission subband. If the number of overlapping RBs of the two subbands is the same, the UCI transmission subband may be determined with another method.

In a fourth method for determining the UCI transmission subband, each subband may be configured with a priority. The UE may determine the UCI transmission subband based on the priority. For example, in the case that there are two subbands to which the PUSCH belongs, a priority may be configured for each of the two subbands. In the case that there is a subband with a higher priority among the two subbands, the UE may determine the subband with the higher priority as the UCI transmission subband. In the case that the priorities of the two subbands are the same, the UE may determine the UCI transmission subband with another method. The priority may be configured to the UE with a higher layer signal (RRC, MAC-CE) of the base station. In addition, the priority may be updated with a higher layer signal (RRC, MAC-CE) of the base station.

In a fifth method for determining the UCI transmission subband, the UE may be indicated with one subband from the DCI that schedules the PUSCH. That is, the DCI may include information for indicating one subband. For example, the DCI may include a bit field for indicating one of the S subbands. The length of the bit field may be ceil(log₂(S)) bits. For example, one subband may be indicated according to an RNTI value for scrambling the DCI. As another example, the DCI may include an N-bit downlink allocation index (DAI) field. One value of the N-bit DAI field may indicate that there is no UCI to be multiplexed. The remaining values may include information on the subbands for multiplexing the UCI. Here, N may be N=ceiling (log₂(1+S)) to indicate one subband of the S subbands. For example, one subband may be indicated based on at least one or a combination of slot index/symbol index/search space index/CORESET index in which the DCI is received. For example, one subband may be indicated based on at least one or a combination of the lowest RB index/highest RB index/aggregation level of the PDCCH on which the DCI is received.

In a sixth method for determining the UCI transmission subband, the UE may select one subband. In the case that there is a plurality of subbands to which an UL channel or signal belongs, the UE may select one subband according to the implementation of the UE. In this case, the implementation of the UE may be capable of maximizing the transmission quality of the UCI. For example, the UE may calculate the expected transmission quality when transmitting UCI by multiplexing it in each subband. The UE may select a subband associated with a transmission parameter that provides the best quality among the calculated UCI transmission qualities.

In the fourth operation 1904, the UE may multiplex UCI to the PUSCH based on the UCI transmission subband. Then, the UE may transmit the PUSCH to the base station.

The method for the UE to multiplex UCI to the PUSCH based on the UCI transmission subband may include the following.

In a first method, the UE may determine the type of UCI to be transmitted within the UCI transmission subband.

For example, it is assumed that the UE transmits a plurality of UCI types to the PUSCH. The plurality of UCI types may include HARQ-ACK, CSI part 1, and CSI part 2. The UE may transmit all or some of the plurality of UCI types within the UCI transmission subband. For example, HARQ-ACK may be transmitted within the UCI transmission subband, and other UCI types (CSI part 1, CSI part 2) may be transmitted in all RBs of the PUSCH. For example, HARQ-ACK and CSI part 1 may be transmitted within the UCI transmission subband, and other UCI types (CSI part 2) may be transmitted in all RBs of the PUSCH.

As another example, it is assumed that the UE transmits UCIs with a plurality of priorities in the PUSCH. For example, when there is UCI with a high priority and UCI with a low priority, the UE may transmit all or some of the UCIs within the UCI transmission subband. For example, among the UCIs, the UCI with a high priority may be transmitted within the UCI transmission subband, and the UCI with a low priority may be transmitted in all RBs of the PUSCH.

As a second method, when the UE transmits UCI within a subband, the number of REs occupied by the UCI may be determined as follows.

For example, it is assumed that HARQ-ACK is transmitted within the UCI transmission subband. In this case, the number of REs for HARQ-ACK transmission may be determined as follows. In the equation below, since HARQ-ACK information is multiplexed only within the UCI transmission subband, MPS may be the number of subcarriers that overlap with the UCI transmission subband among the subcarriers on which the PUSCH is scheduled.

$${Q}_{ACK}^{′} = min \{ ⌈ \frac{\begin{matrix}( {O}_{ACK} + {L}_{ACK} ) \cdot {β}_{offset}^{PUSCH} \cdot \\ {\sum }_{l = 0}^{{N}_{symb , all}^{PUSCH} - 1} {M}_{sc}^{UCI} ( l )\end{matrix}}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \} where \qquad [ Equation 7 ]$$

O_{ACK} is the number of HARQ-ACK bits;
if O_{ACK}≥360, L_{ACK}=11; otherwise L_{ACK} is the number of CRC bits for HARQ-ACK determined;
β_{offset}^{PUSCH}=β_{offset}^{HARQ-ACK};
C_{UL-SCH} is the number of code blocks for UL-SCH of the PUSCH transmission;
if the DCI format scheduling the PUSCH transmission includes a CBGTI field indicating that the UE may not transmit the r-th code block, Kᵣ=0; otherwise, Kᵣ is the r-th code block size for UL-SCH of the PUSCH transmission;
M_{sc}^{PUSCH} is the number of subcarrier within intersection of the UCI subband PUSCH and the scheduled bandwidth of the PUSCH transmission if the UCI subband is configured/enabled; otherwise, the number of subcarriers in the scheduled bandwidth of the PUSCH transmission;
M_{sc}^{PT-RS}(l) is the number of subcarriers in OFDM symbol l that carries PTRS, in the PUSCH transmission;
M_{sc}^{UCI}(l) is the number of resource elements that can be used for transmission of UCI in OFDM symbol l, for l=0, 1, 2, . . . , N_{symb,all}^{PUSCH}−1, in the PUSCH transmission and N_{symb,all}^{PUSCH} is the total number of OFDM symbols of the PUSCH, including all OFDM symbols used for DMRS;
for any OFDM symbol that carries DMRS of the PUSCH, M_{sc}^{UCI}(l)=0;
for any OFDM symbol that does not carry DMRS of the PUSCH, M_{sc}^{UCI}(l)=M_{sc}^{PUSCH}−M_{sc}^{PT-RS}(l);
α is configured by higher layer parameter scaling; and
l₀ is the symbol index of the first OFDM symbol that does not carry DMRS of the PUSCH, after the first DMRS symbol(s), in the PUSCH transmission.

As another example, since UCI is transmitted only in the UCI transmission subband, the number of information bits of PUSCH transmitted in the UCI transmission subband may be considered. In the above equation, Σᵣ₌₀^{C}^{_{UL-SCH}}⁻¹ Kᵣ is the total number of information bits transmitted by a PUSCH. Since the UE uses some bands among the total bands on which PUSCH is scheduled for UCI transmission, the number of effective information bits may be given by Ratio*Σᵣ₌₀^{C}^{_{UL-SCH}}⁻¹ Kᵣ. Here, it may be

$$Ratio = \frac{{M}_{sc}^{PUSCH}}{number of subcarriers in the scheduled PUSCH} .$$

Here, M_{sc}^{PUSCH} may be as defined above. That is, if all PUSCH are included in the UCI transmission subbands, Ratio may be 1. Reflecting this, the number of REs for HARQ-ACK transmission may be determined as follows.

$${Q}_{ACK}^{′} = min \{ ⌈ \frac{\begin{matrix}( {O}_{ACK} + {L}_{ACK} ) \cdot {β}_{offset}^{PUSCH} \cdot \\ {\sum }_{l = 0}^{{N}_{symb , all}^{PUSCH} - 1} {M}_{sc}^{UCI} ( l )\end{matrix}}{Ratio * {\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \} . \qquad [ Equation 8 ]$$

The UE may select a subband for transmitting UCI by itself. In this case, the UE may transmit, to the base station, information on the subband it has selected. This relates to a method for the UE to transmit information on the subband it has selected to the base station.

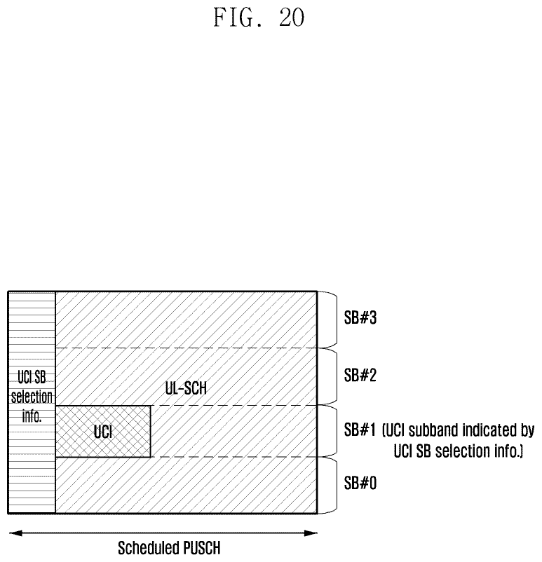

FIG. 20 illustrates multiplexing of information of a selected UCI subband (UCI SB selection information) and UCI within a PUSCH when a UE selects a subband for transmitting UCI by itself according to an embodiment of the disclosure.

The UE may be configured with a fixed number of subbands. It is said that the number is S, and the indices of the subbands are 0, 1, . . . , S−1. The UE may transmit, to the base station, information on a subband used for UCI transmission among the subbands based on the index. In another method, it is said that the number of subbands overlapping with the PUSCH among the subbands configured by the UE is S, and the indices of the subbands are 0, 1, . . . , S−1. The UE may transmit, to the base station, information on a subband used for UCI transmission among the subbands based on the index.

In the case that the UE selects one of the S subbands to use for UCI transmission, the UE may transmit B=ceil(log₂(S)) bits to the base station. The B bits may be referred to as UCI SB selection information. For example, with reference to FIG. 20, in the case that S=4 subbands are configured by the base station, the UE may transmit B=ceil(log₂(4))=2 bits to the base station. Here, “00” may indicate that a subband with an index of 0 among the S subbands is used for UCI transmission, “01” may indicate that a subband with an index of 1 among the S subbands is used for UCI transmission, “10” may indicate that a subband with an index of 2 among the S subbands is used for UCI transmission, and “11” may indicate that a subband with an index of 0 among the S subbands is used for UCI transmission.

In the case that the UE selects one or a plurality of subbands among S subbands to use for UCI transmission, and in the case that only the continuous selected subbands are allowed in a frequency area, the UE may transmit B=ceil(log₂(S*(S+1)/2)) bits to the base station. Here, B=ceil(log₂(S*(S+1)/2)) bits is a joint coding of the start index (SBₛₜₐᵣₜ) of the subbands used by the UE for UCI transmission and the number of consecutive subbands (L_{SBs}) using RIV, and may be as shown in Equation 9.

$$if ( {L}_{RBs} - 1 ) \leq ⌊ S / 2 ⌋ then \qquad [ Equation 9 ]$$

$$RIV = S ( {L}_{RBs} - 1 ) + {SB}_{start}$$

$$else RIV = S ( S - {L}_{RBs} + 1 ) + ( S - 1 - {SB}_{start} )$$

$$where {L}_{RBs} \geq 1 and may not exceed S - {SB}_{start} .$$

In the case that the UE selects one or a plurality of subbands among S subbands to use for UCI transmission, and in the case that the continuous or discontinuous selected subbands are allowed in a frequency area, the UE may transmit B=S bits to the base station. Here, each bit of the B=S bits has a corresponding subband, and in the case that the subband is used for UCI transmission, bit=1, and in the case of otherwise, bit=0. For example, the MSB may indicate whether the subband whose index is 0 is used for UCI transmission, and the LSB may indicate whether the subband whose index is S−1 is used for UCI transmission. For example, the LSB may indicate whether the subband whose index is 0 is used for UCI transmission, and the MSB may indicate whether the subband whose index is S−1 is used for UCI transmission.

The UE may transmit B bits to the base station. The method for transmitting the B bits is as follows.

In a first method, the UE may transmit the B bits through the PUCCH. The PUCCH may be transmitted before the PUSCH in which UCI is multiplexed and transmitted. The format, start symbol, and length of the PUCCH may be configured by the base station. That is, the base station may configure information on the PUCCH for receiving B bits including information on UCI selected by the UE to the UE. The base station may receive the PUCCH according to the above configuration. The base station may obtain the B bits from the PUCCH, and may determine which subband includes the UCI from the B bits. The base station may receive the multiplexed UCI in the PUSCH to be transmitted within the subband determined according to the above determination. In the case that the scheduled PUSCH is included in only one subband, the UE does not need to transmit separate information. Therefore, the UE may omit PUCCH transmission. Since the base station knows the scheduling information, in the case that the scheduled PUSCH is included in only one subband, the base station may obtain the multiplexed UCI by receiving the PUSCH without receiving the PUCCH.

In a second method, B bits may be multiplexed and transmitted in the PUSCH. That is, B bits, which are information on the UCI subband, and UCI may be multiplexed simultaneously in the PUSCH. In a method, UCI may be multiplexed on the UCI subband selected by the UE. B bits, which are information on the UCI subband, may be multiplexed across the entire band of the PUSCH. That is, information on the UCI subband may be multiplexed on all subbands overlapping with the PUSCH. This means that in the case that B bits are included in a specific UCI subband and transmitted, the base station may perform a plurality of blind decodings to determine the specific UCI subband. However, in the case that B bits are multiplexed on all subbands overlapping with PUSCH, the base station may obtain information on UCI subbands with one decoding.

The above-described B bits are information on UCI subbands on which UCI is multiplexed within PUSCH. The UE may select different UCI subbands for each UCI type. For example, HARQ-ACK may be transmitted on a first UCI subband, and CSI part 1 to part 2 may be transmitted on a second UCI subband. In this case, the UE may generate a first B bits, which are information for indicating the first UCI subband, and a second B bits, which are information for indicating the second UCI subband. The UE may transmit, to the base station, a bit sequence that combines the first B bits and second B bits.

### Fourth Embodiment: Power Boosting Method

When transmitting a PUSCH, a UE may use higher transmission power for a specific subband in order to transmit a specific subband with higher quality. The specific subband may be a subband used for UCI transmission. That is, the UE may transmit a subband transmitting UCI with higher power than a subband not transmitting UCI.

To this end, the base station may configure a power offset value to be applied to a subband transmitting UCI to the UE. The offset value may be in dB units and may be a positive integer. The UE may determine the PUSCH transmission power and transmit REs of the subband transmitting UCI by increasing the UL transmission power by the offset value.

The subband used for UCI transmission is an example, and the base station may configure a subband to be transmitted with higher power to the UE through a higher layer signal. The UE may be configured to receive a subband to be transmitted at a higher power according to a higher layer signal by the base station, and may transmit by increasing the transmission power of the subband of the PUSCH.

When transmitting the PUSCH, the UE may use a higher transmission power for specific REs in order to transmit the specific REs at a higher quality. The specific REs may be REs to which UCI is transmitted. In other words, the UE may transmit the REs to which UCI is transmitted at a higher power than the REs that do not transmit UCI.

To this end, the base station may configure a power offset value to be applied to the REs to which UCI is transmitted to the UE. The offset value has a unit of dB and may be a positive integer. The UE may determine the PUSCH transmission power, and may transmit the REs to which UCI is transmitted by increasing the UL transmission power by the offset value.

An RE used for UCI transmission is one example, and the base station may configure the REs to be transmitted at a higher power to the UE through a higher layer signal. The UE may be configured to REs to be transmitted at higher power according to a higher layer signal by the base station, and may transmit the same by increasing the transmission power of the REs of the PUSCH.

When transmitting the PUSCH, the UE may use higher transmission power for a specific symbol in order to transmit the specific symbol with higher quality. The specific symbol may be a symbol transmitting UCI. That is, the UE may transmit the symbol transmitting UCI at higher power than the symbol not transmitting UCI.

To this end, the base station may configure a power offset value to be applied to the symbol transmitting UCI to the UE. The offset value has a unit of dB and may be a positive integer. The UE may determine the PUSCH transmission power, and may transmit the symbol transmitting UCI by increasing the UL transmission power by the offset value.

In the method, the DMRS symbol of the PUSCH may also be transmitted at the same power as the symbol transmitting UCI.

The symbol used for UCI transmission is an example, and the base station may configure a symbol to be transmitted with higher power to the UE through a higher layer signal. The UE may be configured to symbols to be transmitted with higher power by the base station according to a higher layer signal, and if the PUSCH overlaps with the symbol, the transmission power of the symbols of the PUSCH may be increased and transmitted.

In the method, the symbols may be symbols to which the SBFD UL subband is configured.

When transmitting the PUSCH, the UE may use a higher transmission power for a specific PUSCH in order to transmit the specific PUSCH with higher quality. The PUSCH may be a PUSCH on which UCI is multiplexed. That is, the UE may transmit the PUSCH on which UCI is multiplexed with higher power than the PUSCH on which UCI is not multiplexed. In this case, all symbols of the PUSCH on which UCI is multiplexed may be transmitted with higher power.

To this end, the base station may configure a power offset value to be applied to the PUSCH on which UCI is transmitted to the UE. The offset value has a unit of dB and may be a positive integer. The UE may determine the PUSCH transmission power, and in the case that the PUSCH multiplexes UCI, the PUSCH may be transmitted by increasing the UL transmission power by the offset value.

In the method, the PUSCH on which UCI is multiplexed is an example, and the base station may configure a symbol to be transmitted at a higher power through a higher layer signal to the UE. The UE may be configured to symbols to be transmitted at a higher power according to the higher layer signal by the base station, and if the PUSCH overlaps with the symbol, the transmission power of all symbols of the PUSCH may be increased and transmitted.

In the method, the symbols may be symbols to which the SBFD UL subband is configured.

In the disclosure, the transmission at a higher power has been described, but it may be extended to the transmission at a lower power. In this case, the offset value may be replaced with a negative integer.

In the disclosure, it has been described that the transmission power is determined for a first purpose subband/RE/symbol/PUSCH of a PUSCH, and a higher power is calculated for a second purpose subband/RE/symbol/PUSCH using the offset value. However, the disclosure may be replaced with the first transmission power being determined for the first purpose subband/RE/symbol/PUSCH of the PUSCH, and the second transmission power being determined for the second purpose subband/RE/symbol/PUSCH.

Here, the first purpose subband/RE/symbol/PUSCH may be a subband/RE/symbol/PUSCH on which UCI is not transmitted, and the second purpose subband/RE/symbol/PUSCH may be a subband/RE/symbol/PUSCH on which UCI is transmitted.

Here, the first purpose symbol may be a symbol (or UL symbol, or UL symbol and flexible symbol) for which the SBFD UL subband is not configured, and the second purpose symbol may be a symbol (or SBFD symbol) for which the SBFD UL subband is configured.

In an embodiment, as an example, UCI may include HARQ-ACK, CSI part 1, and CSI part 2. As another example, UCI may be limited to HARQ-ACK. That is, the power boosting methods described above may be used according to the multiplexing of HARQ-ACK.

In an embodiment, UCI may use the power boosting methods described above for high priority UCI and low priority UCI. As another example, UCI may be limited to high priority UCI. That is, the power boosting methods described above may be used when multiplexing high priority UCI.

In an embodiment, in order to allocate higher power to the UCI subband, the UL-SCH may not be transmitted in a subband other than the UCI subband in the symbol in which the UCI is transmitted. That is, the UE may use the transmission power only for the UCI subband in the symbol in which the UCI is transmitted. Here, the UL-SCH of the subband other than the UCI subband may be rate-matched or punctured.

In an embodiment, in order to allocate higher power to the REs to which the UCI is assigned, the UL-SCH may not be transmitted in the REs, other than the REs to which the UCI is assigned in the symbol in which the UCI is transmitted. That is, the UE may use the transmission power only for the REs to which the UCI is assigned in the symbol in which the UCI is transmitted. Here, the UL-SCH of the REs, other than REs to which the UCI is assigned, may be rate-matched or punctured.

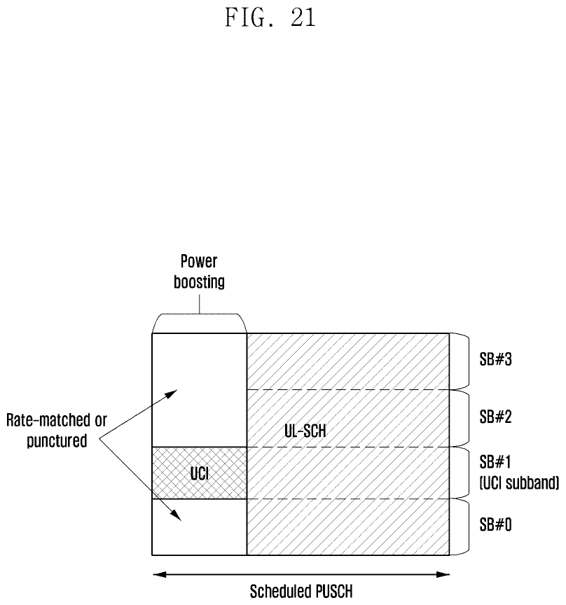

FIG. 21 illustrates an example of applying rate-matching or puncturing in a subband where UCI is not transmitted according to an embodiment of the disclosure.

In the example of FIG. 21, a UE may use SB #1 as a UCI subband. That is, UCIS may be multiplexed and transmitted within the UCI subband (SB #1). In addition, UL-SCH may not be transmitted in subbands (SB #0, SB #2, SB #3) that are not UCI subbands.

In an embodiment, the UE may be indicated through MAC-CE or DCI whether to use the power boosting method or not.

For example, MAC-CE may activate or deactivate the power boosting method. That is, the UE may receive MAC-CE through PDSCH and obtain information on whether the power boosting method is activated or deactivated from the MAC-CE. The UE may activate or deactivate the power boosting method according to the indication of the MAC-CE for the PUSCH to be transmitted in the slot after a certain time from the slot in which the PDSCH including the MAC-CE is received, and transmit the same. Here, the certain time may be the first slot after 3 ms (or 3*Nₛₗₒₜ^{subframe,μ}, Nₛₗₒₜ^{subframe,μ} is the number of slots included in the subframe when the subcarrier spacing is 15*2^{μ}kHz).

For example, the power boosting method may be activated or deactivated in some fields of the DCI. Here, the DCI format may be a DCI format that schedules the PUSCH. The DCI format may include 1 bit for indicating activation and deactivation. The activation and deactivation may be applied only to the PUSCH scheduled by the DCI format. The activation and deactivation may be applied to the PUSCH scheduled by the DCI format and the PUSCHs transmitted after the PUSCH. The above activation and deactivation may be applied to the PUSCH scheduled by the DCI format and the PUSCH scheduled after the DCI format.

The above activation and deactivation may be joint coded with other fields of the DCI format. For example, a downlink allocation index (DAI) field indicating whether the UCI of the DCI format is multiplexed may be extended to 2 bits. Here, one code point (e.g., “00”) of the 2 bits may indicate that the UCI is not multiplexed, the other code point (e.g., “01”) of the 2 bits may indicate that the UCI is multiplexed and the power boosting method is not activated, and the other code point (e.g., “10”) of the 2 bits may indicate that the UCI is multiplexed and the power boosting method is activated. As another example, the above activation and deactivation information may be included in the TPC command for scheduled PUSCH field indicating the transmit power control of the PUSCH of the DCI format. For example, a 2-bit TPC command for scheduled PUSCH field may be extended to 3 bits, and 2 bits out of the 3 bits may indicate the transmit power control of the existing PUSCH, and the remaining 1 bit may indicate whether to activate power boosting.

In the case of DCI format 0_0, a bit field indicating activation and deactivation may not be included. Therefore, the power boosting method may not be applied to the PUSCH scheduled by DCI format 0_0. In another method, in the case that DCI format 0_0 is monitored in common search space (CSS), the power boosting method is not applied to the PUSCH scheduled by DCI format 0_0, and in the case that DCI format 0_0 is monitored in UE-specific search space (USS), the power boosting method may be applied to the PUSCH scheduled by DCI format 0_0. In another method, whether to apply the power boosting method to the PUSCH scheduled by DCI format 0_0 may be configured in the higher layer signal (RRC signal) of the base station. The UE may determine whether to apply the power boosting method to the PUSCH scheduled by DCI format 0_0 through the higher layer signal from the base station.

For example, the power boosting method may be activated or deactivated in some fields of the DCI. Here, the DCI format may be a group-common DCI format. That is, one or a plurality of UEs in the cell may receive the group-common DCI format. Then, one or a plurality of UEs may determine whether the power boosting method is activated or deactivated from the group-common DCI format. The group-common DCI format may include 1 bit for indicating whether one or a plurality of UEs are power boosted. The base station may configure the location of the 1 bit in the group-common DCI format to the UE. For example, if the same bit location is configured for two UEs in the group-common DCI format, the two UEs may determine whether the power boosting method is activated with the same 1 bit. If different bit locations are configured for two UEs in the group-common DCI format, the two UEs may determine whether the power boosting method is activated with different 1 bits.

The activation and deactivation of the power boosting method may be included in another group common DCI format. For example, DCI format 2_2 is a group common DCI format that indicates TPC commands of PUCCH and PUSCH. The activation and deactivation of the power boosting method may be included in DCI format 2_2 and transmitted.

### Fifth Embodiment: Beta-Offset Configuration for Each Subband

The UE may be configured with a beta-offset value for each subband. For example, in the case that the UE is configured with two subbands by the base station, the UE may be configured with information on a first beta-offset configuration to be used when multiplexing UCI in the first subband and a second beta-offset configuration to be used when multiplexing UCI in the second subband by the base station. Here, each beta-offset configuration may include beta offset values used when multiplexing HARQ-ACK, beta offset values used when multiplexing CSI part 1, and beta offset values used when multiplexing CSI part 2.

The UE may transmit UCI within the PUSCH in the UCI subband. In the case that the UCI subband includes only one subband, the UE may determine the number of REs on which UCI is to be transmitted based on the beta-offset configuration corresponding to the one subband. That is, in the case that the UCI subband is the first subband, the number of REs on which the UCI is to be transmitted may be determined based on the first beta-offset configuration, and in the case that the UCI subband is the second subband, the number of REs on which the UCI is to be transmitted may be determined based on the second beta-offset configuration.

The UE may transmit UCI within the PUSCH in the UCI subband. In the case that the UCI subband includes a plurality of subbands, the UE may determine the number of REs on which the UCI is to be transmitted by at least one of the following methods.

In a first method, the beta-offset value to be used may be determined based on the beta-offset configuration values configured for a plurality of subbands.

In a first-1 method, the number of REs on which the UCI is to be transmitted may be determined based on the largest value among the beta-offset configuration values configured for the plurality of subbands. For example, in the case that UCI is transmitted on the first subband and second subband, the number of REs on which UCI is to be transmitted may be determined based on a larger value between the first beta-offset configuration value and the second beta-offset configuration value. This method may increase the transmission reliability of UCI by using more REs for UCI transmission.

In a first-2 method, the number of REs on which UCI is to be transmitted may be determined based on a smallest value among the beta-offset configuration values configured for the plurality of subbands. For example, in the case that UCI is transmitted on the first subband and second subband, the number of REs on which UCI is to be transmitted may be determined based on a smaller value between the first beta-offset configuration value and the second beta-offset configuration value. This method may increase the transmission reliability of UL-SCH by using more REs for UL-SCH transmission.

In a first-3 method, the number of REs on which the UCI is to be transmitted may be determined based on an average value of beta-offset configuration values configured for the plurality of subbands. For example, in the case that the UCI is to be transmitted on the first subband and second subband, the number of REs on which the UCI is to be transmitted may be determined based on an average value ((beta1+beta2)/2) of the first beta-offset configuration value (beta1) and the second beta-offset configuration value (beta2).

In a second method, the number of REs to be transmitted by UCI may be determined based on the number of REs calculated according to the beta-offset configuration values configured for the plurality of subbands.

In a second-1 method, the number of REs to be transmitted by UCI may be determined based on the largest value among the numbers of REs calculated according to the beta-offset configuration values configured for the plurality of subbands. For example, in the case that UCI is transmitted in the first subband and second subband, the number of REs to be transmitted by UCI may be determined based on the larger value among the number of REs (RE1) calculated according to the first beta-offset configuration value and the number of REs (RE2) calculated according to the second beta-offset configuration value. This method may increase the transmission reliability of UCI by using more REs for UCI transmission.

In a second-2 method, the number of REs to be transmitted by UCI may be determined based on the smallest value among the numbers of REs calculated according to the beta-offset configuration values configured for the plurality of subbands. For example, in the case that UCI is transmitted in the first subband and second subband, the number of REs on which UCI is to be transmitted may be determined based on a smaller value among the number of REs (RE1) calculated according to the first beta-offset configuration value and the number of REs (RE2) calculated according to the second beta-offset configuration value. This method may increase the transmission reliability of UL-SCH by using more REs for UL-SCH transmission.

In a second-3 method, the number of REs on which UCI is to be transmitted may be determined based on an average value of the number of REs calculated according to the beta-offset configuration values configured for the plurality of subbands. For example, in the case that UCI is to be transmitted in the first subband and second subband, the number of REs on which the UCI is to be transmitted may be determined based on an average value ((RE1+RE2)/2) of the number of REs (RE1) determined according to the first beta-offset configuration value and the number of REs (RE2) determined according to the second beta-offset configuration value. If the average value is not an integer, the number of REs on which the UCI is to be transmitted may be determined by ceil, floor, or rounding.

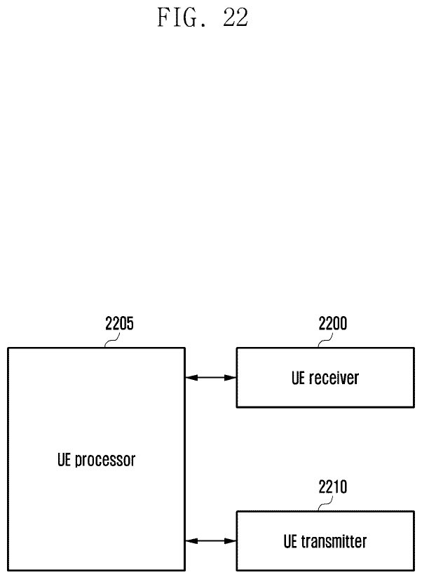

FIG. 22 illustrates the structure of a UE in a wireless communication system according to an embodiment of the disclosure.

With reference to FIG. 22, the UE may include a transceiver with reference to a UE receiver 2200 and a UE transmitter 2210, a memory (not shown), and a UE processor 2205 (or a UE controller or processor). According to the above-described communication method of the UE, the UE transceiver 2200 and 2210, memory, and UE processor 2205 may operate. However, the components of the UE are not limited to the above-described examples. For example, the UE may include more or fewer components than the aforementioned components. In addition, the transceiver, memory, and processor may be implemented in the form of one chip.

The transceiver may transmit/receive a signal to/from the base station. Here, the signal may include control information and data. To this end, the transceiver may include an RF transmitter for up-converting and amplifying a frequency of a transmitted signal, and an RF receiver for low-noise amplifying a received signal and down-converting a frequency of the received signal. However, this is only an embodiment of the transceiver, and the components of the transceiver are not limited to the RF transmitter and RF receiver.

In addition, the transceiver may receive a signal through a radio channel, output the same to the processor, and transmit a signal output from the processor through a radio channel.

The memory may store programs and data necessary for the operation of the UE. In addition, the memory may store control information or data included in a signal transmitted and received by the UE. The memory may be constituted as a storage medium such as read only memory (ROM), random access memory (RAM), hard disks, compact disc read only memory (CD-ROM), and digital versatile disc (DVD), or a combination thereof. In addition, a plurality of memories may be provided.

In addition, the processor may control a series of processes such that the UE operates according to the above-described embodiment. For example, the processor may control the components of the UE so as to receive DCI comprised of two layers, thereby simultaneously receiving a plurality of PDSCHs. A plurality of processors may be provided, and the processor may execute a program stored in the memory to perform a component control operation of the UE.

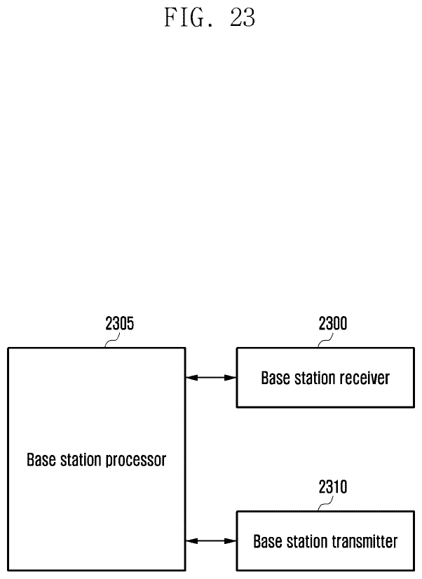

FIG. 23 illustrates the structure of a base station in a wireless communication system according to an embodiment of the disclosure.

With reference to FIG. 23, the base station may include a transceiver with reference to a base station receiver 2300 and a base station transmitter 2310, a memory (not shown), and a base station processor 2305 (or a base station controller or processor). According to the above-described communication method of the base station, the base station transceiver 2300 and 2310, memory, and base station processor 2305 may operate. However, the components of the base station are not limited to the above-described examples. For example, the base station may include more or fewer components than the aforementioned components. In addition, the transceiver, memory, and processor may be implemented in the form of one chip.

The transceiver may transmit/receive a signal to/from the UE. Here, the signal may include control information and data. To this end, the transceiver may include an RF transmitter for up-converting and amplifying a frequency of a transmitted signal, and an RF receiver for low-noise amplifying a received signal and down-converting a frequency of the received signal. However, this is only an embodiment of the transceiver, and the components of the transceiver are not limited to the RF transmitter and RF receiver.

In addition, the transceiver may receive a signal through a radio channel, output the same to the processor, and transmit a signal output from the processor through a radio channel.

The memory may store programs and data necessary for the operation of the base station. In addition, the memory may store control information or data included in a signal transmitted and received by the base station. The memory may be constituted as a storage medium such as ROM, RAM, hard disks, CD-ROM, and DVD, or a combination thereof. In addition, a plurality of memories may be provided.

The processor may control a series of processes such that the base station operates according to the above-described embodiment. For example, the processor may control each of the components of the base station so as to constitute and transmit two-layer DCI including allocation information for a plurality of PDSCHs. A plurality of processors may be provided, and the processor may execute a program stored in the memory to perform a component control operation of the base station.

The methods according to embodiments described in the claims or specification of the disclosure may be implemented by hardware, software, or a combination of hardware and software.

In the case where the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to the embodiments disclosed in the claims or specification of the disclosure.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in a memory constituted with some or all of them. Further, a plurality of such memories may be included.

In addition, the programs may be stored in an attachable storage device which may be accessed through communication networks such as the Internet, Intranet, Local Area Network (LAN), Wide LAN (WLAN), and Storage Area Network (SAN) or a combination thereof. Such a storage device may access an apparatus performing the embodiments of the disclosure via an external port. Further, a separate storage device on the communication network may access an apparatus performing the embodiments of the disclosure.

In the above-described detailed embodiments of the disclosure, a component included in the disclosure is expressed in the singular or the plural according to presented detailed embodiments. However, the singular form or plural form is selected appropriately to the presented situation for the convenience of description, and the disclosure is not limited by components expressed in the singular or the plural. Therefore, either a component expressed in the plural may also include a single component or a component expressed in the singular may also include multiple components.

Meanwhile, the embodiments of the disclosure shown in the specification and drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. For example, an embodiment of the disclosure may be partially grouped with another embodiment of the disclosure to operate a base station and UE. As an example, embodiments 1 to 5 of the disclosure may be partially combined to operate a base station and UE. Further, although the above embodiments have been described by way of the FDD LTE system, other variants based on the technical idea of the embodiments may be implemented in other systems such as TDD LTE and 5G or NR systems.

Meanwhile, in the drawings in which methods of the disclosure are described, the order of the description does not always correspond to the order in which each method is executed, and the order relationship between the steps may be changed or the steps may be executed in parallel.

Alternatively, in the drawings in which methods of the disclosure are described, some components may be omitted and only some components may be included therein without departing from the essential spirit of the disclosure.

Further, in methods of the disclosure, some or all of the contents of each embodiment may be implemented in combination without departing from the essential spirit of the disclosure.

Various embodiments of the disclosure have been described. The above description of the disclosure is for the purpose of illustration, and embodiments of the disclosure are not limited to the embodiments set forth herein. Those skilled in the art will appreciate that other specific modifications and changes may be easily made thereto the without departing from the technical idea or essential features of the disclosure. The scope of the disclosure is defined not by the above detailed description but by the appended claims to be described below, and all modifications or changes derived from the meaning and scope of the claims and equivalent concepts thereof shall be construed as falling within the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, from a base station, a configuration for one or more sub-bands;
receiving, from the base station, downlink control information (DCI) scheduling a physical uplink shared channel (PUSCH);
identifying, among the one or more sub-bands, a first sub-band for uplink control information (UCI);
multiplexing the UCI on the PUSCH based on the first sub-band for the UCI; and
transmitting, to the base station, the PUSCH including the UCI.

2. The method of claim 1, wherein the DCI includes a field indicating the first sub-band for the UCI among the one or more sub-bands, and
wherein the first sub-band for the UCI is identified based on the field included in the DCI.

3. The method of claim 1, wherein the first sub-band for the UCI is identified as a second sub-band selected by the UE, and
wherein the PUSCH includes information indicating the second sub-band selected by the UE.

4. The method of claim 3, wherein the information indicating the second sub-band selected by the UE is multiplexed on the PUSCH over an entire bandwidth of the PUSCH.

5. The method of claim 1, wherein the configuration for one or more sub-bands includes a beta-offset value for each sub-band of the one or more sub-bands, and
wherein a number of resource elements (REs) for the UCI is identified based on a beta-offset value for the first sub-band for the UCI.

6. A method performed by a base station in a communication system, the method comprising:
transmitting, to a user equipment (UE), a configuration for one or more sub-bands;
transmitting, to the UE, downlink control information (DCI) scheduling a physical uplink shared channel (PUSCH); and
receiving, from the UE, the PUSCH including an uplink control information (UCI),
wherein the UCI is multiplexed in a first sub-band for the UCI among the one or more sub-bands.

7. The method of claim 6, wherein the DCI includes a field indicating the first sub-band for the UCI among the one or more sub-bands, and
wherein the first sub-band for the UCI is identified based on the field included in the DCI.

8. The method of claim 6, wherein the first sub-band for the UCI is identified as a second sub-band selected by the UE, and
wherein the PUSCH includes information indicating the second sub-band selected by the UE.

9. The method of claim 8, wherein the information indicating the second sub-band selected by the UE is multiplexed on the PUSCH over an entire bandwidth of the PUSCH.

10. The method of claim 6, wherein the configuration for one or more sub-bands includes a beta-offset value for each sub-band, and
wherein a number of resource elements (REs) for the UCI is identified based on a beta-offset value for the first sub-band for the UCI.

11. A user equipment (UE) in a communication system, the UE comprising:
a transceiver; and
at least one processor operably coupled to the transceiver, the at least one processor configured to:
receive, from a base station, a configuration for one or more sub-bands,
receive, from the base station, downlink control information (DCI) scheduling a physical uplink shared channel (PUSCH),
identify, among the one or more sub-bands, a first sub-band for uplink control information (UCI),
multiplex the UCI on the PUSCH based on the first sub-band for the UCI, and transmit, to the base station, the PUSCH including the UCI.

12. The UE of claim 11, wherein the DCI includes a field indicating the first sub-band for the UCI among the one or more sub-bands, and
wherein the first sub-band for the UCI is identified based on the field included in the DCI.

13. The UE of claim 11, wherein the first sub-band for the UCI is identified as a second sub-band selected by the UE, and
wherein the PUSCH includes information indicating the second sub-band selected by the UE.

14. The UE of claim 13, wherein the information indicating the second sub-band selected by the UE is multiplexed on the PUSCH over an entire bandwidth of the PUSCH.

15. The UE of claim 11, wherein the configuration for one or more sub-bands includes a beta-offset value for each sub-band, of the one or more sub-bands and
wherein a number of resource elements (REs) for the UCI is identified based on a beta-offset value for the first sub-band for the UCI.

16. A base station in a communication system, the base station comprising:
a transceiver; and
at least one processor operably coupled to the transceiver, the at least one processor configured to:
transmit, to a user equipment (UE), a configuration for one or more sub-bands,
transmit, to the UE, downlink control information (DCI) scheduling a physical uplink shared channel (PUSCH), and
receive, from the UE, the PUSCH including an uplink control information (UCI),
wherein the UCI is multiplexed in a first sub-band for the UCI among the one or more sub-bands.

17. The base station of claim 16, wherein the DCI includes a field indicating the first sub-band for the UCI among the one or more sub-bands, and
wherein the first sub-band for the UCI is identified based on the field included in the DCI.

18. The base station of claim 16, wherein the first sub-band for the UCI is identified as a second sub-band selected by the UE, and
wherein the PUSCH includes information indicating the second sub-band selected by the UE.

19. The base station of claim 18, wherein the information indicating the second sub-band selected by the UE is multiplexed on the PUSCH over an entire bandwidth of the PUSCH.

20. The base station of claim 16, wherein the configuration for one or more sub-bands includes a beta-offset value for each sub-band, and
wherein a number of resource elements (REs) for the UCI is identified based on a beta-offset value for the first sub-band for the UCI.
